(19) United States
(12) Patent Application Publication
(10) Pub. No.: US 2009/0189128 A1
(43) Pub. Date: Jul. 30, 2009

(54) COLOR FILTER INK, COLOR FILTER INK SET, COLOR FILTER, IMAGE DISPLAY DEVICE, AND ELECTRONIC DEVICE

(75) Inventors: Hiroshi Takiguchi, Matsumoto (JP); Akihiro Shintani, Shiojiri (JP); Mitsuhiro Isobe, Kofu (JP); Masaya Shibatani, Matsumoto (JP); Hidekazu Moriyama, Fujimi-machi (JP); Hiroshi Kiguchi, Suwa (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/349,660

(22) Filed: Jan. 7, 2009

(30) Foreign Application Priority Data
Jan. 29, 2008 (JP) 2008-017203

(51) Int. Cl. G02B 5/23

(52) U.S. Cl. 252/586

(57) ABSTRACT

A color filter ink is adapted to be used to manufacture a color filter by an inkjet method. The color filter ink includes a pigment, a dispersing agent and a liquid medium. The pigment includes a halogenated phthalocyanine zinc complex and a pigment derivative represented by a prescribed chemical formula. The dispersing agent disperses the pigment. The liquid medium, in which the pigment is dispersed, includes at least a first liquid and a second liquid different than the first liquid. A boiling point at atmospheric pressure of the first liquid is 180 to 290° C. A content ratio of the second liquid in the color filter ink is 5 to 20 wt %. A relationship |SP (X)−SP (Y)|≦0.8 is satisfied, wherein a value SP (X) indicates a solubility parameter for the dispersing agent, and a value SP (Y) indicates a solubility parameter for the second liquid.

### CROSS-REFERENCE TO RELATED APPLICATIONS

This application claims priority to Japanese Patent Application No. 2008-017203 filed on Jan. 29, 2008. The entire disclosure of Japanese Patent Application No. 2008-017203 is hereby incorporated herein by reference.

### BACKGROUND

1. Technical Field

The present invention relates to a color filter ink, a color filter ink set, a color filter, an image display device, and an electronic device.

2. Related Art

Color filters are generally used in liquid crystal display devices (LCD) and the like that display color.

Color filters have conventionally been manufactured using a so-called photolithography method in which a coating film composed of a material (color layer formation composition) that includes a colorant, a photosensitive resin, a functional monomer, a polymerization initiator, and other components is formed on a substrate, and then photosensitive processing for radiating light via a photomask, development processing, and the like are performed. In such a method, the color filters are usually manufactured by repeating a process in which a coating film corresponding to each color is formed on substantially the entire surface of the substrate, only a portion of the coating film is cured, and most of the film other than the cured portion is removed, so that there is no color overlap. Therefore, only a portion of the coating film formed in color filter manufacturing remains as a color layer in the finished color filter, and most of the coating film is removed in the manufacturing process. Therefore, not only does the manufacturing cost of the color filter increase, but the process is also undesirable from the perspective of resource saving.

Methods have recently been proposed for forming the color layer of a color filter through the use of an inkjet head (droplet discharge head) (see Japanese Laid-Open Patent Application No. 2002-372613, for example). In such a method, because the discharge position and the like of droplets of the material (color layer formation composition) used to form the color layer are easily controlled, and waste of the color layer formation composition can be reduced, the environmental impact can be reduced, and manufacturing cost can also be minimized.

Pigments generally have superior light fastness and other characteristics in comparison to dyes, and pigments are therefore widely used as colorants in color filter ink. Three colors of ink (color filter ink) that correspond to the three primary colors of light (red, green, and blue) are usually used in color filter manufacturing.

In a green color filter ink, C. I. Pigment Green 36 is widely used from the perspectives of dispersion properties and dispersion stability of the pigment particles. However, when C. I. Pigment Green 36 is used in the ink for the purpose of increasing the performance of the color filter, it is difficult to increase brightness, contrast, and other characteristics adequately for recent needs for higher quality.

The inventors have discovered that a green colored portion having excellent brightness and contrast in comparison to C. I. Pigment Green 36 can be formed through the use of a halogenated phthalocyanine zinc complex in the manufacture of the color filter. However, a halogenated phthalocyanine zinc complex has inferior dispersion stability in the color filter ink. In such a case, when ink droplets are discharged for long periods of time, and droplets are discharged continuously, the trajectory of the discharged droplets varies (so-called flight deflection occurs) due to mist contamination and the like near the nozzles, and problems occur in that it becomes impossible to land the droplets in the desired position, the droplet discharge head becomes clogged, the droplet discharge quantity becomes unstable, and other problems occur. Specifically, adequately excellent droplet discharge stability is difficult to obtain. In particularly, since the droplet discharge device (industrial) used for color filter manufacturing is entirely different from what is used for a printer (consumer-level), and the droplet discharge device is used for mass production, for example, there is a need to discharge large quantities of droplets for long periods of time. In a droplet discharge device (industrial) used for color filter manufacturing, since the viscosity of the ink is generally high in comparison to the ink used in a consumer-level droplet discharge device used in a printer, drying during discharge is a problem, and ink readily remains in the discharge ports (nozzles) of the inkjet head.

Cleaning for cleaning the inkjet head may be periodically performed in order to stably perform discharge over a long period of time under such harsh conditions. For example, inkjet head cleaning is performed by a method (spitting) whereby droplets are discharged on a portion of the droplet discharge device that does not include the substrate (workpiece) used for the color filter, or a method whereby a suction means is used to forcibly draw in the ink accumulated in the inkjet head. Waste ink generated by discharge usually accumulates in the portions of the droplet discharge device in which such cleaning is performed. Such waste ink is usually removed by suction or another means.

However, when a color filter ink is used that includes a halogenated phthalocyanine zinc complex, the viscosity of the waste ink readily increases, and the pigment or the like readily aggregates and solidifies. A color filter ink generally differs from consumer ink in that it is difficult to re-disperse the solidified color filter ink. Therefore, when cleaning is repeated in a certain location, the solidified waste ink accumulates rather than being removed, and forms a solid body. Therefore, when ink is discharged onto the solid body during cleaning, the discharged droplets collide with the solid body and scatter, and the scattered droplets readily adhere to the area near the discharge ports of the inkjet head. The solid body and the inkjet head sometimes come in contact with each other. Therefore, when a color filter ink containing a halogenated phthalocyanine zinc complex is used during manufacturing of a color filter, droplet discharge sometimes becomes unstable when droplets are discharged for a long time, even when cleaning of the inkjet head is adequately performed. When such a problem occurs, fluctuation occurs in the color saturation between the plurality of colored portions that is supposed to have the same color saturation, and as a result, unevenness of color and saturation occurs between regions of the color filter, fluctuation occurs in the characteristics (particularly contrast ratio, color reproduction range, and other color characteristics) among numerous color filters, and the reliability of the color filters is reduced.

### SUMMARY

An object of the present invention is to provide an inkjet-type color filter ink capable of stable discharge from an inkjet head over a long period of time, that can be stably and suitably used to manufacture a color filter in which unevenness of color and saturation between regions is suppressed, that has excellent uniformity of characteristics between individual units, and that enables image display having excellent contrast and brightness; to provide a color filter ink set provided with the color filter ink; to provide a color filter in which unevenness of color and saturation between regions is suppressed, that has excellent uniformity of characteristics between individual units, and that enables image display having excellent contrast and brightness; and to provide an image display device and electronic device provided with the color filter.

Such objects are achieved by the present invention described hereinafter.

A color filter ink according to a first aspect is adapted to be used to manufacture a color filter by an inkjet method. The color filter ink includes a pigment, a dispersing agent and a liquid medium. The pigment includes a halogenated phthalocyanine zinc complex and a pigment derivative represented by Formula (1) below.

Formula (1)

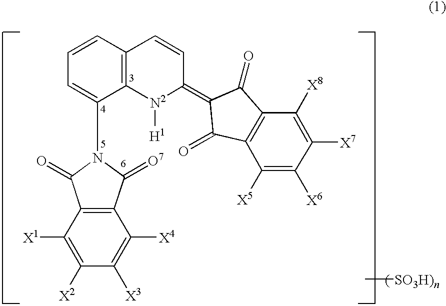

In Formula (1), a value n is an integer from 1 to 5, and X¹ through X⁸ represent each independently a hydrogen atom or a halogen atom.

The dispersing agent disperses the pigment. The liquid medium, in which the pigment is dispersed, includes at least a first liquid and a second liquid different than the first liquid. A boiling point at atmospheric pressure of the first liquid is 180 to 290° C. A content ratio of the second liquid in the color filter ink is 5 to 20 wt %. A relationship |SP (X)−SP (Y)|≦0.8 is satisfied, wherein a value SP (X) ((cal/c^{m3)1/2}) indicates a solubility parameter for the dispersing agent, and a value SP (Y) ((cal/c^{m3)1/2}) indicates a solubility parameter for the second liquid.

It is thereby possible to provide an inkjet-type color filter ink capable of stable discharge from an inkjet head over a long period of time, that can be stably and suitably used to manufacture a color filter in which unevenness of color and saturation between regions is suppressed, that has excellent uniformity of characteristics between individual units, and that enables image display having excellent contrast and brightness.

In the color filter ink as described above, a relationship 0.01≦X_{PD}/X_{PG}≦0.30 is preferably satisfied, wherein a value X_{PD} (wt %) indicates a content ratio of the pigment derivative in the color filter ink, and a value X_{PG} (wt %) indicates a content ratio of the halogenated phthalocyanine zinc complex.

The pigment particles can thereby be more reliably prevented from aggregating in the color filter ink, and the grain size of the pigment particles is made uniform over a long period of time. The colored portion formed using the color filter ink can also be provided with particularly excellent contrast.

In the color filter ink as described above, a relationship 0.05≦X_{D}/X_{PG}≦1.50 is preferably satisfied, wherein a value X_{PD} (wt %) indicates a content ratio of the dispersing agent in the color filter ink, and a value X_{PG} (wt %) indicates a content ratio of the halogenated phthalocyanine zinc complex.

Particularly excellent dispersion properties of the pigment in the color filter ink can thereby be obtained, and the color filter ink can be provided with particularly excellent storage stability. The waste ink can also be reliably prevented from increasing in viscosity and solidifying, and droplets can be stably discharged over a long period of time.

In the color filter ink as described above, a relationship 3.0≦X_{LA}/X_{LB}≦13.0 is preferably satisfied, wherein a value X_{LA} (wt %) indicates a content of the first liquid, and a value X_{LB} (wt %) indicates a content ratio of the second liquid in the color filter ink.

The waste ink can thereby be reliably prevented from increasing in viscosity and solidifying during cleaning, while the liquid medium is adequately prevented from evaporating during discharge. As a result, clogging of the droplet discharge head, flight deflection, and the like are suppressed over a long period of time, and droplets can be stably discharged. The manufactured color filter can therefore be provided with higher quality and excellent uniformity of characteristics between individual units.

In the color filter ink as described above, a relationship 0.32≦X_{D}/X_{LB}<3.0 is preferably satisfied, wherein a value X_{D} (wt %) indicates a content ratio of the dispersing agent in the color filter ink, and a value X_{LB} (wt %) indicates a content ratio of the second liquid.

Particularly excellent dispersion properties of the pigment in the color filter ink can thereby be obtained, and the color filter ink can be provided with particularly excellent storage stability. During cleaning, the discharged droplets can also rapidly dissolve the dispersing agent included in the waste ink. Even when a small quantity of droplets are discharged, the dispersing agent included in the waste ink can be suitably dissolved. The waste ink can thereby be reliably prevented from increasing in viscosity and solidifying, and droplets can be stably discharged over a long period of time.

The color filter ink as described above preferably further includes a resin material including a first polymer containing at least a first epoxy-containing vinyl monomer as a monomer component.

The first polymer thereby does not readily cure in the discharged waste ink, and the viscosity of the waste ink is suitably prevented from increasing. The colored portion formed using the color filter ink can also be provided with particularly excellent solvent resistance. Particularly excellent dispersion stability of the pigment such as described above in the color filter ink can be obtained, and the color filter ink can be provided with particularly excellent long-term storage properties and discharge stability.

In the color filter ink as described above, the first polymer is preferably a copolymer having the first epoxy-containing vinyl monomer and a second vinyl monomer as monomer components, the second vinyl monomer having an isocyanate group or a block isocyanate group in which an isocyanate group is protected by a protective group.

The content ratio of gas (dissolved gas, bubbles present as microbubbles, or the like) in the color filter ink can thereby be reduced more effectively, and particularly excellent droplet discharge stability by the inkjet method can be obtained. As a result, it is possible to more effectively prevent the occurrence of uneven color, uneven saturation, and the like between different regions of the manufactured color filter, and fluctuation of characteristics between individual units. The first polymer is also particularly resistant to curing in the discharged waste ink, and the viscosity of the waste ink is suitably prevented from increasing.

In the color filter ink as described above, the first polymer is preferably a copolymer having the first epoxy-containing vinyl monomer and a third vinyl monomer as monomer components, the third vinyl monomer having a hydroxyl group.

A suitable angle of contact of the color filter ink with respect to the discharge ports (nozzles) can thereby be obtained, and the ink is provided with excellent drying. Specifically, the ink is provided with particularly excellent droplet discharge stability. The colored portion formed using the color filter ink can thereby be provided with particularly excellent adhesion to the substrate, particularly adhesion under repeated exposure to sudden temperature changes that accompany image display.

The color filter ink as described above preferably further includes a resin material including a second polymer containing at least an alkoxysilyl-containing vinyl monomer indicated by Formula (2) below as a monomer component.

Formula (2)

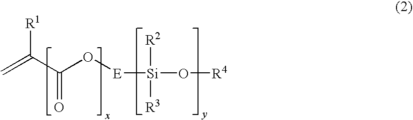

In Formula (2), R¹ represents a hydrogen atom or a C₁₋₇ alkyl group, E represents a single bond hydrocarbon group or a bivalent hydrocarbon group, R² represents a C₁₋₆ alkyl group or a C₁₋₆ alkoxyl group, R represents a C₁₋₆ alkyl group or a C₁₋₆ alkoxyl group, R⁴ represents a C₁₋₆ alkyl group, a value x is 0 or 1, and a value y is an integer from 1 to 10.

The ink discharged onto the substrate can thereby be suitably spread out on the substrate, and the thickness of the obtained colored portion can be made particularly uniform as a result. The obtained color filter can therefore be provided with a particularly low occurrence of uneven color and saturation among different regions. The colored portion can also be formed under relatively mild conditions, and the formed colored portion can be provided with adequately excellent hardness, adhesion to the substrate, light fastness, thermal resistance, and other characteristics. The polymer B is also particularly resistant to curing in the discharged waste ink, and the viscosity of the waste ink is suitably prevented from increasing.

A color filter ink set according to a second aspect including a plurality of different colors of color filter ink with a green ink being the color filter ink as described above.

It is thereby possible to provide a color filter ink set comprising the inkjet-type color filter ink capable of stable discharge from an inkjet head over a long period of time, that can be stably and suitably used to manufacture a color filter in which unevenness of color and saturation between regions is suppressed, that has excellent uniformity of characteristics between individual units, and that enables image display having excellent contrast and brightness.

A color filter according to a third aspect is manufactured using the color filter ink as described above.

It is thereby possible to provide a color filter in which unevenness of color and saturation between regions is suppressed, that has excellent uniformity of characteristics between individual units, and that enables image display having excellent contrast and brightness.

A color filter according to a fourth aspect is manufactured using the color filter ink set as described above.

It is thereby possible to provide a color filter in which unevenness of color and saturation between regions is suppressed, that has excellent uniformity of characteristics between individual units, and that enables image display having excellent contrast and brightness.

An image display device according to a fifth aspect has the color filter as described above.

It is thereby possible to provide an image display device comprising a color filter in which unevenness of color and saturation between regions is suppressed, that has excellent uniformity of characteristics between individual units, and that enables image display having excellent contrast and brightness.

The image display device as described above is preferably a liquid crystal panel.

It is thereby possible to provide an image display device comprising a color filter in which unevenness of color and saturation between regions is suppressed, that has excellent uniformity of characteristics between individual units, and that enables image display having excellent contrast and brightness.

An electronic device according to a sixth aspect has the image display device as described above.

It is thereby possible to provide an electronic device comprising a color filter in which unevenness of color and saturation between regions is suppressed, that has excellent uniformity of characteristics between individual units, and that enables image display having excellent contrast and brightness.

### BRIEF DESCRIPTION OF THE DRAWINGS

Referring now to the attached drawings which form a part of this original disclosure:

FIG. 1 is a cross-sectional view showing a preferred embodiment of a color filter according to the present invention.

FIG. 2 includes a series of cross-sectional views (1a) to (1e) showing a method for manufacturing a color filter.

FIG. 3 is perspective view showing a droplet discharge device used in the manufacture of the color filter.

FIG. 4 is a view of the droplet discharge means of the droplet discharge device shown in FIG. 3 as seen from the stage.

FIG. 5 is a view showing the bottom surface of the droplet discharge head of the droplet discharge device shown in FIG. 3.

FIG. 6 includes a pair of diagrams (a) and (b) showing a droplet discharge head of the droplet discharge device shown in FIG. 3, wherein FIG. 6(a) is a cross-sectional perspective view and FIG. 6(b) is a cross-sectional view.

FIG. 7 a schematic cross sectional view showing a portion of the cleaning mechanism in the droplet discharge device shown in FIG. 3.

FIG. 8 is a cross-sectional view showing an embodiment of a liquid crystal display device.

FIG. 9 is a perspective view showing a mobile (or notebook) personal computer exemplifying an electronic device in accordance with the present invention.

FIG. 10 is a perspective view showing a portable telephone (including PHS) exemplifying an electronic device in accordance with the present invention.

FIG. 11 is a perspective view showing a digital still camera exemplifying an electronic device in accordance with the present invention.

### DETAILED DESCRIPTION OF EXEMPLARY EMBODIMENTS

Preferred embodiments of the present invention will be described in detail hereinafter.

### Color Filter Ink

The color filter ink of the present invention is an ink used to manufacture (form the colored portion of a color filter) a color filter, and is used particularly in the manufacture of a color filter by an inkjet method.

The color filter ink of the present invention includes a pigment, a dispersing agent for dispersing the pigment, and a liquid medium in which the pigment disperses.

The inventors discovered that a green colored portion having excellent brightness and contrast in comparison to C. I. Pigment Green 36 can be formed through the use of a halogenated phthalocyanine zinc complex (also referred to hereinafter as a halogenated phthalocyanine complex) as a pigment of the green color filter ink in the manufacture of a color filter as described above. However, a halogenated phthalocyanine zinc complex has inferior dispersion stability in the ink. In such a case, when ink droplets are discharged for long periods of time, and droplets are discharged continuously, the trajectory of the discharged droplets varies (so-called flight deflection occurs) due to mist contamination and the like near the nozzles, and problems occur in that it becomes impossible to land the droplets in the desired position, the droplet discharge head becomes clogged, the droplet discharge quantity becomes unstable, and other problems occur. Specifically, adequately excellent droplet discharge stability is difficult to obtain.

Since the droplet discharge device (industrial) used for color filter manufacturing is entirely different from what is used for a printer (consumer-level), and the droplet discharge device is used for mass production, for example, there is a need to discharge large quantities of droplets for long periods of time. In a droplet discharge device (industrial) used for color filter manufacturing, since the viscosity of the ink is generally high in comparison to the ink used in a consumer-level droplet discharge device used in a printer, drying during discharge is a problem, and ink readily remains in the discharge ports (nozzles) of the inkjet head. As a result, when discharge is performed continuously for long periods of time, the discharge ports of the inkjet head become blocked, and flight deflection of droplets occurs more frequently.

Cleaning for cleaning the inkjet head is periodically performed in order to stably perform discharge over a long period of time under such harsh conditions. The inkjet head is cleaned by a method (spitting) whereby droplets are discharged on a portion of the droplet discharge device that does not include the substrate (workpiece) used for the color filter, or a method whereby a suction means is used to forcibly draw in the ink accumulated in the inkjet head, for example. Waste ink generated by discharge usually accumulates in the portions of the droplet discharge device in which such cleaning is performed. Such waste ink is usually removed by suction or another means.

However, when a color filter ink is used that includes a halogenated phthalocyanine zinc complex, the viscosity of the waste ink readily increases, and the pigment or the like readily aggregates and solidifies. A color filter ink generally differs from consumer ink in that it is difficult to re-disperse the solidified color filter ink. Therefore, when cleaning is repeated in a certain location, the solidified waste ink accumulates rather than being removed, and forms a solid body. As a result, when ink is discharged onto the solid body during cleaning, the discharged droplets collide with the solid body and scatter, and the scattered droplets readily adhere to the area near the discharge ports of the inkjet head. The solid body and the inkjet head sometimes come in contact with each other. Therefore, when a color filter ink containing a halogenated phthalocyanine zinc complex is used during manufacturing of a color filter, droplet discharge sometimes becomes unstable when droplets are discharged for a long time, even when cleaning of the inkjet head is adequately performed. Specifically, waste ink or solids adhered to the inkjet head lead to nozzle blockage, flight deflection, or other problems. The waste ink also sometimes intrudes into the color filter cells, and flight deflection may make it impossible to discharge into the desired cell.

When such problems occur, cells that are colored by mixed ink (defects) occur in the obtained color filter. Fluctuation occurs in the color saturation between the plurality of colored portions that is supposed to have the same color saturation, and as a result, light leakage and unevenness of color and saturation occur between regions of the color filter, fluctuation occurs in the characteristics (particularly contrast ratio, color reproduction range, and other color characteristics) among numerous color filters, and the reliability of the color filters is reduced.

In the present invention, however, the color filter ink includes a halogenated phthalocyanine zinc complex as well as a sulfonated pigment derivative indicated by Formula (1) below as pigments. As components constituting the liquid medium, the color filter ink also includes at least a liquid A, and a liquid B different than the liquid A that is capable of easily dissolving a dispersing agent.

Formula (1)

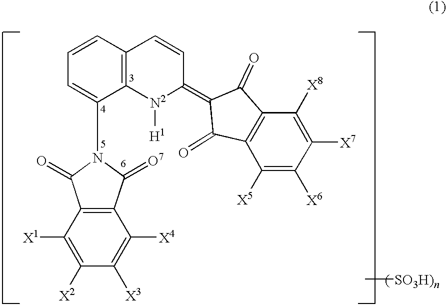

In Formula (1), n is an integer from 1 to 5; and X¹ through X⁸ are each independently a hydrogen atom or a halogen atom.

The sulfonated pigment derivative (also referred to hereinafter as the sulfonated pigment derivative) indicated by Formula (1) above is capable of entering between molecules of the halogenated phthalocyanine complex and preventing aggregation of the halogenated phthalocyanine complex. The halogenated phthalocyanine complex is thereby prevented from aggregating in the ink, and the halogenated phthalocyanine complex can be dispersed in a microparticulate state. Even when the concentration of solids in the waste ink is relatively high, the fine-particles of the halogenated phthalocyanine complex can be prevented from aggregating in the waste ink, and the halogenated phthalocyanine complex is easily re-dispersed by adding ink even when the waste ink is solidified.

The dispersing agent is a component capable of suitably and stably dispersing the micro-particulate halogenated phthalocyanine complex in the liquid medium. The halogenated phthalocyanine complex can therefore be stably dispersed in the color filter ink for a long period of time.

The color filter ink furthermore includes a liquid B capable of easily dissolving the dispersing agent. Ink droplets discharged onto the accumulated waste ink when re-cleaning is performed can thereby rapidly mix with the waste ink and easily dissolve the dispersing agent in the waste ink even when the viscosity of the waste ink generated during cleaning has increased. The dispersing agent in the waste ink can therefore suitably re-disperse the pigment or the like. At this time, the halogenated phthalocyanine complex is prevented from solidifying by the sulfonated pigment derivative, and the halogenated phthalocyanine complex is easily re-dispersed into the liquid medium.

By the synergistic action of such effects, the waste ink can be prevented from increasing in viscosity and solidifying, and the waste ink can be provided with fluidity. The waste ink can therefore be suitably removed by suction or other means. By thus suitably removing the waste ink, solid bodies are prevented from forming, and it is possible to prevent ricocheting droplets from adhering to the inkjet head during cleaning, and to prevent the inkjet head and solid body from coming in contact. Through the use of the color filter ink of the present invention as described above, blockage of the inkjet head and flight deflection of discharged droplets can be prevented, and droplets can be discharged stably for long periods of time. Uneven color and saturation between regions, and light leakage are also suppressed, and excellent uniformity of characteristics between units is obtained in the color filters manufactured using such a color filter ink. Coloration of cells by mixed ink (defects) can also be prevented in the manufactured color filter.

The components constituting the color filter ink of the present invention will next be described in detail.

### Pigment

As described above, the color filter ink of the present invention includes a halogenated phthalocyanine zinc complex as a main pigment, and a sulfonated pigment as a secondary pigment.

### Maim Pigment (Halogenated Phthalocyanine Zinc Complex)

The zinc complex of a halogenated phthalocyanine as the main pigment is provided with zinc as the central metal, and a halogenated phthalocyanine as a ligand. A zinc complex of a halogenated phthalocyanine has excellent brightness in comparison to C. I. Pigment Green 7 or C. I. Pigment Green 36. Therefore, a color filter having excellent brightness can be formed through the use of a color filter ink that includes a zinc complex of a halogenated phthalocyanine.

In a halogenated phthalocyanine, at least a portion of the hydrogen atoms of the benzene ring constituting the phthalocyanine is replaced by halogen atoms. Any halogenated phthalocyanine may be used insofar as such a condition is satisfied, but a halogenated phthalocyanine having the chemical structure indicated by Formula (3) below is preferred. A zinc complex of a halogenated phthalocyanine having such a structure has excellent brightness and luminance, as well as excellent coloration properties.

Formula (3)

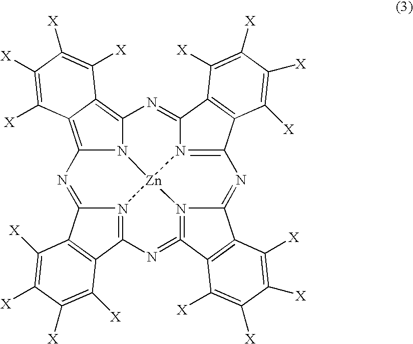

In Formula (3), X are each independently a hydrogen atom (H), a chlorine atom (Cl), or a bromine atom (Br), wherein the number of H atoms in each molecule is 0 to 4, the number of Cl atoms is 0 to 8, and the number of Br atoms is 4 to 16.

The content ratio of the halogenated phthalocyanine zinc complex in the color filter ink is not particularly limited, but is preferably 2.8 to 10.7 wt %, and more preferably 2.9 to 8.6 wt %.

The zinc complex of a halogenated phthalocyanine may be composed of a single compound, or may be a mixture of a plurality of types of compounds.

### Secondary Pigment

As described above, the color filter ink in the present invention includes as pigments a halogenated phthalocyanine zinc complex (main pigment), as well as a sulfonated pigment derivative indicated by Formula (1) above as a secondary pigment.

By thus including a halogenated phthalocyanine complex (main pigment) as well as this type of sulfonated pigment derivative in the color filter ink, the halogenated phthalocyanine complex can be prevented from aggregating in the color filter ink, and the grain size of the pigment particles in the ink can be made uniform for long periods of time. The physical properties of the ink can therefore be prevented from changing over long periods of time. The halogenated phthalocyanine complex is also prevented from aggregating in the waste ink, and the halogenated phthalocyanine complex in the waste ink can be easily re-dispersed by adding the liquid medium. The color filter manufactured using the color filter ink can also be provided with extremely excellent contrast and brightness. By including such a sulfonated pigment derivative in the color filter ink, the hue of the colored portions of the obtained color filter can be adjusted, and the color filter is provided with a wide color reproduction range.

The sulfonated pigment derivative used as the secondary pigment is obtained by sulfonation of a compound indicated by Formula (4) below.

Formula (4)

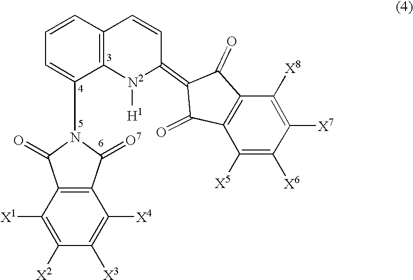

In Formula (4), X¹ through X⁸ are each independently a hydrogen atom or a halogen atom.

Sulfonation can be performed by an aromatic substitution reaction using fuming sulfuric acid, concentrated sulfuric acid, or a mixture of fuming sulfuric acid and concentrated sulfuric acid; a mixture of sulfuric acid and phosphorus pentoxide; chlorosulfonic acid, sodium bisulfate, or a mixture of sulfuryl chloride and aluminum chloride; or another sulfonating agent, for example. The reaction system may also be heated as necessary during the aromatic substitution reaction.

A catalyst may also be used as needed in the sulfonation treatment. Examples of catalysts that may be used include calcium sulfate, aluminum sulfate, iron sulfate, and other metal salts of sulfuric acid and the like. Undesirable secondary reactions can be prevented/suppressed, the reaction conditions can be mitigated, the reaction rate can be increased, and other effects, for example, are obtained through the use of a catalyst.

The amount of catalyst used is not particularly limited, but is preferably 0.05 to 10 parts by weight with respect to 100 parts by weight of the pigment to be sulfonated.

Ethylene glycol, propylene glycol, chloroform, ethylene chloride, carbon tetrachloride, or the like may also be used in the reaction system as needed in order to control (suppress) the reaction rate in the sulfonation treatment.

After the sulfonation reaction is completed, the sulfonated pigment derivative can be precipitated by pouring the reacted mixture into an excess of water with respect to the sulfonating agent used. The desired sulfonated pigment derivative is obtained by filtering out the sulfonated pigment derivative, washing the product with dilute hydrochloric acid or another dilute acid, and then rinsing and drying the product. When chloroform, ethylene chloride, carbon tetrachloride, or another water-insoluble volatile solvent is used, the solvent is preferably removed prior to adding the reacted mixture to water.

A sulfonic acid obtained as described above may be used as the secondary pigment (sulfonated pigment derivative) without modification, or a salt of the aforementioned sulfonic acid may be used as the secondary pigment (sulfonated pigment derivative). Examples of compounds or atoms that form a salt with the aforementioned sulfonic acid include lithium, potassium, sodium, calcium, magnesium, strontium, aluminum, and other metal atoms having valences of 1 to 3; organic amines such as ethyl amine, butyl amine, and other monoalkyl amines; dimethyl amine, diethyl amine, and other dialkyl amines; trimethyl amine, triethyl amine, and other trialkyl amine monoethanol amines; diethanol amine, triethanol amine, and other alkanol amines; ammonia; and the like.

Among these examples, when the sale is an alkali metal salt, the salt becomes aqueous, and such effects as the following are obtained. Specifically, after the salt is dissolved in water, anhydrous impurities can easily be separated merely by filtration, and the sulfonated pigment derivative can be obtained in a state of high purity.

The inventors discovered as a result of concentrated investigation that such excellent effects as described above are obtained through the use of a sulfonated pigment derivative (secondary pigment) having a specific chemical structure together with a halogenated phthalocyanine zinc complex (main pigment), and although the mechanism of these effects is not known in detail, the effects are considered to be obtained for such reasons as those described below. A highly conjugated system is formed by the molecule as a whole in the halogenated phthalocyanine complex that constitutes the main pigment, and a planar structure is energetically stable. Planar molecules of the halogenated phthalocyanine complex are in a layered (parallel to each other) arrangement, whereby a stable state occurs in which π electrons of conjugated systems between molecules are overlapped. The main pigment is therefore easily aggregated, and difficult to stably disperse in a solvent. In a sulfonated pigment derivative such as described above, the hydrogen atom bonded to a nitrogen atom in Formula (1) forms a hydrogen bond between the oxygen atoms that form a phthalimide structure. For this reason, the hydrogen atom bonded to a nitrogen atom in Formula (1) essentially forms a strong bond with the nitrogen atom forming the quinoline structure, as well as the oxygen atom forming the phthalimide structure, and in a sulfonated pigment derivative such as described above, a stable ring structure (seven-member ring structure) is formed by the seven atoms that are labeled 1 through 7 in Formula (1). A non-parallel state with respect to the plane of the quinoline structure and the plane of the phthalimide structure occurs through the formation of such a seven-member ring structure, and a molecule having a large overall size is formed.

The plane of the quinoline structure, and the plane of the phthalimide structure are thus non-parallel, whereby a sulfonated pigment derivative having the appropriate degree of affinity to a halogenated phthalocyanine is introduced between molecules of the halogenated phthalocyanine zinc complex, and the halogenated phthalocyanine zinc complex, which is originally easily aggregated as described above, can be made less prone to aggregate.

As described above, the sulfonated pigment derivative in the present invention may have the chemical structure indicated by Formula (1), but the sulfonated pigment derivative preferably has the chemical structure indicated by Formula (5) below. Effects such as those described above are thereby more significantly demonstrated. The reason for this is considered to be that due to being halogenated to a high degree, the sulfonated pigment derivative is provided with an appropriately large size, and can more suitably prevent the halogenated phthalocyanine complex from aggregating. The sulfonated pigment derivative can also have suitable polarity, and excellent affinity thereof to the resin material (particularly the curable resin material such as described hereinafter) such as described hereinafter can be maintained.

Formula (5)

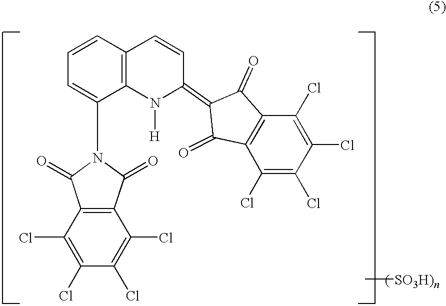

In Formula (5), n is an integer from 1 to 5.

The content ration of the sulfonated pigment derivative in the color filter ink is not particularly limited, but is preferably 0.07 to 2.7 wt %, and more preferably 0.2 to 2.1 wt %.

The relation 0.05≦X_{PD}/X_{PG}≦0.30 is preferably satisfied, and the relation 0.07≦X_{PD}/X_{PG}≦0.28 is more preferably satisfied, wherein X_{PD} (wt %) is the content ratio of the sulfonated pigment derivative in the color filter ink, and X_{PG} (wt %) is the content ratio of the halogenated phthalocyanine complex. The pigment particles in the color filter ink are thereby more reliably prevented from aggregating, and the grain size of the pigment particles is uniform for a longer period of time. The colored portion formed using the color filter ink can also be provided with particularly excellent brightness and contrast.

The sulfonated pigment derivative (secondary pigment) may be composed of a single compound, or may be a mixture of a plurality of types of compounds.

### Other Pigments

It is sufficient in the present invention insofar as the color filter ink includes a halogenated phthalocyanine complex (main pigment), and a sulfonated pigment derivative (secondary pigment) as pigments, but the color filter ink may also include other pigment components (other pigments).

Various organic pigments and various inorganic pigments may be used as the other pigments, but more specific examples include compounds classified as pigments in the Color Index (C. I.; issued by The Society of Dyers and Colorists), and more specifically, compounds such as those below numbered according to the Color Index (C. I.). Specifically, examples of other pigments include C. I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:1, 48:2, 48:3, 48:4, 49:1, 49:2, 50:1, 52:1, 53:1, 57, 57:1, 57:2, 58:2, 58:4, 60:1, 63:1, 63:2, 64:1, 81, 81:1, 83, 88, 90:1, 97, 101, 102, 104, 105, 106, 108, 108:1, 112, 113, 114, 122, 123, 144, 146, 149, 150, 151, 166, 168, 170, 171, 172, 174, 175, 176, 177, 178, 179, 180, 185, 187, 188, 190, 193, 194, 202, 206, 207, 208, 209, 215, 216, 220, 224, 226, 242, 243, 245, 254, 255, 264, and 265; C. I. Pigment Green 7, 36, 15, 17, 18, 19, 26, 50, and 60; C. I. Pigment Blue 1, 15, 15:1, 15:2, 15:3, 15:4, 15:6, 17:1, 18, 60, 27, 28, 29, 35, 36, and 80; C. I. Pigment Yellow 1, 3, 12, 13, 14, 15, 16, 17, 20, 24, 31, 34, 35, 35:1, 37, 37:1, 42, 43, 53, 55, 60, 61, 65, 71, 73, 74, 81, 83, 93, 94, 95, 97, 98,100, 101, 104, 106, 108, 109, 110, 113, 114, 116, 117, 119, 120, 126, 127, 128, 129, 138, 139, 150, 151, 152, 153, 154, 155, 156, 157, 166, 168, 175, 180, 184, and 185; C. I. Pigment Violet 1, 3, 14, 16, 19, 23, 29, 32, 36, 38, and 50; C. I. Pigment Orange 1, 5, 13, 14, 16, 17, 20, 20:1, 24, 34, 36, 38, 40, 43, 46, 49, 51, 61, 63, 64, 71, 73, and 104; C. I. Pigment Brown 7, 11, 23, 25, and 33; and derivatives of these pigments and the like, and one or more types of pigments selected from the above examples may be combined and used.

The content ratio of the pigments (including the main pigment and the secondary pigment) in the color filter ink is preferably 2.0 to 25 wt %, more preferably 3.5 to 20 wt %, and more preferably 4.0 to 15 wt %. When the content ratio of the pigments is within the aforementioned range, higher color saturation can be maintained in the color filter that is manufactured using the color filter ink, and the color filter can be used for clearer image display. The amount of the color filter ink that is needed to form a colored portion having a predetermined color saturation can also be reduced, which is advantageous from the perspective of resource saving. Since the amount of evaporation of the solvent can be suppressed during formation of the colored portion of the color filter, the environmental impact can be reduced. In the conventional technique, when the pigment is included in such a relatively high concentration, the discharge stability is particularly low, and flight deflection, instability of the droplet discharge quantity, and other problems occur particularly easily when droplets of the color filter ink are discharged. Also in the conventional technique, such problems as a severe occurrence of defects due to fluctuation of the discharge quantity among different locations on the surface, and marked reduction of production properties of the color filter occurs particularly when droplets are discharged onto a large substrate (e.g., G5 or larger) to form colored portions. In the present invention, however, even when the pigment is included at a relatively high concentration, such problems as those described above can be reliably prevented from occurring, unevenness of color, saturation, and the like in different locations of the manufactured color filter, or fluctuation of characteristics between individual units can be reliably prevented, and a color filter can be manufactured with excellent productivity, as described in detail hereinafter. Specifically, the effects of the present invention are more significantly demonstrated when the color filter ink includes a relatively high concentration of the pigment, as described above. The durability of the manufactured color filter can also be made particularly excellent.

The average grain size of the pigment particles in the color filter ink is not particularly limited, but is preferably 10 to 200 nm, and more preferably 20 to 180 nm. The dispersion stability of the pigment in the color filter ink, as well as the contrast, brightness, and other characteristics in the color filter can thereby be made particularly excellent while making the light fastness of the color filter manufactured using the color filter ink adequately superior.

### Liquid Medium

The liquid medium (liquid vehicle) has the function of dispersing pigments such as those described above. Specifically, the liquid medium functions as a pigment dispersion medium. Usually, most of the liquid medium is removed in the process of manufacturing the color filter. When a resin material (curable resin material, thermoplastic resin material) or a dispersing agent such as described hereinafter is included in the color filter ink, the liquid medium also functions as a solvent for dissolving these components.

Ester compounds, ether compounds, hydroxyketones, carbonic diesters, cyclic amide compounds, and the like, for example, may be used as the components constituting the liquid medium, preferred among which are (1) ethers (polyalcohol ethers) as condensates of polyalcohols (e.g., ethylene glycol, propylene glycol, butylene glycol, glycerin, and the like); alkyl ethers (e.g., methyl ether, ethyl ether, butyl ether, hexyl ether, and the like) of polyalcohols or polyalcohol ethers; and esters (e.g., formate, acetate, propionate, and the like); (2) esters (e.g., methyl esters and the like) of polycarboxylic acids (e.g., succinic acid, glutamic acid, and the like); (3) ethers, esters, and the like of compounds (hydroxy acids) having at least one hydroxyl group and at least one carboxyl group in the molecule thereof; and (4) carbonic diesters having a chemical structure such as that obtained by reaction of a polyalcohol and a phosgene. Examples of compounds that can be used as the liquid medium include butyl cellosolve, ethylene glycol monohexyl ether, ethylene glycol 2-ethylhexyl ether, diethylene glycol, diethylene glycol monomethyl ether, diethylene glycol monoethyl ether, diethylene glycol monopropyl ether, diethylene glycol monobutyl ether, diethylene glycol monohexyl ether, diethylene glycol mono-2-ethyl hexyl ether, triethylene glycol monomethyl ether, triethylene glycol monoethyl ether, triethylene glycol monopropyl ether, triethylene glycol monobutyl ether, 1,3-butylene glycol, ethylene glycol, butoxy propanol, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monobutyl ether, polyethylene glycol monomethyl ether, n-nonyl alcohol, ethylene glycol butyl methyl ether, diethylene glycol dimethyl ether, diethylene glycol methyl ethyl ether, diethylene glycol diethyl ether, diethylene glycol diethyl ether, diethylene glycol methyl propyl ether, diethylene glycol ethyl propyl ether, diethylene glycol methyl butyl ether, diethylene glycol butyl ethyl ether, diethylene glycol butyl propyl ether, triethylene glycol dimethyl ether, triethylene glycol methyl ethyl ether, triethylene glycol methyl propyl ether, triethylene glycol butyl methyl ether, triethylene glycol ethyl propyl ether, triethylene glycol butyl ethyl ether, tetraethylene glycol dimethyl ether, dipropylene glycol dimethyl ether, bis(2-butoxyethyl)ether, diethyl succinate, dimethyl succinate, dimethyl glutarate, diethyl glutarate, ethyl 3-ethoxy propionate, methyl octanoate, ethyl octanoate, ethylene glycol dibutyrate, 4-methyl-1,3-dioxolan-2-one, 4-hydroxy-4-methyl-2-pentanone, diacetin, butyl glycolate, N-methyl-2-pyrrolidone, ethylene glycol butyl ether acetate, diethylene glycol methyl ether acetate, diethylene glycol ethyl ether acetate, diethylene glycol propyl ether acetate, diethylene glycol butyl ether acetate, propylene glycol methyl ether acetate, 2-(2-methoxy-1-methylethoxy)-1-methyl ethyl acetate, dipropylene glycol monomethyl ether acetate, triethylene glycol methyl ether acetate, triethylene glycol ethyl ether acetate, triethylene glycol propyl ether acetate, triethylene glycol butyl ether acetate, propylene glycol diacetate, 3-methoxy butyl acetate, diethylene glycol monoethyl ether acetate, cyclohexyl acetate, ethylene glycol diacetate, diethylene glycol diacetate, triethylene glycol diacetate, 1,3-butylene glycol diacetate, 1,6-diacetoxyhexane, and the like, and one or more types of compounds selected from the above examples may be combined and used.

At least a liquid A (first liquid), and a liquid B (second liquid) different than the liquid A are included as components constituting the liquid medium.

The liquid A and the liquid B each satisfy predetermined conditions such as described hereinafter. The liquid A and the liquid B will next be described.

### Liquid A

The liquid A is a liquid that does not readily evaporate at normal temperature. By including such a liquid A in the liquid medium, the liquid medium as a whole does not readily evaporate even when the liquid B readily evaporates at normal temperature, and droplets can be discharged stably for long periods of time.

Specifically, the boiling point at atmospheric pressure (1 atmosphere) of the liquid A is 180 to 290° C. When the boiling point of the liquid A at atmospheric pressure is within this range, blockage and the like in the droplet discharge head for discharging the color filter ink can be more effectively prevented, and the color filter can be manufactured with particularly excellent productivity. It is also possible to effectively prevent the liquid medium from evaporating in the waste ink discharged during cleaning, and to prevent the viscosity of the waste ink from increasing. The waste ink can therefore be easily removed from the position at which the droplet discharge device was cleaned, and the waste ink can be reliably prevented from solidifying into a solid body. Droplets can therefore be discharged stably for long periods of time. In contrast, when the boiling point of the liquid A is less than the lower limit of the aforementioned range, the liquid medium in the color filter ink easily evaporates during discharge, and blockage or flight deflection frequently occurs. The liquid medium in the waste ink discharged by cleaning also readily evaporates, and there is a severe increase in the viscosity of the waste ink. As a result, droplets cannot be stably discharged over long periods of time. When the boiling point of the liquid A exceeds the upper limit, it is difficult to suitably remove the liquid medium in the color filter ink that is on the color filter substrate after discharge. The removal step must therefore be performed for a long time or at a relatively high temperature in order to adequately remove the liquid medium, the manufactured color filter is often changed or deformed by heat, and uniformity between units is not obtained. The pigment and other materials may also be altered during drying. It is sufficient insofar as the boiling point of the liquid A is within the abovementioned range, but the boiling point is more preferably 190 to 280° C., and more significant effects can be obtained. In the present specification, the boiling point referred to is the boiling point at atmospheric pressure (1 atmosphere) unless specifically noted.

The vapor pressure at 20° C. of the liquid A is preferably 0.10 mmHg or lower. When the vapor pressure of the liquid medium is adequately low, blockage and other problems in the droplet discharge head for discharging the color filter ink can be more effectively prevented, and the color filter can be manufactured with particularly excellent productivity. It is also possible to effectively prevent evaporation of the liquid medium in the waste ink discharged during cleaning, and to prevent the viscosity of the waste ink from increasing. The waste ink can therefore be easily removed from the position at which the droplet discharge device was cleaned, and the waste ink can be reliably prevented from solidifying into a solid body. Droplets can therefore be discharged stably for long periods of time. The vapor pressure referred to in the present specification is the vapor pressure at 20° C.

The content of the liquid A in the color filter ink is preferably 20 to 80 wt %, and more preferably 48 to 72 wt %. When the content ratio of the liquid A is within this range, blockage of the inkjet head due to liquid medium evaporation and the like can be suitably prevented, and it is possible to reliably prevent evaporation of the liquid medium in the waste ink discharged during cleaning. The color filter ink can also be provided with suitable viscosity and particularly excellent discharge properties from the droplet discharge head used for the color filter. Adequate color saturation can also be maintained while excellent durability is maintained in the manufactured color filter.

The liquid A is not particularly limited insofar as the boiling point thereof is within such a range as described above, and the liquid A is preferably a liquid selected from triethylene glycol dimethyl ether, 4-methyl-1,3-dioxolan-2-one, ethylene glycol butyl methyl ether, ethylene glycol di-n-butyrate, tetraethylene glycol dimethyl ether, butoxy propanol, diethylene glycol methyl ethyl ether, diethylene glycol methyl butyl ether, triethylene glycol methyl ethyl ether, 2-(2-methoxy-1-methylethoxy)-1-methyl ethyl acetate, diethylene glycol diethyl ether, ethyl octanoate, ethylene glycol monobutyl ether acetate, diethylene glycol butyl ether acetate, 3-methoxy butyl acetate, ethylene glycol diacetate, 4-hydroxy-4-methyl-2-pentanone, dipropylene glycol monomethyl ether, polyethylene glycol monomethyl ether, butyl glycolate, ethylene glycol monohexyl ether, dipropylene glycol mono n-butyl ether, N-methyl-2-pyrrolidone, triethylene glycol butyl methyl ether, bis(2-propoxyethyl)ether, diethylene glycol butyl ethyl ether, diethylene glycol butyl propyl ether, diethylene glycol ethyl propyl ether, dipropylene glycol dimethyl ether, diethylene glycol methyl propyl ether, diethylene glycol monobutyl ether acetate, diethylene glycol propyl ether acetate, triethylene glycol methyl ether acetate, triethylene glycol ethyl ether acetate, triethylene glycol propyl ether acetate, triethylene glycol butyl ether acetate, triethylene glycol butyl ethyl ether, triethylene glycol ethyl propyl ether, triethylene glycol methyl propyl ether, n-nonyl alcohol, triethylene glycol monomethyl ether, tripropylene glycol mono n-butyl ether, 1,3-butylene glycol, ethylene glycol, diethylene glycol, diethylene glycol diethyl ether, 1,3-butylene glycol, and 3-methoxy butyl acetate. Among such compounds, such effects as those described below are obtained when ethylene glycol diacetate, ethyl octanoate, 2-(2-methoxy-1-methylethoxy)-1-methyl ethyl acetate, ethylene glycol monobutyl ether acetate, and diethylene glycol monobutyl ether acetate are used. Such compounds have particularly excellent affinity to the sulfonated pigment derivative. Including a liquid having such high affinity to the sulfonated pigment derivative as the liquid A in the liquid medium makes it possible to disperse the halogenated phthalocyanine complex with particular stability in the liquid medium. The color filter ink can therefore be provided with particularly excellent discharge stability of droplets; unevenness of color, saturation, and the like in regions of the manufactured color filter can be more effectively suppressed, and the color filter can be provided with particularly excellent uniformity of characteristics between individual units. When the liquid A is composed of a compound such as described above, because of the chemical structural interaction between the compound, the aforementioned pigments, and a curable resin material such as described in detail hereinafter, the curable resin material can be unevenly distributed on the surfaces of the pigment particles in the color filter ink, particularly excellent discharge stability of droplets can be obtained, the dispersion stability of the pigment particles in the color filter ink can be made particularly excellent, and the color filter ink can be provided with particularly excellent long-term storage properties while the dissolving properties of the curable resin material are made adequately excellent. When the liquid A is a compound such as described above, the color filter ink can be reliably made to spread into the entire cell in the method for manufacturing a color filter such as described hereinafter, and a flattened colored portion can easily be formed even when the conditions for removing the liquid medium are not strictly prescribed. In other words, the internal shape of the pixels is easily controlled during baking.

Among the above examples, when the liquid A is 2-(2-methoxy-1-methylethoxy)-1-methyl ethyl acetate, ethylene glycol monobutyl ether acetate, or ethyl octanoate, the ink can be provided with a relatively low viscosity and particularly excellent droplet discharge stability. The ink can also instantly spread into the corners on the substrate, and the thickness of the obtained color filter is made uniform, whereby particularly excellent color reproduction properties and depolarization properties (contrast ratio) can be obtained. When a curable resin material such as described hereinafter is included in the ink, the solubility parameters (SP values) of the liquid A and the curable resin are close to each other, and the ink has high dispersion stability and minimal variation in viscosity over long periods of time.

When the liquid A includes diethylene glycol monobutyl ether acetate among the examples described above, the ink is extremely unlikely to dry in the vicinity of the nozzles, and the occurrence of flight deflection in the inkjet step is more effectively suppressed. The solubility parameters (SP values) of the liquid A and the curable resin are close to each other particularly when the liquid A is diethylene glycol monobutyl ether acetate and the curable resin such as described hereinafter is included in the ink, and the ink has high dispersion stability and minimal variation in viscosity over long periods of time.

### Liquid B

The liquid B is capable of easily dissolving the dispersing agent described hereinafter. Including such a liquid B provides the color filter ink with excellent pigment dispersion properties. Accordingly, using the liquid B as a liquid medium makes it possible to dissolve more of the pigment, and an ink having a high pigment content ratio can be stably prepared. The dispersing agent in the waste ink can also be easily dissolved in the ink by discharging color filter ink to waste ink in which the viscosity has increased, or to a solid body in which the pigment and other components have aggregated and solidified. As a result, the viscosity of the waste ink can be reduced, and the pigment and other components in the solid body can be re-dispersed.

In the present invention, a solubility parameter is used as an indicator of solubility of the liquid B and the dispersing agent. The solubility parameter (SP value) will be described below.

The solubility parameter (SP value) δ ((cal/cm³)^{1/2}) is used as an indicator of the solubility and affinity of multiple substances, and is defined by Equation (A) shown below.

δ=(ΔE^{V}/V_{O})^{1/2}÷2.046 ((cal/cm³)^{1/2}) (A)

In the equation, ΔE^{V} (10⁶ N·m·mol⁻¹) is the heat of vaporization, and V_{O} (m³·mol⁻¹) is the volume per 1 mol. The difference in the solubility parameters between two substances is closely related to the amount of energy needed for the two substances to be compatible, and the smaller the difference in solubility parameters is, the smaller the amount of energy that is needed for the two substances to be compatible. Specifically, when two substances are present, the affinity and solubility are generally higher the smaller the differences is between the solubility parameters.

The solubility parameter can be found by experimentation, but can also be calculated. Several methods for finding a solubility parameter by calculation have been proposed, and the method of Small (P. A. Small: J. Appl. Chem, 3, 71 (1953)), for example, may be used in relation to materials having relatively high molecular weights. The method of Hildebrand (J. H. Hildebrand and R. L. Scott: The Solubility of Non-Electrolytes, ACS Monograph Series, 1950) may be used in relation to materials having relatively low molecular weights. More appropriate solubility parameters can be obtained through the use of these methods, and the solubility parameter can be found more easily.

Therefore, in the present invention, the method of Small is used to find the solubility parameter of the dispersing agent, and the method of Hildebrand is used to find the solubility parameters for the liquids constituting the liquid medium, and appropriate values can easily be obtained as the solubility parameters. For materials whose solubility parameter cannot be calculated by such methods, the solubility parameter can be found in accordance with a “solubility test” (“Solvent Pocket Handbook,” p. 22, Society of Synthetic Organic Chemistry). When the solubility parameter of a material is publicly known, the known value may be used as the solubility parameter.

Using such a solubility parameter, the dispersing agent and the liquid B satisfy the relationship |SP (X)−SP (Y)|≦0.8, wherein SP (X) ((cal/cm³)^{1/2}) is the solubility parameter for the dispersing agent, and SP (Y) ((cal/cm³)^{1/2}) is the solubility parameter for the liquid B. The dispersing agent and the liquid B satisfying such a relationship enables the dispersing agent to be suitably dissolved in the liquid B. Therefore, the liquid B included in the droplets can rapidly dissolve the dispersing agent in the waste ink by discharging color filter ink to waste ink in which the viscosity has increased, or to a solid body in which the pigment and other components have aggregated and solidified. As a result, the viscosity of the waste ink can be reduced, and the pigment and other components in the solid body can be rapidly re-dispersed. In contrast, when the dispersing agent and the liquid B cannot satisfy such a relationship, the dispersing agent cannot be suitably dissolved in the liquid B. The waste ink generated by cleaning therefore cannot be prevented from increasing in viscosity or solidifying to form a solid body. As a result, blockage of the inkjet head and other trouble easily occurs, and droplets cannot be stably discharged for long periods of time. It is sufficient insofar as the dispersing agent and the liquid B satisfy the relationship described above, but the relationship |SP (X)−SP (Y)|≦0.6 is preferably satisfied, and the relationship |SP (X)−SP (Y)|≦0.3 is more preferably satisfied. The effects described above can thereby be enhanced.

When a plurality of types of components is included as the dispersing agent, the SP value of the dispersing agent can be calculated by averaging the molar fractions of the components. In this case, it is sufficient insofar as the SP value of the dispersing agent as the average SP value according to the molar fractions of the plurality of types of components satisfies the abovementioned relationship, but a relationship such as described above is more preferably satisfied for the SP values of the components of the dispersing agent.

The expression |SP (X)−SP (Y)| is smaller than the absolute value of the difference between the SP value of the liquid A and the SP value of the dispersing agent.

The liquid B is not particularly limited insofar as a solubility parameter relationship such as described above is satisfied, but the liquid B is preferably a liquid selected from diethylene glycol diacetate, diethylene glycol mono-2-ethyl hexyl ether, ethylene glycol 2-ethyl hexyl ether, triethylene glycol monoethyl ether, triethylene glycol monobutyl ether, butyl cellosolve, diethylene glycol ethyl ether acetate, triethylene glycol dimethyl ether (MTM), triethylene glycol diacetate, diethylene glycol monoethyl ether acetate, diethyl glutarate, dimethyl glutarate, 1,3-butylene glycol diacetate, 1,6-diacetoxy hexane, tripropylene glycol methyl ether, diethylene glycol dimethyl ether, ethyl 3-ethoxy propionate, cyclohexyl acetate, diethyl succinate, dimethyl succinate, diethylene glycol monopropyl ether, diethylene glycol monobutyl ether, propylene glycol diacetate, propylene glycol n-butyl ether, dipropylene glycol monomethyl ether, dipropylene glycol n-butyl ether, dipropylene glycol n-propyl ether, diethylene glycol monoethyl ether, diethylene glycol monomethyl ether, ethylene glycol monohexyl ether, and N-methyl-2-pyrrolidone. When it is considered that the SP value of the common pigment dispersing agent used in a color filter ink is 9 to 10 ((cal/cm³)^{1/2}), the liquid B is preferably a liquid selected from ethyl 3-ethoxy propionate, dimethyl glutarate, 1,3-butylene glycol diacetate, diethylene glycol monoethyl ether, and butyl cellosolve.

Blockage of the droplet discharge head for discharging the color filter ink, increasing viscosity of the waste ink after cleaning, and other problems can thereby be effectively prevented, and the manufactured color filters can be provided with higher quality and particularly excellent uniformity of characteristics between units.

The content of the liquid B in the color filter ink is 5 to 20 wt %. When the content of the liquid B is within this range, the dispersing agent included in the waste ink can be rapidly dissolved by the liquid B included in the discharged color filter ink. Therefore, the viscosity of the waste ink can easily be reduced, and the pigment and other components in the solid body can be re-dispersed by discharging color filter ink to waste ink in which the viscosity has increased, or to a solid body or the like in which the pigment and other components have aggregated and solidified. The waste ink is therefore easily removed by suction or other means. In contrast, when the content of the liquid B is less than the aforementioned lower limit, the liquid B in the discharged color filter ink cannot adequately dissolve the dispersing agent included in the waste ink. The viscosity of the waste ink is therefore difficult to reduce even when color filter ink is discharged to the waste ink during cleaning. Therefore, blockage of the inkjet head and other trouble easily occurs due to the solidified solid body of waste ink, and droplets cannot be stably discharged for long periods of time. When the content of the liquid B exceeds the aforementioned upper limit, the content of the liquid A decreases in proportion to the increased content of the liquid B, and the liquid medium therefore easily evaporates when the color filter ink is discharged, and blockage, flight deflection, and other trouble easily occurs. Droplets therefore cannot be discharged stably for long periods of time. It is sufficient insofar as the content of the liquid B in the color filter ink is within the abovementioned range, but a content of 7 to 18 wt % is preferred. The effects described above can thereby be enhanced.

The relationship 3.0≦X_{LA}/X_{LB}≦13 is preferably satisfied, and the relationship 2.5≦X_{LA}/X_{LB}≦12 is more preferably satisfied, wherein X_{LA} (wt %) is the content of the liquid A, and X_{LB} (wt %) is the content ratio of the liquid B in the color filter ink. When the relationship of the content of the liquid A and the content of the liquid B is within the aforementioned range, the waste ink can be reliably prevented from increasing in viscosity and solidifying during cleaning, while evaporation of the liquid medium is adequately prevented. As a result, blockage of the droplet discharge head, flight deflection, and other problems can be suppressed for a long time, and droplets can be stably discharged. The manufactured color filters can therefore be provided with higher quality and excellent uniformity of characteristics between units.

The liquid B may be dissolved in any ratio with respect to the liquid A. The liquid medium included in the droplets can thereby rapidly dilute the waste ink during cleaning when droplets of the color filter ink are discharged to the waste ink that has increased in viscosity, and the viscosity of the waste ink can be easily and reliably reduced. Solid bodies formed by aggregation of pigment and other components can also be easily dispersed. As a result, droplets can be discharged with particular stability by the droplet discharge head over long periods of time.

The liquid medium may also include another liquid in addition to the liquid A and the liquid B.

### Dispersing Agent

The color filter ink includes a dispersing agent. The color filter ink can thereby be provided with excellent pigment dispersion stability. The color filter ink can therefore be provided with a suitable viscosity, and it is possible to prevent the waste ink generated during cleaning from increasing in viscosity and solidifying. As described above, the dispersing agent can also be easily dissolved in the liquid B. Therefore, even when the waste ink has increased in viscosity or solidified, since the color filter ink that includes the liquid B adheres to the waste ink in cleaning, the dispersing agent included in the waste ink is easily dissolved in the color filter ink, and as a result, the waste ink that is solidified or increased in viscosity can be provided with fluidity and low viscosity. The dispersion properties of the pigment in the color filter ink are also improved, and the color filter ink can therefore be provided with excellent storage stability.

Through the use of the dispersing agent, the dispersing agent adheres to (adsorbs on) the surfaces of the pigment particles (pigment particles having a relatively large grain size that are not fine dispersed) added to the dispersing-agent-dispersed liquid in the fine dispersion step of the manufacturing method such as described hereinafter, and excellent dispersion properties of the pigment particles (pigment particles having a relatively large grain size that are not fine dispersed) in the dispersing-agent-dispersed liquid can be obtained. The fine dispersion process in the fine dispersion step can thereby be efficiently performed, the production properties of the color filter ink can be made particularly excellent, particularly excellent long-term dispersion stability of the pigment particles (fine dispersed pigment fine-particles) can be obtained in the color filter ultimately obtained, and the color filter manufactured using the color filter ink can be provided with particularly excellent brightness and contrast.

The content of the dispersing agent in the color filter ink is preferably 0.5 to 10 wt %. When the content of the dispersing agent is within this range, the pigment can be highly dispersed in the color filter ink, and it is possible to reliably prevent increased viscosity and solidification of the waste ink generated by cleaning. As a result, adhesion of droplets and the like to the nozzles of the droplet discharge head during cleaning can be prevented particularly effectively, and droplets can be stably discharged for long periods of time.

The relationship 0.32<X_{D}/X_{LB}≦3.0 is preferably satisfied, and the relationship 0.6≦X_{D}/X_{LB}≦2.5 is more preferably satisfied, wherein X_{D} (wt %) is the content ratio of the dispersing agent in the color filter ink, and X_{LB} (wt %) is the content ratio of the liquid B. When the relationship between the content of the liquid B and the content of the dispersing agent is within the aforementioned range, particularly excellent dispersion properties of the pigment in the color filter ink can thereby be obtained, and the color filter ink can be provided with particularly excellent storage stability. During cleaning, the discharged droplets can also rapidly dissolve the dispersing agent included in the waste ink. Even when a small quantity of droplets are discharged, the dispersing agent included in the waste ink can be suitably dissolved. The waste ink can thereby be reliably prevented from increasing in viscosity and solidifying, and droplets can be stably discharged over a long period of time.

The relationship 0.05≦X_{D}/X_{PG}≦1.50 is preferably satisfied, and the relationship 0.10≦X_{D}/X_{PG}≦1.20 is more preferably satisfied, wherein X_{D} (wt %) is the content ratio of the dispersing agent in the color filter ink, and X_{PG} (wt %) is the content ratio of the halogenated phthalocyanine zinc complex. Particularly excellent dispersion properties of the pigment in the color filter ink can thereby be obtained, and the color filter ink can be provided with particularly excellent storage stability. The waste ink can also be reliably prevented from increasing in viscosity and solidifying, and droplets can be stably discharged over a long period of time.

The dispersing agent is not particularly limited insofar as the dispersing agent satisfies an SP value relationship such as described above with the liquid B, but a polymer-based dispersing agent, for example, may be used. Examples of polymer-based dispersing agents include basic polymer-based dispersing agents, neutral polymer-based dispersing agents, acidic polymer-based dispersing agents, and the like. Examples of such polymer-based dispersing agents include dispersing agents composed of acrylic-based and modified acrylic-based copolymers; urethane-based dispersing agents; and dispersing agents composed of polyaminoamide salts, polyether esters, phosphoric acid ester-based compounds, aliphatic polycarboxylic acids, and the like.

More specific examples of dispersing agents include Disperbyk 101, Disperbyk 102, Disperbyk 103, Disperbyk P104, Disperbyk P104S, Disperbyk 220S, Disperbyk 106, Disperbyk 108, Disperbyk 109, Disperbyk 110, Disperbyk 111, Disperbyk 112, Disperbyk 116, Disperbyk 140, Disperbyk 142, Disperbyk 160, Disperbyk 161, Disperbyk 162, Disperbyk 163, Disperbyk 164, Disperbyk 166, Disperbyk 167, Disperbyk 168, Disperbyk 170, Disperbyk 171, Disperbyk 174, Disperbyk 180, Disperbyk 182, Disperbyk 183, Disperbyk 184, Disperbyk 185, Disperbyk 2000, Disperbyk 2001, Disperbyk 2050, Disperbyk 2070, Disperbyk 2095, Disperbyk 2150, Disperbyk LPN6919, Disperbyk 9075, and Disperbyk 9077 (all manufactured by Byk Chemie Japan); EFKA 4008, EFKA 4009, EFKA 4010, EFKA 4015, EFKA 4020, EFKA 4046, EFKA 4047, EFKA 4050, EFKA 4055, EFKA 4060, EFKA 4080, EFKA 4400, EFKA 4401, EFKA 4402, EFKA 4403, EFKA4406, EFKA 4408, EFKA 4300, EFKA 4330, EFKA 4340, EFKA 4015, EFKA 4800, EFKA 5010, EFKA 5065, EFKA 5066, EFKA 5070, EFKA 7500, and EFKA 7554 (all manufactured by Ciba Specialty Chemicals); Solsperse 3000, Solsperse 9000, Solsperse 13000, Solsperse 16000, Solsperse 17000, Solsperse 18000, Solsperse 20000, Solsperse 21000, Solsperse 24000, Solsperse 26000, Solsperse 27000, Solsperse 28000, Solsperse 32000, Solsperse 32500, Solsperse 32550, Solsperse 33500 Solsperse 35100, Solsperse 35200, Solsperse 36000, Solsperse 36600, Solsperse38500, Solsperse 41000, Solsperse 41090, and Solsperse 20000 (all manufactured by Nippon Lubrizol); Ajisper PA111, Ajisper PB711, Ajisper PB821, Ajisper PB822, and Ajisper PB824 (all manufactured by Ajinomoto Fine-Techno); Disparlon 1850, Disparlon 1860, Disparlon 2150, Disparlon 7004, Disparlon DA-100, Disparlon DA-234, Disparlon DA-325, Disparlon DA-375, Disparlon DA-705, Disparlon DA-725, and Disparlon PW-36 (all manufactured by Kusumoto Chemicals); Floren DOPA-14, Floren DOPA-15B, Floren DOPA-17, Floren DOPA-22, Floren DOPA- 44, Floren TG-710, and Floren D-90 (all manufactured by Kyoei Kagaku); Anti-Terra-205 (manufactured by Byk Chemie Japan); and the like, and one or more types of compounds selected from the above examples may be combined and used.

A compound having the partial structure indicated by Formula (6) and Formula (7) below, for example, may be used as the dispersing agent. Using such a compound as the dispersing agent makes it possible to obtain particularly excellent dispersion properties of the pigment in the color filter ink, and to provide the color filter ink with particularly excellent discharge stability.

Formula (6)

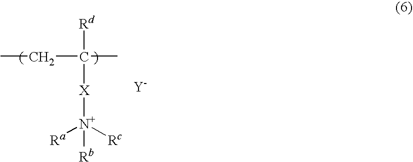

In Formula (6), R^{a}, R^{b}, and R^{c} are each independently a hydrogen atom, or a cyclic or chain hydrocarbon group which may be substituted; or two or more of R^{a}, R^{b}, and R^{c} bond with each other and form a cyclic structure; R^{d} is a hydrogen atom or a methyl group; X is a bivalent linking group; and Y⁻ is a counter anion.

Formula (7)

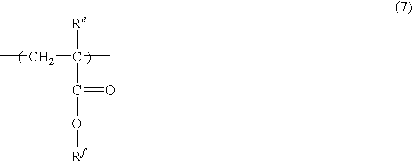

In Formula (7), R^{e} is a hydrogen atom or a methyl group; R^{f} is a cyclic or chain alkyl group which may have a substituted group, an aryl group which may have a substituted group, or an aralkyl group which may have a substituted group.

A dispersing agent having a predetermined acid value (also referred to hereinafter as an acid-value dispersing agent) and a dispersing agent having a predetermined amine value (also referred to hereinafter as an amine-value dispersing agent) may be simultaneously included as dispersing agents in the color filter ink. The effects of an acid-value dispersing agent for demonstrating viscosity-reducing effects whereby the viscosity of the color filter ink is reduced, and the effects of an amine-value dispersing agent whereby the viscosity of the color filter ink is stabilized can thereby be obtained at the same time, particularly excellent dispersion stability of the pigment in the color filter ink can be obtained, and particularly excellent droplet discharge stability of the color filter ink can be obtained over long periods of time. In particular, a method such as the one described hereinafter has a preparatory dispersion step for obtaining a dispersing-agent-dispersed liquid in which the dispersing agent is dispersed in a dispersion medium by stirring a mixture of the dispersing agent, a thermoplastic resin, and the dispersion medium prior to performing the pigment fine dispersion process, but in such a method, the joint use of an acid-value dispersing agent and an amine-value dispersing agent makes it possible to reliably prevent association of the dispersing agents (association of the acid-value dispersing agent and the amine-value dispersing agent), and to obtain particularly excellent dispersion stability of the pigment such as described above.

Specific examples of acid-value dispersing agents include Disperbyk P104, Disperbyk P104S, Disperbyk 220S, Disperbyk 110, Disperbyk 111, Disperbyk 170, Disperbyk 171, Disperbyk 174, and Disperbyk 2095 (all manufactured by Byk Chemie Japan); EFKA 5010, EFKA 5065, EFKA 5066, EFKA 5070, EFKA 7500, and EFKA 7554 (all manufactured by Ciba Specialty Chemicals); Solsperse 3000, Solsperse 16000, Solsperse 17000, Solsperse 18000, Solsperse 36000, Solsperse 36600, and Solsperse 41000 (all manufactured by Nippon Lubrizol); and the like.

Specific examples of amine-value dispersing agents include Disperbyk 102, Disperbyk 160, Disperbyk 161, Disperbyk 162, Disperbyk 163, Disperbyk 164, Disperbyk 166, Disperbyk 167, Disperbyk 168, Disperbyk 2150, Disperbyk LPN6919, Disperbyk 9075, and Disperbyk 9077 (all manufactured by Byk Chemie Japan); EFKA 4015, EFKA 4020, EFKA 4046, EFKA 4047, EFKA 4050, EFKA 4055, EFKA 4060, EFKA 4080, EFKA 4300, EFKA 4330, EFKA 4340, EFKA 4400, EFKA 4401, EFKA 4402, EFKA 4403, and EFKA 4800 (all manufactured by Ciba Specialty Chemicals); Ajisper PB711 (manufactured by Ajinomoto Fine Techno); Anti-Terra-205 (manufactured by Byk Chemie Japan); and the like.

When an acid-value dispersing agent and an amine-value dispersing agent are used jointly, the acid value (acid value on a solid basis) of the acid-value dispersing agent is not particularly limited, but is preferably 5 to 370 KOH mg/g, more preferably 20 to 270 KOH mg/g, and more preferably 30 to 135 KOH mg/g. When the acid value of the acid-value dispersing agent is within the aforementioned range, the dispersion stability of the pigment can be particularly excellent in the case of joint use with an amine-value dispersing agent. The acid value of the dispersing agent can be calculated by a method based on DIN EN ISO 2114, for example.

The acid-value dispersing agent is preferably one having a predetermined amine value, i.e., an amine value of zero.

When an amine-value dispersing agent and an acid-value dispersing agent are used jointly, the amine value (amine value on a solid basis) of the amine-value dispersing agent is not particularly limited, but is preferably 5 to 200 KOH mg/g, more preferably 25 to 170 KOH mg/g, and more preferably 30 to 130 KOH mg/g. When the amine value of the amine-value dispersing agent is within the aforementioned range, the dispersion stability of the pigment can be particularly excellent in the case of joint use with an amine-value dispersing agent. The amine value of the dispersing agent can be calculated by a method based on DIN 16945, for example.

The amine-value dispersing agent is preferably one having a predetermined acid value, i.e., an acid value of zero.

When an acid-value dispersing agent and an amine-value dispersing agent are jointly used, the relation 0.1≦CA/CB≦1 is preferably satisfied, and the relation 0.15≦CA/CB≦0.5 is more preferably satisfied, wherein CA (wt %) is the content ratio of the acid-value dispersing agent in the color filter ink, and CB (wt %) is the content ratio of the amine-value dispersing agent in the color filter ink. Satisfying such a relation makes it possible to more significantly demonstrate the synergistic effects of jointly using the acid-value dispersing agent and the amine-value dispersing agent, and to obtain particularly excellent dispersion stability of the pigment, discharge stability of droplets, and other effects.

The relation 0.01≦(AV×CA)/(BV×CB)≦1.9 is preferably satisfied, and the relation 0.10≦(AV×CA)/(BV×CB)≦1.5 is more preferably satisfied, wherein AV (KOH mg/g) is the acid value of the acid-value dispersing agent, BV (KOH mg/g) is the amine value of the amine-value dispersing agent, CA (wt %) is the content ratio of the acid-value dispersing agent, and CB (wt %) is the content ratio of the amine-value dispersing agent. Satisfying such a relation makes it possible to more significantly demonstrate the synergistic effects of jointly using the acid-value dispersing agent and the amine-value dispersing agent, and to obtain particularly excellent dispersion stability of the pigment, discharge stability of droplets, and other effects.

### Resin Material

The color filter ink generally includes a binder re sin (resin material) for such purposes as enhancing adhesion of the formed colored portion to the substrate. Solvent resistance is needed in the binder resin in order to prevent adverse effects due to chemical application or washing in steps subsequent to the ink application step in an inkjet method. In the present invention, a curable resin is preferably used as the binder resin.

### Curable Resin Material

A curable resin material generally has excellent adhesion to the substrate after curing. Consequently, the color filter can be provided with excellent durability by using a curable resin material as the binder resin.

The curable resin material is not particularly limited, and various types of heat-curable resins, photo-curing resins, and other energy-ray curable resins and the like can be used, but a curable resin material such as described hereinafter is preferably included. In general, when a large quantity of a curable resin material is included in the ink, the viscosity increases, and excellent droplet discharge stability is difficult to obtain. However, when a curable resin material such as described hereinafter is used as the curable resin material, the viscosity is prevented from increasing even when a relatively large quantity of the curable resin material is included, and particularly excellent droplet discharge stability is obtained. Since a curable resin material such as described hereinafter does not readily cure in the discharged waste ink, the viscosity of the waste ink is suitably prevented from increasing. A curable resin material such as described hereinafter can be suitably cured when the dispersion medium of the color filter ink such as described hereinafter is removed. When such a curable resin material is used in the ink, the obtained color filter is provided with particularly excellent durability.

The curable resin material (curable resin composition) that can be suitably used in the color filter ink will be described in detail hereinafter.

### Polymer A

The polymer A (first polymer) contains at least the epoxy-containing vinyl monomer a1 (first epoxy-containing vinyl monomer) as a monomer component. The polymer A may be composed of essentially a single compound, or may be a mixture of a plurality of types of compounds. However, when the polymer A is a mixture of a plurality of types of compounds, each of the compounds contains at least the epoxy-containing vinyl monomer a1 as a monomer component.

### Epoxy-Containing Vinyl Monomer a1

The polymer A contains at least the epoxy-containing vinyl monomer a1 as a monomer component. Including such an epoxy-containing vinyl monomer a1 as a monomer component makes it possible to easily and reliably introduce an epoxy group into the polymer A. By including the epoxy-containing vinyl monomer a1 as a monomer component, the color filter ink can be provided with particularly excellent dispersion stability of the pigment such as described above, and particularly excellent long-term storage properties and discharge stability. Including the epoxy-containing vinyl monomer a1 as a monomer component also makes the polymer A less readily cured in the discharged waste ink and suitably prevents the viscosity of the waste ink from increasing. The colored portion formed using the color filter ink can also be provided with particularly excellent solvent resistance. Including the epoxy-containing vinyl monomer a1 as a monomer component is also useful because the curable resin material can be cured under relatively mild conditions when a colored portion is formed using the color filter ink, and the formed colored portion is provided with excellent hardness and other characteristics. When the polymer A includes a vinyl monomer a2 (second vinyl monomer), a vinyl monomer a3 (third vinyl monomer), and other components such as described hereinafter, the polymer can be suitably synthesized, and a polymer A having the desired characteristics can be easily and reliably obtained.

The epoxy-containing vinyl monomer a1 used may have the structure indicated by Formula (8) below, for example. When the epoxy-containing vinyl monomer a1 has such a structure, it is possible to obtain particularly excellent dispersion stability of the pigment such as described above in the color filter ink, and the color filter ink can be provided with particularly excellent long-term storage properties and excellent discharge stability. When the epoxy-containing vinyl monomer a1 has the structure indicated by Formula (8) below, the colored portion formed using the color filter ink set can be provided with even more superior solvent resistance. When the epoxy-containing vinyl monomer a1 has the structure indicated by Formula (8) below, the polymer A is less readily cured in the discharged waste ink, and the viscosity of the waste ink is suitably prevented from increasing. The curable resin material can also be cured under relatively mild conditions when a colored portion is formed using the color filter ink, and the formed colored portion is provided with excellent hardness and other characteristics. When the epoxy-containing vinyl monomer a1 has such a structure, the polymer A can be provided with particularly excellent compatibility with the polymer B (second polymer) described hereinafter, and the colored portion formed using the color filter ink can also be provided with particularly high transparency.

Formula (8)

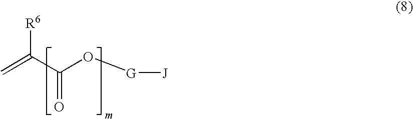

In Formula (8), R⁶ is a hydrogen atom or a C₁₋₇ alkyl group; G is a single bond hydrocarbon group or a bivalent hydrocarbon group which may contain a hetero atom; J is an epoxy group or an alicyclic epoxy group which may have a ring-structured C₃₋₁₀ substituted group; and m is 0 or 1.

In Formula (8), examples of the C₁₋₇ alkyl group indicated by R⁶ include methyl, ethyl, propyl, isopropyl, butyl, isobutyl, s-butyl, t-butyl, pentyl, hexyl, heptyl, and other alkyl groups, but a hydrogen atom or a C₁₋₂ alkyl group is preferred, and a hydrogen atom or a methyl group is more preferred. The dispersion stability of the pigment such as described above in the color filter ink can be made particularly excellent, and the color filter ink can be provided with excellent long-term storage properties and excellent discharge stability. The contrast of the displayed image can also be made particularly excellent in the manufactured color filter. The colored portion formed using the color filter ink can also be provided with excellent hardness and other characteristics. The polymer A can also be provided with particularly excellent compatibility with the polymer B described hereinafter, and the colored portion formed using the color filter ink can be provided with extremely high transparency.

Typical examples of a bivalent hydrocarbon group that may include a hetero atom indicated by G in Formula (8) include straight-chain or branched alkylene groups, or more specifically, methylenes, ethylenes, propylenes, tetramethylenes, ethyl ethylenes, pentamethylenes, hexamethylenes, oxymethylenes, oxyethylenes, oxypropylenes, and the like.

Specific examples of the epoxy-containing vinyl monomer a1 include glycidyl(meth)acrylate, methylglycidyl(meth)acrylate, ethylglycidyl(meth)acrylate, glycidyl vinylbenzyl ether (product name: VBGE; manufactured by Seimi Chemical), the alicyclic epoxy-containing unsaturated compounds indicated by Formulas (8-1) through (8-31) below, and the like; and one or more types of these compounds may be selected and used, but (3,4-epoxycyclohexyl)methyl (meth)acrylate is particularly preferred as the epoxy-containing vinyl monomer a1. The dispersion stability of the pigment such as described above in the color filter ink can thereby be made particularly excellent, and the color filter ink can be provided with excellent long-term storage properties and excellent discharge stability. The colored portion formed using the color filter ink can also be provided with particularly excellent hardness, solvent resistance, and other characteristics. The polymer A can be provided with particularly excellent compatibility with the polymer B described hereinafter, and the colored portion formed using the color filter ink can be provided with extremely high transparency.

Formulas (8-1) through (8-31)

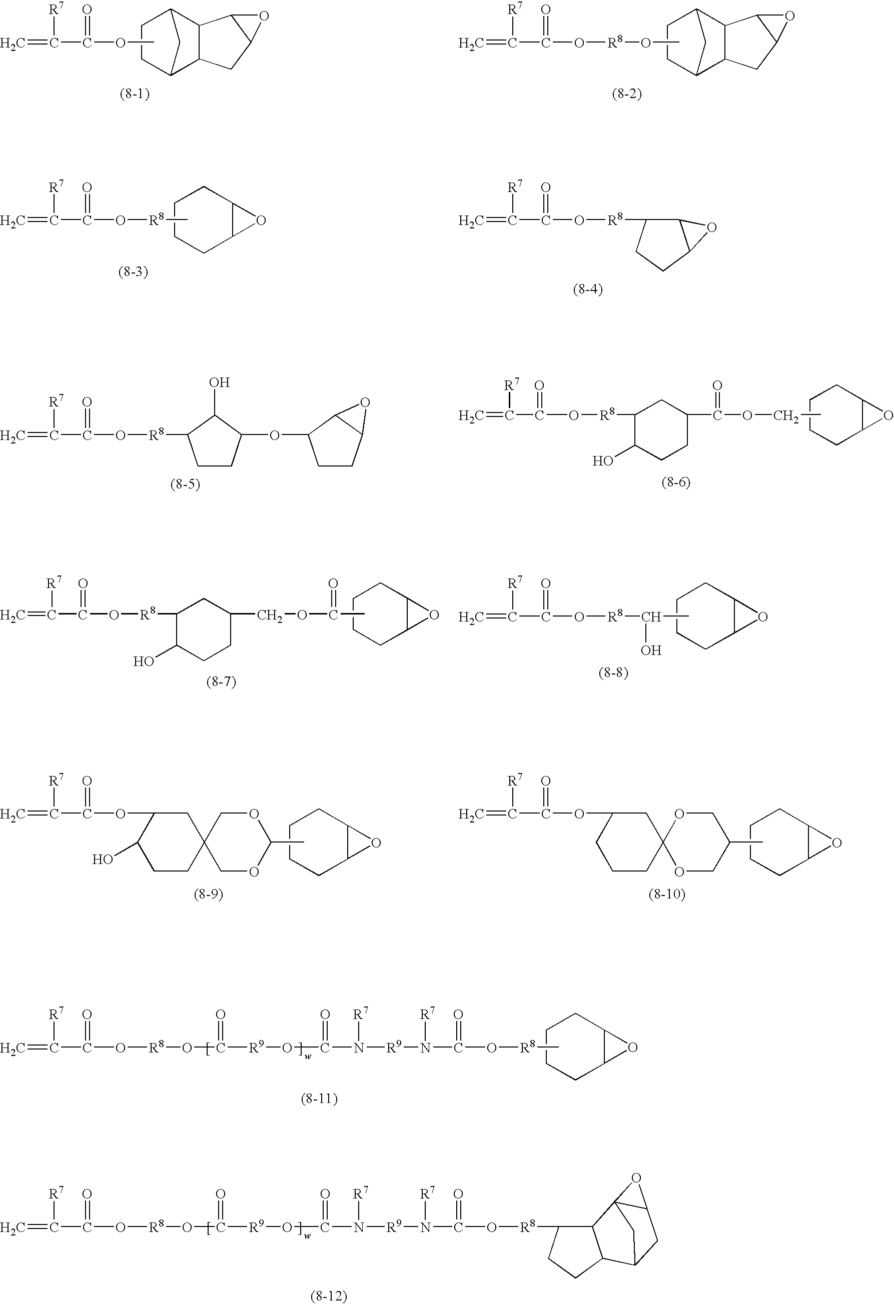

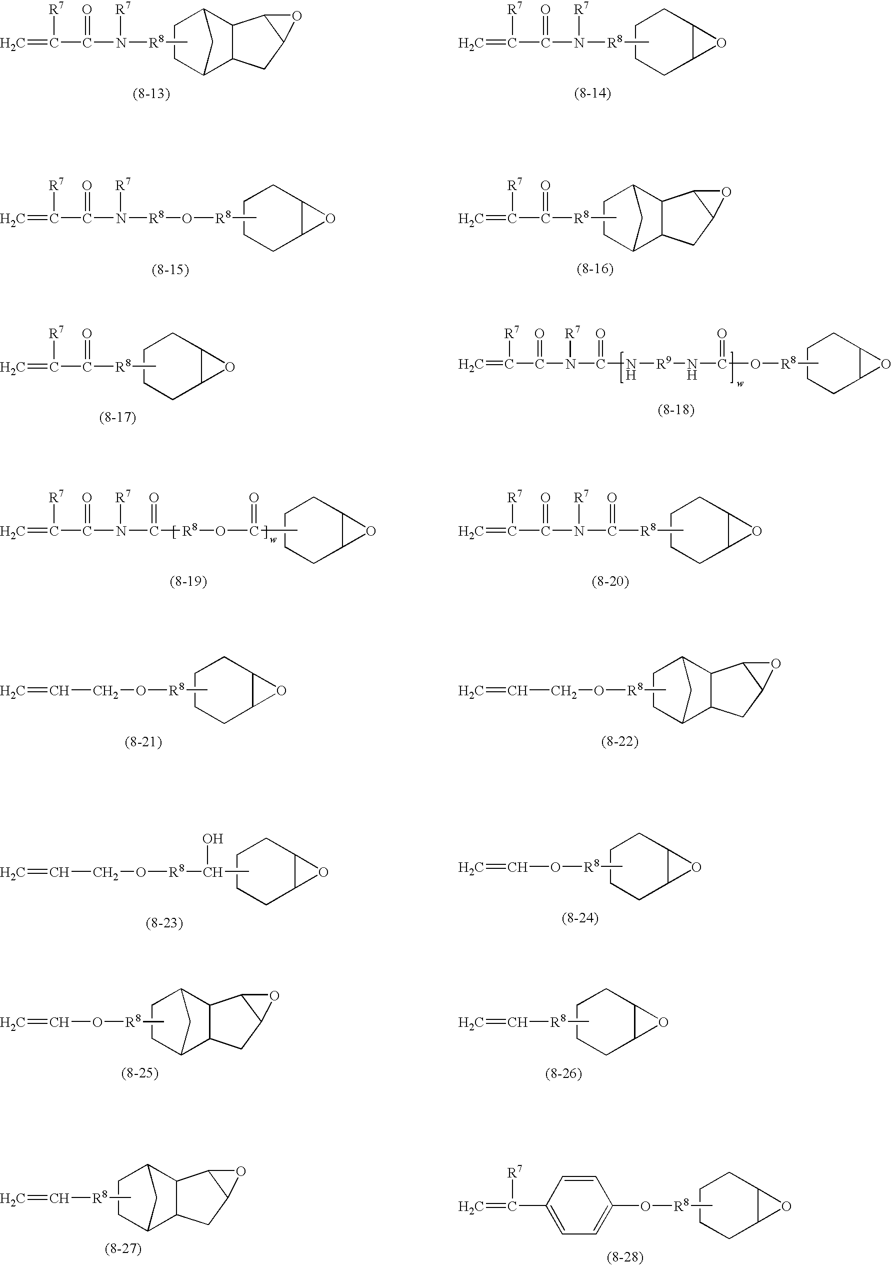

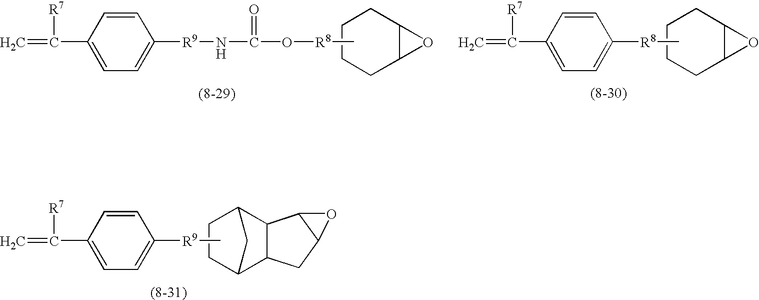

In Formulas (8-1) through (8-31), R⁷ is a hydrogen atom or a methyl group; R⁸ is a C₁₋₈ bivalent hydrocarbon group; and R⁹ is a C₁₋₂₀ bivalent hydrocarbon group. R⁷, R⁵, and R⁹ may be mutually the same or different, and w is 0 to 10.

The content ratio (which is a value obtained by substitution with the weight of the monomer used to synthesize the polymer) of the epoxy-containing vinyl monomer a1 in the polymer A is preferably 50 to 99 wt %, and more preferably 70 to 94 wt %. When the content ratio of the epoxy-containing vinyl monomer a1 in the polymer A is within the aforementioned range, the dispersion stability of the pigment such as described above in the color filter ink can be made particularly excellent, and the color filter ink can be provided with excellent long-term storage properties and excellent discharge stability. When the content ratio of the epoxy-containing vinyl monomer a1 in the polymer A is within the aforementioned range, the curable resin material can be cured under relatively mild conditions when a colored portion is formed using the color filter ink, and the formed colored portion is provided with particularly excellent hardness, solvent resistance, and other characteristics. When the polymer A is a mixture of a plurality of types of compounds, the weighted average value (weighted average value based on weight ratio) of the mixed compounds may be used as the content ratio of the epoxy-containing vinyl monomer a1. When the polymer A is a mixture of a plurality of types of compounds, the compounds all preferably contain the epoxy-containing vinyl monomer a1 in such a content ratio as described above.

### Vinyl Monomer a2

The polymer A may contain at least the epoxy-containing vinyl monomer a1 as a monomer component, but the polymer A is preferably one (a copolymer) containing the epoxy-containing vinyl monomer a1, as well as a vinyl monomer a2 as a monomer group provided with an isocyanate group or a blocked isocyanate group in which the isocyanate group is protected by a protective group. The content ratio of gas (dissolved gas, bubbles present as microbubbles, or the like) in the color filter ink can thereby be reduced more effectively, and particularly excellent stability of droplet discharge by the inkjet method can be obtained. As a result, it is possible to more effectively prevent the occurrence of uneven color, uneven saturation, and the like between different regions of the manufactured color filter, and fluctuation of characteristics between individual units. The polymer A is also particularly less prone to curing in the discharged waste ink, and the viscosity of the waste ink is suitably prevented from increasing.

Examples of polymerizable vinyl monomers a2 include 2-acryloyloxyethyl isocyanate (product name: Karenz MOI; manufactured by Showa Denko), 2-methacryloyloxyethyl isocyanate, and other (meth)acryloyl isocyanates and the like in which (meth)acryloyl is bonded with an isocyanate group via a C₂₋₆ alkylene group.

The isocyanate group of the abovementioned (meth)acryloyl isocyanate is preferably a blocked isocyanate group. The term “blocked isocyanate group” refers to an isocyanate group in which the terminal ends are masked by a blocking agent. Examples of monomers having a blocked isocyanate group include ethyl 2-(0-[1′-methylpropylideneamino]carboxyamino)methacrylate and the like, and are commercially available under the trade name Karenz MOI-BM, manufactured by Showa Denko. A combination of one or more types of these polymerizable vinyl monomers may be used.

The content ratio (which is a value obtained by substitution with the weight of the monomer used to synthesize the polymer) of the vinyl monomer a2 in the polymer A is preferably 2 to 20 parts by weight, and more preferably 3 to 15 parts by weight, with respect to 100 parts by weight of the epoxy-containing vinyl monomer a1. When the content ratio of the vinyl monomer a2 in the polymer A is within the aforementioned range, the content ratio of gas (dissolved gas, bubbles present as microbubbles, or the like) in the color filter ink can be reduced more effectively, and particularly excellent stability of droplet discharge by the inkjet method can be obtained while the color filter ink is provided with adequately excellent long-term storage properties and other characteristics. The colored portion formed using the color filter ink can also be provided with adequately high transparency. The polymer A is also particularly less prone to curing in the discharged waste ink, and the viscosity of the waste ink is suitably prevented from increasing. When the polymer A is a mixture of a plurality of types of compounds, the weighted average value (weighted average value based on weight ratio) of the mixed compounds may be used as the content ratio of the vinyl monomer a2. When the polymer A is a mixture of a plurality of types of compounds, the compounds all preferably contain the vinyl monomer a2 in such a content ratio as described above.

### Vinyl Monomer a3

The polymer A may contain at least the epoxy-containing vinyl monomer a1 as a monomer component, but the polymer A is preferably one (a copolymer) containing the epoxy-containing vinyl monomer a1, as well as a vinyl monomer a3 provided with a hydroxyl group. The colored portion formed using the color filter ink can thereby be provided with particularly excellent adhesion to the substrate, particularly adhesion under repeated exposure to sudden temperature changes that accompany image display. As a result, the occurrence of light leakage (white spots, bright points) and other problems can be reliably prevented even when the color filter is used for a long time, for example. Specifically, the color filter can be provided with particularly excellent durability. When the polymer A contains the vinyl monomer a3 as a monomer component, the polymer A can be provided with particularly excellent compatibility with the polymer B described hereinafter, and the colored portion formed using the color filter ink can be provided with extremely high transparency. When the polymer A contains the vinyl monomer a3 as a monomer component, a suitable contact angle of the ink with respect to the discharge openings (nozzles) can be obtained, and particularly excellent drying of the ink can be obtained. Specifically, the ink can be provided with particularly excellent droplet discharge stability.

Examples of the vinyl monomer a3 include monoester compounds of a acrylic acid or methacrylic acid with 2-hydroxyethyl(meth)acrylate, hydroxypropyl(meth)acrylate, 2,3-dihydroxybutyl(meth)acrylate, 4-hydroxybutyl(meth)acrylate, 6-hydroxyhexyl(meth)acrylate, 8-hydroxyoctyl(meth)acrylate, 4-hydroxymethyl cyclohexyl(meth)acrylate, polyalkylene glycol mono(meth)acrylate, and other polyalcohols; compounds in which ε-caprolactone is ring-open polymerized with the abovementioned monoester compounds of a polyalcohol and acrylic acid or methacrylic acid (PLACCEL FA series, PLACCEL FM series, and the like manufactured by Daicel Chemical Industries); compounds in which ethylene oxide and propylene oxide is ring-open polymerized; and the like, and one or more types of compounds selected from the above examples may be used.

The content ratio (which is a value obtained by substitution with the weight of the monomer used to synthesize the polymer) of the vinyl monomer a3 in the polymer A is preferably 2 to 20 parts by weight, and more preferably 3 to 15 parts by weight, with respect to 100 parts by weight of the epoxy-containing vinyl monomer a1. When the content ratio of the vinyl monomer a3 in the polymer A is within the aforementioned range, the color filter manufactured using the color filter ink can be provided with particularly excellent durability while the color filter ink is provided with adequately excellent long-term storage properties and other characteristics. The colored portion formed using the color filter ink can also be provided with high transparency. Particularly excellent droplet discharge stability of the ink can also be obtained In contrast, when the content ratio of the vinyl monomer a3 in the polymer A is less than the lower limit of the aforementioned range, the effects of including a vinyl monomer a3 such as those described above may not be adequately demonstrated. When the content ratio of the vinyl monomer a3 in the polymer A exceeds the upper limit of the aforementioned range, it may be difficult to make the content ratio of gas in the color filter ink adequately low. When the polymer A is a mixture of a plurality of types of compounds, the weighted average value (weighted average value based on weight ratio) of the mixed compounds may be used as the content ratio of the vinyl monomer a3. When the polymer A is a mixture of a plurality of types of compounds, the compounds all preferably contain the vinyl monomer a3 in such a content ratio as described above.

### Other Polymerizable Vinyl Monomer a4

The polymer A may contain as a monomer component a polymerizable vinyl monomer a4 other than the epoxy-containing vinyl monomer a1, the vinyl monomer a2, and the vinyl monomer a3 described above. A vinyl monomer that can be copolymerized with the epoxy-containing vinyl monomer a1 may be used as the polymerizable vinyl monomer a4, and specific examples thereof include methyl(meth)acrylate, ethyl(meth)acrylate, butyl(meth)acrylate, 2-ethylhexyl(meth)acrylate, phenyl(meth)acrylate, cyclohexyl(meth)acrylate, dicyclopentanyl(meth)acrylate, dicyclopentanyloxyethyl(meth)acrylate, isobornyl(meth)acrylate, benzyl(meth)acrylate, phenyl ethyl(meth)acrylate, and other C₁₋₁₂ alkyl and aralkyl(meth)acrylates; styrene, α-methylstyrene, and other vinyl aromatic compounds; CF₃(CF₂)₃CH₂CH═CH₂, CF₃(CF₂)₃CH═CH₂, CF₃(CF₂)₅CH₂CH═CH₂, CF₃(CF₂)₅CH═CH₂, CF₃(CF₂)₇CH═CH₂, CF₃(CF₂)₉CH₂CH═CH₂, CF₃(CF₂)₉CH═CH₂, (CF₃)₂CF(CF₂)₂CH₂CH═CH₂, (CF₃)₂CF(CF₂)₂CH═CH₂, (CF₃)₂CF(CF₂)₄CH₂CH═CH₂, (CF₃)₂CF(CF₂)₄CH═CH₂, (CF₃)₂CF(CH₂)₆CH₂CH═CH₂, (CF₃)₂CF(CF₂)₆CH═CH₂, F₅C₆CH═CH₂, CF₃(CF₂)₅CH₂CH₂OCH₂CH═CH₂, CF₃(CF₂)₅CH₂CH₂CH₂OCH₂CH═CH₂, CF₃(CF₂)₇CH₂CH₂OCH₂CH═CH₂, CF₃(CF₂)₇CH₂CH₂CH₂OCH₂CH═CH₂, CF₃(CF₂)₉CH₂CH₂OCH₂CH═CH₂, CF₃(CF₂)₉CH₂CH₂CH₂OCH₂CH═CH₂, H(CF₂)₆CH₂OCH₂CH═CH₂, H(CF₂)₈CH₂OCH₂CH═CH₂, (CF₃)₂CF(CF₂)₂CH₂CH₂OCOCH═CH₂, (CF₃)₂CF(CF₂)₂CH₂CH₂OCOC(CH₃)═CH₂, (CF₃)₂CF(CF₂)₄CH₂CH₂OCOCH═CH₂, (CF₃)₂CF(CF₂)₄CH₂CH₂OCOC(CH₃)═CH₂, (CF₃)₂CF(CF₂)₆CH₂CH₂OCOCH═CH₂, (CF₃)₂CF(CF₂)₆CH₂CH₂OCOC(CH₃)═CH₂, CF₃(CF₂)₅CH₂CH₂OCOCH═CH₂, CF₃(CF₂)₅CH₂CH₂OCOC(CH₃)═CH₂, CF₃(CF₂)₇CH₂CH₂OCOCH═CH₂, CF₃(CF₂)₇CH₂CH₂OCOC(CH₃)═CH₂, CF₃(CF₂)₉CH₂CH₂OCOCH═CH₂, CF₃(CF₂)₉CH₂CH₂OCOC(CH₃)═CH₂, H(CF₂)₆CH₂CH₂OCOCH═CH₂, H(CF₂)₈CH₂CH₂OCOC(CH₃)═CH₂, F(CF₂)₈CH₂CH₂OCOCH═CH₂, F(CF₂)₈CH₂CH₂OCOC(CH₃)═CH₂, H(CF₂)₄CH₂OCOC(CH₃)═CH₂, H(CF₂)₄CH₂OCOCH═CH₂, and other fluoroalkyl- or fluoroaryl-containing vinyl compounds and the like, and one or more types of compounds selected from the above examples may be combined and used. However, the polymer A does not contain as a monomer component an alkoxysilyl-containing vinyl monomer b1 such as described hereinafter.

The content ratio (which is a value obtained by substitution with the weight of the monomer used to synthesize the polymer) of the polymerizable vinyl monomer a4 in the polymer A is preferably 20 parts by weight or less, and more preferably 10 parts by weight or less with respect to 100 parts by weight of the epoxy-containing vinyl monomer a1. When the polymer A is a mixture of a plurality of types of compounds, the weighted average value (weighted average value based on weight ratio) of the mixed compounds may be used as the content ratio of the polymerizable vinyl monomer a4. When the polymer A is a mixture of a plurality of types of compounds, the content ratio of the polymerizable vinyl monomer a4 with respect to the mixture of compounds preferably satisfies such conditions as those described above.

As described above, the polymer A may contain at least the epoxy-containing vinyl monomer a1 as a monomer component, but preferably contains the epoxy-containing vinyl monomer a1 as well as the vinyl monomer a2 and the vinyl monomer a3. The effects of including a vinyl monomer a2 such as the ones described above, and the effects of including a vinyl monomer a3 such as the ones described above can be obtained at the same time.

The ratio (content ratio) accounted for by the polymer A in the curable resin material is not particularly limited, but is preferably 25 to 80 wt %, and more preferably 33 to 70 wt %. When the polymer A is a mixture of a plurality of types of compounds, the sum of the content ratios of the mixed compounds may be used as the content ratio of the polymer A.

### Polymer B

In the color filter ink, the curable resin material preferably includes a polymer B that contains at least the alkoxysilyl-containing vinyl monomer b1 indicated by Formula (2) below as a monomer component.

Formula (2)

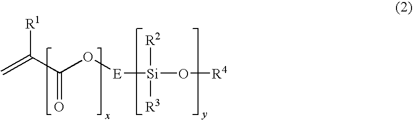

In Formula (2), R¹ is a hydrogen atom or a C₁₋₇ alkyl group; E is a single bond hydrocarbon group or a bivalent hydrocarbon group; R² and R³ are the same or different C₁₋₆ alkyl groups or C₁₋₆ alkoxyl groups; R⁴ is a C₁₋₆ alkyl group; x is 0 or 1; and y is an integer from 1 to 10.

The polymer B may be composed of essentially a single compound, or may be a mixture of a plurality of types of compounds. However, when the polymer B is a mixture of a plurality of types of compounds, each of the compounds contains at least the alkoxysilyl-containing vinyl monomer b1 as a monomer component.

Such a polymer B includes an alkoxysilyl group, and therefore has high affinity to the substrate (particularly glass substrate) for supporting the colored portion of the color filter. Therefore, when the ink includes the polymer B as a curable resin material, the ink discharged onto the substrate can suitably spread out on the substrate, and the thickness of the obtained colored portion can be made particularly uniform as a result. The obtained color filter can therefore be provided with a particularly low occurrence of uneven color and saturation among different regions. Since the polymer B has high affinity to the substrate, the colored portion of the color filter can be provided with particularly excellent adhesion to the substrate. Curing of the polymer A can be supplemented by the presence of such a polymer B, the colored portion can be formed under relatively mild conditions, and the formed colored portion can be provided with adequately excellent hardness, light fastness, thermal resistance, and other characteristics.

### Alkoxysilyl-Containing Vinyl Monomer b1

The polymer B contains at least the alkoxysilyl-containing vinyl monomer b1 indicated by Formula (2) as a monomer component. Including such an alkoxysilyl-containing vinyl monomer b1 as a monomer component makes it possible to easily and reliably introduce an alkoxysilyl group into the polymer B. By including the alkoxysilyl-containing vinyl monomer b1 as a monomer component, curing of the polymer A can be supplemented when the curable resin material (curable resin composition) is cured to form the colored portion, the colored portion can be formed under relatively mild conditions, and the formed colored portion can be provided with adequately excellent hardness, adhesion to the substrate, light fastness, thermal resistance, and other characteristics. The polymer B is also particularly less prone to curing in the discharged waste ink, and the viscosity of the waste ink is suitably prevented from increasing. When the polymer B includes a vinyl monomer b2 or the like such as described hereinafter, the polymer can be suitably synthesized, and a polymer B having the desired characteristics can be easily and reliably obtained.

In Formula (2), examples of the C₁₋₇ alkyl group indicated by R¹ include methyl, ethyl, propyl, isopropyl, butyl, isobutyl, s-butyl, t-butyl, pentyl, hexyl, heptyl, and other alkyl groups, but a hydrogen atom or a C₁₋₂ alkyl group is preferred, and a hydrogen atom or a methyl group is more preferred. The color filter ink can thereby be provided with particularly excellent dispersion stability of the pigment in the color filter ink, and discharge stability of the color filter ink, and the formed colored portion can be provided with particularly excellent hardness, adhesion to the substrate, light fastness, thermal resistance, and other characteristics. The polymer A can also be provided with particularly excellent compatibility with the polymer B, and the colored portion formed using the color filter ink can be provided with particularly high transparency.

Typical examples of the bivalent hydrocarbon group indicated by E in Formula (2) include straight-chain or branched alkylene groups, or more specifically, methylenes, ethylenes, propylenes, tetramethylenes, ethyl ethylenes, pentamethylenes, hexamethylenes, and the like. Among these examples, a C₁₋₃ straight-chain alkylene group (e.g., methylene, ethylene, propylene) is particularly preferred.

Examples of the C₁₋₆ alkyl groups indicated by R², R³, and R⁴ in Formula (2) include straight-chain or branched alkyl groups, e.g., methyl, ethyl, propyl, isopropyl, butyl, isobutyl, s-butyl, t-butyl, pentyl, hexyl, and the like. Examples of the C₁₋₆ alkoxyl groups indicated by R² and R³ include straight-chain or branched alkoxyl groups, e.g., methoxy, ethoxy, propoxy, isopropoxy, butoxy, isobutoxy, s-butoxy, t-butoxy, pentoxy, hexyloxy, and the like.

Specific examples of monomers indicated by Formula (2) include vinyltrimethoxysilane, vinyltriethoxysilane, vinylmethyldimethoxysilane, vinylmethyldiethoxysilane, γ-(meth)acryloyloxypropyltrimethoxysilane, γ-(meth)acryloyloxypropylmethyldimethoxysilane, γ-(meth)acryloyloxypropylmethyldiethoxysilane, γ-(meth)acryloyloxypropyltriethoxysilane, β-(meth)acryloyloxyethyltrimethoxysilane, γ-(meth)acryloyloxybutylphenyldimethoxysilane, and other alkoxysilyl-containing polymerizable unsaturated compounds and the like, and one or more types of compounds selected from the above examples may be combined and used.

The content ratio (which is a value obtained by substitution with the weight of the monomer used to synthesize the polymer) of the alkoxysilyl-containing vinyl monomer bl in the polymer B is preferably 70 to 100 wt %, and more preferably 80 to 100 wt %. When the content ratio of the alkoxysilyl-containing vinyl monomer b1 in the polymer B is within the aforementioned range, the color filter ink can be provided with particularly excellent dispersion stability of the pigment in the color filter ink, and discharge stability of the color filter ink. Curing of the polymer A can be supplemented when the curable resin material (curable resin composition) is cured to form the colored portion, and the colored portion can be formed under relatively mild conditions. The formed colored portion can also be provided with particularly excellent shape uniformity, hardness, adhesion to the substrate, light fastness, thermal resistance, and other characteristics. When the polymer B is a mixture of a plurality of types of compounds, the weighted average value (weighted average value based on weight ratio) of the mixed compounds may be used as the content ratio of the alkoxysilyl-containing vinyl monomer b1. When the polymer B is a mixture of a plurality of types of compounds, the compounds all preferably contain the alkoxysilyl-containing vinyl monomer b 1 in such a content ratio as described above.

### Other Polymerizable Vinyl Monomer b2

The polymer B may contain at least the alkoxysilyl-containing vinyl monomer b1 as a monomer component, but may also contain as a monomer component a polymerizable vinyl monomer b2 other than the alkoxysilyl-containing vinyl monomer b1, in addition to the alkoxysilyl-containing vinyl monomer b1. A vinyl monomer that can be copolymerized with the alkoxysilyl-containing vinyl monomer b 1 may be used as the polymerizable vinyl monomer b2, and specific examples thereof include 2-hydroxyethyl(meth)acrylate, hydroxypropyl(meth)acrylate, 2,3-dihydroxybutyl(meth)acrylate, 4-hydroxybutyl(meth)acrylate, 6-hydroxyhexyl(meth)acrylate, 8-hydroxyoctyl(meth)acrylate, 4-hydroxymethyl cyclohexyl(meth)acrylate, polyalkylene glycol mono(meth)acrylate, and other monoester compounds of a polyalcohol and acrylic acid or methacrylic acid; compounds in which ε-caprolactone is ring-open polymerized with the abovementioned monoester compounds of a polyalcohol and acrylic acid or methacrylic acid (PLACCEL FA series, PLACCEL FM series, and the like manufactured by Daicel Chemical Industries); compounds in which ethylene oxide and propylene oxide is ring-open polymerized, and other polymerizable vinyl monomers provided with a hydroxyl group; methyl(meth)acrylate, ethyl(meth)acrylate, butyl(meth)acrylate, 2-ethylhexyl(meth)acrylate, phenyl(meth)acrylate, cyclohexyl(meth)acrylate, dicyclopentanyl(meth)acrylate, dicyclopentanyloxyethyl(meth)acrylate, isobornyl(meth)acrylate, benzyl(meth)acrylate, phenyl ethyl(meth)acrylate, and other C₁₋₁₂ alkyl and aralkyl(meth)acrylates; styrene, α-methylstyrene, and other vinyl aromatic compounds; CF₃(CF₂)₃CH₂CH═CH₂, CF₃(CF₂)₃CH═CH₂, CF₃(CF₂)₅CH₂CH═CH₂, CF₃(CF₂)₅CH═CH₂, CF₃(CF₂)₇CH═CH₂, CF₃(CF₂)₉CH₂CH═CH₂, CF₃(CF₂)₉CH═CH₂, (CF₃)₂CF(CF₂)₂CH₂CH═CH₂, (CF₃)₂CF(CF₂)₂CH═CH₂, (CF₃)₂CF(CF₂)₄CH₂CH═CH₂, (CF₃)₂CF(CF₂)₄CH═CH₂, (CF₃)₂CF(CF₂)₆CH₂CH═CH₂, (CF₃)₂CF(CF₂)₆CH═CH₂, F₅C₆CH═CH₂, CF₃(CF₂)₅CH₂CH₂OCH₂CH═CH₂, CF₃(CF₂)₅CH₂CH₂OCH₂CH═CH₂, CF₃(CF₂)₇CH₂CH₂OCH₂CH═CH₂, CF₃(CF₂)₇CH₂CH₂CH₂OCH₂CH═CH₂, CF₃(CF₂)₉CH₂CH₂OCH₂CH═CH₂, CF₃(CF₂)₉CH₂CH₂CH₂OCH₂CH═CH₂, H(CF₂)₆CH₂OCH₂CH═CH₂, H(CF₂)₈CH₂OCH₂CH═CH₂, (CF₃)₂CF(CF₂)₂CH₂CH₂OCOCH═CH₂, (CF₃)₂CF(CF₂)₂CH₂CH₂OCOC(CH₃)═CH₂, (CF₃)₂CF(CF₂)₄CH₂CH₂OCOCH═CH₂, (CF₃)₂CF(CF₂)₄CH₂CH₂OCOC(CH₃)═CH₂, (CF₃)₂CF(CF₂)₆CH₂CH₂OCOCH═CH₂, (CF₃)₂CF(CF₂)₆CH₂CH₂OCOC(CH₃)═CH₂, CF₃(CF₂)₅CH₂CH₂OCOCH═CH₂, CF₃(CF₂)₅CH₂CH₂OCOC(CH₃)═CH₂, CF₃(CF₂)₇CH₂CH₂OCOCH═CH₂, CF₃(CF₂)₇CH₂CH₂OCOC(CH₃)═CH₂, CF₃(CF₂)₉CH₂CH₂OCOCH═CH₂, CF₃(CF₂)₉CH₂CH₂OCOC(CH₃)═CH₂, H(CF₂)₆CH₂CH₂OCOCH═CH₂, H(CF₂)₈CH₂CH₂OCOC(CH₃)═CH₂, F(CF₂)₈CH₂CH₂OCOCH═CH₂, F(CF₂)₈CH₂CH₂OCOC(CH₃)═CH₂, H(CF₂)₄CH₂OCOC(CH₃)═CH₂, H(CF₂)₄CH₂OCOCH═CH₂, and other fluoroalkyl- or fluoroaryl-containing vinyl monomers and the like, and one or more types of compounds selected from the above examples may be combined and used. However, the polymer B does not contain as a monomer component an epoxy-containing vinyl monomer al such as previously described. The polymer B also preferably does not contain a fluoroalkyl- or fluoroaryl-containing vinyl monomer such as described above as a monomer component.

The content ratio (which is a value obtained by substitution with the weight of the monomer used to synthesize the polymer) of the polymerizable vinyl monomer b2 in the polymer B is preferably 30 wt % or less, and more preferably 20 wt % or less. When the polymer B is a mixture of a plurality of types of compounds, the weighted average value (weighted average value based on weight ratio) of the mixed compounds may be used as the content ratio of the polymerizable vinyl monomer b2. When the polymer B is a mixture of a plurality of types of compounds, the content ratio of the polymerizable vinyl monomer b2 with respect to the mixture of compounds preferably satisfies such conditions as those described above.

As described above, the polymer B may contain at least the alkoxysilyl-containing vinyl monomer b1 as a monomer component, and may contain a monomer component other than the alkoxysilyl-containing vinyl monomer b1, but is preferably a homopolymer of the alkoxysilyl-containing vinyl monomer b1. Specifically, the polymer B preferably does not contain components other than the alkoxysilyl-containing vinyl monomer b1 as monomer components. The dispersion stability of the pigment in the color filter ink, the discharge stability of the color filter ink, and the durability of the color filter manufactured using the color filter ink can thereby be made particularly excellent.

The ratio (content ratio) accounted for by the polymer B in the curable resin material is not particularly limited, but is preferably 20 to 60 wt %, and more preferably 25 to 55 wt %. When the polymer B is a mixture of a plurality of types of compounds, the sum of the content ratios of the mixed compounds may be used as the content ratio of the polymer B.

When the polymer A and the polymer B are included as the curable resin material, the ratio of the polymer A content and the polymer B content in terms of weight is preferably 25:75 to 75:25, and more preferably 45:55 to 55:45. Satisfying such conditions enables the color filter ink to be provided with particularly excellent dispersion stability of the pigment in the color filter ink, and discharge stability of the color filter ink. The color filter manufactured using the color filter ink can be provided with excellent uniformity of characteristics between individual units, and unevenness of color and saturation between different regions can be more reliably prevented. The color filter can also be provided with excellent durability.

### Polymer C

The curable resin material (curable resin composition) may furthermore include a polymer C that contains as a monomer component the fluoroalkyl- or fluoroaryl-containing vinyl monomer c1 indicated by Formula (9) below.

Formula (9)

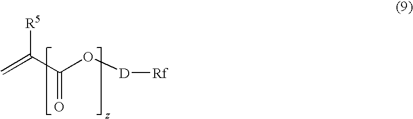

In Formula (9), R⁵ is a hydrogen atom or a C₁₋₇ alkyl group; D is a single bond hydrocarbon group or a bivalent hydrocarbon group which may contain a hetero atom; Rf is a C₁₋₂₀ fluoroalkyl group or fluoroaryl group; and z is 0 or 1.

Including such a polymer C enables the color filter ink to be provided with particularly excellent discharge stability. In particular, fluid depletion from the nozzles of the droplet discharge head can be improved, and such problems as solid components of the color filter ink adhering to the nozzles can be more effectively prevented. The colored portion formed using the color filter ink can also be provided with particularly excellent thermal resistance. Including such a polymer C also makes the waste ink particularly less prone to adhere to the droplet discharge head. The waste ink also has low affinity to the ink suction body of the cap part such as described hereinafter, for example, and is less prone to adhere to the ink suction part. The waste ink is therefore suitably removed from the ink suction body. When the color filter ink includes the polymer A and the polymer C, these polymers are particularly less prone to cure in the discharged waste ink, and the viscosity of the waste ink is suitably prevented from increasing.

The polymer C may be composed of essentially a single compound, or may be a mixture of a plurality of types of compounds. However, when the polymer C is a mixture of a plurality of types of compounds, each of the compounds contains at least the fluoroalkyl- or fluoroaryl-containing vinyl monomer c1 as a monomer component.

### Fluoroalkyl- or Fluroroaryl-Containing Vinyl Monomer c1

The polymer C contains at least the fluoroalkyl- or fluoroaryl-containing vinyl monomer c1 indicated by Formula (9) as a monomer component. Including such a fluoroalkyl- or fluoroaryl-containing vinyl monomer c1 as a monomer component makes it possible to easily and reliably introduce a fluoroalkyl group or a fluoroaryl group into the polymer C. Including the fluoroalkyl- or fluoroaryl-containing vinyl monomer c1 as a monomer component enables the color filter ink to be provided with particularly excellent discharge stability. The colored portion formed using the color filter ink can also be provided with particularly excellent thermal resistance. When the polymer C includes a vinyl monomer c2 or the like such as described hereinafter, the polymer can be suitably synthesized, and a polymer C having the desired characteristics can be easily and reliably obtained.

Examples of the C₁₋₇ alkyl group indicated by R⁵ in Formula (9) include methyl, ethyl, propyl, isopropyl, butyl, isobutyl, s-butyl, t-butyl, pentyl, hexyl, heptyl, and other alkyl groups, but a hydrogen atom or a C₁₋₂ alkyl group is preferred, and a hydrogen atom or a methyl group is more preferred. The discharge stability of the color filter ink and the thermal resistance of the colored portion formed using the color filter ink can thereby be made particularly excellent.

Typical examples of the bivalent hydrocarbon group (hydrocarbon group which may contain a hetero atom) indicated by D in Formula (9) include straight-chain or branched alkylene groups, or more specifically, methylenes, ethylenes, propylenes, tetramethylenes, ethyl ethylenes, pentamethylenes, hexamethylenes, oxymethylenes, oxyethylenes, oxypropylenes, and the like.

Specific examples of monomers indicated by Formula (9) include CF₃(CF₂)₃CH₂CH═CH₂, CF₃(CF₂)₃CH═CH₂, CF₃(CF₂)₅CH₂CH═CH₂, CF₃(CF₂)₅CH═CH₂, CF₃(CF₂)₇CH═CH₂, CF₃(CF₂)₉CH₂CH═CH₂, CF₃(CF₂)₉CH═CH₂, (CF₃)₂CF(CF₂)₂CH₂CH═CH₂, (CF₃)₂CF(CF₂)₂CH═CH₂, (CF₃)₂CF(CF₂)₄CH₂CH═CH₂, (CF₃)₂CF(CF₂)₄CH═CH₂, (CF₃)₂CF(CF₂)₆CH₂CH═CH₂, (CF₃)₂CF(CF₂)₆CH═CH₂, F₅C₆CH═CH₂, CF₃(CF₂)₅CH₂CH₂OCH₂CH═CH₂, CF₃(CF₂)₅CH₂CH₂CH₂OCH₂CH═CH₂, CF₃(CF₂)₇CH₂CH₂OCH₂CH═CH₂, CF₃(CF₂)₇CH₂CH₂CH₂OCH₂CH═CH₂, CF₃(CF₂)₉CH₂CH₂OCH₂CH═CH₂, CF₃(CF₂)₉CH₂CH₂CH₂OCH₂CH═CH₂, H(CF₂)₆CH₂OCH₂CH═CH₂, H(CF₂)₈CH₂OCH₂CH═CH₂, (CF₃)₂CF(CF₂)₂CH₂CH₂OCOCH═CH₂, (CF₃)₂CF(CF₂)₂CH₂CH₂OCOC(CH₃)═CH₂, (CF₃)₂CF(CF₂)₄CH₂CH₂OCOCH═CH₂, (CF₃)₂CF(CF₂)₄CH₂CH₂OCOC(CH₃)═CH₂, (CF₃)₂CF(CF₂)₆CH₂CH₂OCOCH═CH₂, (CF₃)₂CF(CF₂)₆CH₂CH₂OCOC(CH₃)═CH₂, CF₃(CF₂)₅CH₂CH₂OCOCH═CH₂, CF₃(CF₂)₅CH₂CH₂OCOC(CH₃)═CH₂, CF₃(CF₂)₇CH₂CH₂OCOCH═CH₂, CF₃(CF₂)₇CH₂CH₂OCOC(CH₃)═CH₂, CF₃(CF₂)₉CH₂CH₂OCOCH═CH₂, CF₃(CF₂)₉CH₂CH₂OCOC(CH₃)═CH₂, H(CF₂)₆CH₂CH₂OCOCH═CH₂, H(CF₂)₈CH₂CH₂OCOC(CH₃)═CH₂, F(CF₂)₈CH₂CH₂OCOCH═CH₂, F(CF₂)₈CH₂CH₂OCOC(CH₃)═CH₂, H(CF₂)₄CH₂OCOC(CH₃)═CH₂, H(CF₂)₄CH₂OCOCH═CH₂, and the like, and one or more types of compounds selected from the above examples may be combined and used.

The content ratio (which is a value obtained by substitution with the weight of the monomer used to synthesize the polymer) of the fluoroalkyl- or fluoroaryl-containing vinyl monomer cI in the polymer C is preferably 15 to 100 wt %, and more preferably 18 to 100 wt %. When the content ratio of the fluoroalkyl- or fluoroaryl-containing vinyl monomer c I in the polymer C is within the aforementioned range, the dispersion stability of the pigment in the color filter ink, the discharge stability of the color filter ink, and the thermal resistance of the colored portion formed using the color filter ink can be made particularly excellent. The polymer C can also be provided with particularly excellent compatibility with the polymer A or the polymer B, and the colored portion formed using the color filter ink can be provided with particularly high transparency. When the color filter ink includes the polymer A and the polymer C, these polymers are particularly less prone to cure in the discharged waste ink, and the viscosity of the waste ink is suitably prevented from increasing. When the polymer C is a mixture of a plurality of types of compounds, the weighted average value (weighted average value based on weight ratio) of the mixed compounds may be used as the content ratio of the fluoroalkyl- or fluoroaryl-containing vinyl monomer c1. When the polymer C is a mixture of a plurality of types of compounds, the compounds all preferably contain the fluoroalkyl- or fluoroaryl-containing vinyl monomer c1 in such a content ratio as described above.

### Other Polymerizable Vinyl Monomer c2

The polymer C may contain as a monomer component a polymerizable vinyl monomer c2 other than the fluoroalkyl- or fluoroaryl-containing vinyl monomer c1 such as described above. A vinyl monomer that can be copolymerized with the fluoroalkyl- or fluoroaryl-containing vinyl monomer c1 may be used as the polymerizable vinyl monomer c2, and specific examples thereof include 2-acryloyloxyethyl isocyanate (product name: Karenz MOI; manufactured by Showa Denko), 2-methacryloyloxyethyl isocyanate, and other (meth)acryloyl isocyanates and the like in which (meth)acryloyl is bonded with an isocyanate group via a C₂₋₆ alkylene group; ethyl 2-(0-[1′-methylpropylideneamino]carboxyamino)methacrylate (product name: Karenz MOI-BM; manufactured by Showa Denko) and other polymerizable vinyl monomers provided with an isocyanate group or a blocked isocyanate group in which the isocyanate group is protected by a protective group; 2-hydroxyethyl(meth)acrylate, hydroxypropyl(meth)acrylate, 2,3-dihydroxybutyl(meth)acrylate, 4-hydroxybutyl(meth)acrylate, 6-hydroxyhexyl(meth)acrylate, 8-hydroxyoctyl(meth)acrylate, 4-hydroxymethyl cyclohexyl(meth)acrylate, polyalkylene glycol mono(meth)acrylate, and other monoester compounds of a polyalcohol and acrylic acid or methacrylic acid; compounds in which ε-caprolactone is ring-open polymerized with the abovementioned monoester compounds of a polyalcohol and acrylic acid or methacrylic acid (PLACCEL FA series, PLACCEL FM series, and the like manufactured by Daicel Chemical Industries); compounds in which ethylene oxide and propylene oxide is ring-open polymerized, and other polymerizable vinyl monomers provided with a hydroxyl group; methyl(meth)acrylate, ethyl(meth)acrylate, butyl(meth)acrylate, 2-ethylhexyl(meth)acrylate, phenyl(meth)acrylate, cyclohexyl(meth)acrylate, dicyclopentanyl(meth)acrylate, dicyclopentanyloxyethyl(meth)acrylate, isobornyl(meth)acrylate, benzyl(meth)acrylate, phenyl ethyl(meth)acrylate, and other C₁₋₁₂ alkyl and aralkyl(meth)acrylates; styrene, α-methylstyrene, and other vinyl aromatic compounds; and one or more types of compounds selected from the above examples may be combined and used. However, the polymer C does not contain as a monomer component the epoxy-containing vinyl monomer a1 and the alkoxysilyl-containing vinyl monomer b1 such as previously described.

The content ratio (which is a value obtained by substitution with the weight of the monomer used to synthesize the polymer) of the polymerizable vinyl monomer c2 in the polymer C is preferably 85 wt % or less, and more preferably 82 wt % or less. When the polymer C is a mixture of a plurality of types of compounds, the weighted average value (weighted average value based on weight ratio) of the mixed compounds may be used as the content ratio of the polymerizable vinyl monomer c2. When the polymer C is a mixture of a plurality of types of compounds, the content ratio of the polymerizable vinyl monomer c2 with respect to the mixture of compounds preferably satisfies such conditions as those described above.

When the curable resin material includes the polymer C, the ratio (content ratio) accounted for by the polymer C in the curable resin material is not particularly limited, but is preferably 1 to 20 wt %, and more preferably 2 to 15 wt %. When the polymer C is a mixture of a plurality of types of compounds, the sum of the content ratios of the mixed compounds may be used as the content ratio of the polymer C.

When the curable resin material includes the polymer C, the ratio of the polymer A content and the polymer C content in terms of weight is preferably 50:50 to 99:1, and more preferably 60:40 to 98:2. Satisfying such conditions enables the color filter ink to be provided with particularly excellent dispersion stability of the pigment in the color filter ink, and discharge stability of the color filter ink. The color filter manufactured using the color filter ink can be provided with particularly excellent uniformity of characteristics between individual units, and unevenness of color and saturation between different regions can be more effectively prevented. The color filter can also be provided with particularly excellent durability.

The weight-average molecular weight of each polymer (polymer A, polymer B, polymer C) such as described above is preferably 1000 to 50000, more preferably 1200 to 10000, and even more preferably 1500 to 5000. The degree of dispersion (weight-average molecular weight Mw/number-average molecular weight Mn) of each polymer (polymer A, polymer B, polymer C) such as described above is about 1 to 3.

The content ratio of the curable resin material in the color filter ink is preferably 0.5 to 10 wt %, and more preferably 1 to 5 wt %. When the content ratio of the curable resin material is within this range, the manufactured color filter can be provided with particularly excellent durability while providing the color filter ink with excellent discharge properties from the droplet discharge head. Adequate color saturation can also be maintained in the manufactured color filter.

The content ratio of the curable resin material with respect to 100 parts by weight of the pigment is preferably 15 to 50 parts by weight, and more preferably 19 to 42 parts by weight. Satisfying such conditions enables the color filter ink to be provided with particularly excellent dispersion stability of the pigment in the color filter ink, and discharge stability of the color filter ink, and enables the color filter manufactured using the color filter ink to be provided with particularly excellent contrast and coloration properties of the colored portion. Particularly excellent adhesion of the colored portion to the substrate can also be obtained.

The curable resin material constituting the color filter ink may also include a polymer other than the polymer A, polymer B, and polymer C described above.

The color filter ink may include a component other than those described above. Dispersing agents and the like are included as examples of components other than the pigment and components described above that constitute the color filter ink.

### Thermoplastic Resin

The color filter ink may include a thermoplastic resin. Particularly excellent dispersion properties of the pigment particles in the color filter ink can thereby be obtained. In a manufacturing method such as described hereinafter, the dispersion stability of the pigment particles in the color filter ink can be made extremely excellent by using a thermoplastic resin in the preparatory dispersion process.

Examples of thermoplastic resins include alginic acid, polyvinyl alcohol, hydroxypropyl cellulose, carboxymethyl cellulose, hydroxyethyl cellulose, methyl cellulose, styrene-acrylic acid resin, styrene-acrylic acid-acrylic acid ester resin, styrene-maleic acid resin, styrene-maleic acid semi-ester resin, methacrylic acid-methacrylic acid ester resin, acrylic acid-acrylic acid ester resin, isobutylene-maleic acid resin, rosin-modified maleic acid resin, polyvinyl pyrrolidone, gum arabic starch, polyallyl amine, polyvinyl amine, polyethylene imine, and the like, and one or more types of compounds selected from the above examples may be combined and used.

The content ratio of the thermoplastic resin in the color filter ink is not particularly limited, but is preferably 1.5 to 7.7 wt %, and more preferably 2.1 to 7.2 wt %.

### Other Components

The color filter ink of the present invention may include components other than those described above. Examples of such components include various dyes; various cross-linking agents; thermoacid generators such as diazonium salt, iodonium salt, sulfonium salt, phosphonium salt, selenium salt, oxonium salt, ammonium salt, benzothiazolium salt, and other onium salts; diazonium salt, iodonium salt, sulfonium salt, phosphonium salt, selenium salt, oxonium salt, ammonium salt, and other photoacid generators; various polymerization initiators; acid crosslinking agents; intensifiers; photostabilizers; adhesive improvers; various polymerization accelerants; various photostabilizers; glass, alumina, and other fillers; vinyl trimethoxysilane, vinyl triethoxysilane, vinyl tris(2-methoxy ethoxy)silane, N-(2-aminoethyl)-3-aminopropyl methyl dimethoxysilane, N-(2-aminoethyl)-3-aminopropyl trimethoxysilane, 3-aminopropyl triethoxysilane, 3-glycidoxy propyl trimethoxysilane, 3-glycidoxy propyl methyl dimethoxysilane, 2-(3,4-epoxy cyclohexyl)ethyl trimethoxysilane, 3-chloro propyl methyl dimethoxysilane, 3-chloro propyl trimethoxysilane, 3-methacryloxy propyl trimethoxysilane, 3-mercapto propyl trimethoxysilane, and other adhesion accelerants; 2,2-thiobis(4-methyl-6-t-butyl phenol), 2,6-di-t-butyl phenol, and other antioxidants; 2-(3-t-butyl-5-methyl-2-hydroxy phenyl)-5-chloro benzotriazole, alkoxy benzophenone, and other UV absorbers; sodium polyacrylate, and other anti-coagulants; and the like.

Examples of dyes include azo dyes, anthraquinone dyes, condensed multi-ring aromatic carbonyl dyes, indigoid dyes, carbonium dyes, phthalocyanine dyes, methines, polymethine dyes, and the like. Specific examples of dyes include C. I. Direct Red 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C. I. Acid Red 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C. I. Reactive Red 3, 13, 17, 19, 21, 22, 23, 24, 29, 35, 37, 40, 41, 43, 45, 49, and 55; C. I. Basic Red 12, 13, 14, 15, 18, 22, 23, 24, 25, 27, 29, 35, 36, 38, 39, 45, and 46; C. I. Direct Violet 7, 9, 47, 48, 51, 66, 90, 93, 94, 95, 98, 100, and 101; C. I Acid Violet 5, 9, 11, 34, 43, 47, 48, 51, 75, 90, 103, and 126; C. I. Reactive Violet 1, 3, 4, 5, 6, 7, 8, 9, 16, 17, 22, 23, 24, 26, 27, 33, and 34; C. I. Basic Violet 1, 2, 3, 7, 10, 15, 16, 20, 21, 25, 27, 28, 35, 37, 39, 40, and 48; C. I. Direct Yellow 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C. I. Acid Yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C. I. Reactive Yellow 2, 3, 13, 14, 15, 17, 18, 23, 24, 25, 26, 27, 29, 35, 37, 41, and 42; C. I. Basic Yellow 1, 2, 4, 11, 13, 14, 15, 19, 21, 23, 24, 25, 28, 29, 32, 36, 39, and 40; C. I. Acid Green 16; C. I. Acid Blue 9, 45, 80, 83, 90 and 185; C. I. Basic Orange 21 and 23; and the like.

Examples of cross-linking agents that may be used include polycarboxylic acid anhydrides, polycarboxylic acids, polyfunctional epoxy monomers, polyfunctional acrylic monomers, polyfunctional vinyl ether monomers, and polyfunctional oxetane monomers. Specific examples of polycarboxylic acid anhydrides include phthalic anhydride, itaconic anhydride, succinic anhydride, citraconic anhydride, dodecenyl succinic anhydride, tricarballylic anhydride, maleic anhydride, hexahydrophthalic anhydride, dimethyl tetrahydrophthalic anhydride, himic anhydride, nadic anhydride, and other aliphatic or alicyclic dicarboxylic anhydrides; 1,2,3,4-butane tetracarboxylic acid dianhydride and cyclopentane tetracarboxylic acid dianhydride; benzophenone tetracarboxylic anhydride and other aromatic polycarboxylic acid anhydrides; ethylene glycol his trimellitate, glycerin tris trimellitate, and other ester-containing organic anhydrides, among which an aromatic polycarboxylic acid anhydride is preferred. An epoxy resin curing agent composed of a commercially available carboxylic acid anhydride can also be suitably used. Specific examples of polycarboxylic acids include succinic acid, glutaric acid, adipic acid, butane tetracarboxylic acid, maleic acid, itaconic acid, and other aliphatic polycarboxylic acids; hexahydrophthalic acid, 1,2-cyclohexane dicarboxylic acid, 1,2,4-cyclohexane tricarboxylic acid, cyclopentane tetracarboxylic acid, and other aliphatic polycarboxylic acids; and phthalic acid, isophthalic acid, terephthalic acid, pyromellitic acid, trimellitic acid, 1,4,5,8-naphthalene tetracarboxylic acid, benzophenone tetracarboxylic acid, and other aromatic polycarboxylic acid, but among these, aromatic polycarboxylic acid is preferred. Specific examples of a polyfunctional epoxy monomer include the product name Celloxide 2021 manufactured by Daicel Chemical Industries, the product name Epolead GT401 manufactured by Daicel Chemical Industries, the product name Epolead PB3600 manufactured by Daicel Chemical Industries, bisphenol A, hydrogenated bisphenol A, and triglycidyl isocyanurate. Specific example of a polyfunctional acrylic monomer include pentaerythritolethoxy tetraacrylate, pentaerythritol tetraacrylate, pentaerythritol triacrylate, pentaerythritolethoxy tetraacrylate, ditrimethylolpropane tetraacrylate, trimethylolpropane triacrylate, trimethylolpropane ethoxy triacrylate, dipentaerythritol hexaacrylate trimethallyl isocyanurate, and triallyl isocyanurate. Examples of a polyfunctional vinyl ether monomer include 1,4-butanediol vinyl ether, 1,6-hexanediol divinyl ether, nonanediol divinyl ether, cyclohexanediol divinyl ether, cyclohexanedimethanol divinyl ether, triethylene glycol divinyl ether, trimethylolpropane trivinyl ether, and pentaerythritol tetravinyl ether. Examples of polyfunctional oxetane monomers include xylylene dioxetane, biphenyl-type oxetane, and novolac-type oxetane.

The thermoacid generator is a component for generating acid by applying heat, and particularly preferred among those described above are sulfonium salt and benzothiazolium. More specific examples of thermoacid generators in terms of product names include Sunaid SI-45, Sunaid SI-47, Sunaid SI-60, Sunaid SI-60L, Sunaid SI-80, Sunaid SI-80L, Sunaid SI-100, Sunaid SI-100L, Sunaid SI-145, Sunaid SI-150, Sunaid SI-160, Sunaid SI-110L, Sunaid SI-180L (all product names, manufactured by Sanshin Chemical Industry Co., Ltd.), CI-2921, CI-2920, CI-2946, CI-3128, CI-2624, CI-2639, CI-2064 (all product names, manufactured by Nippon Soda Co., Ltd.), CP-66, CP-77 (product names, manufactured by Adeka Corporation), and FC-520 (product name, manufactured by 3M Company).

The photoacid generator is a component for generating acid by using light, and more specific examples include the product names Cyracure UVI-6970, Cyracure UVI-6974, Cyracure UVI-6990, Cyracure UVI-950 (all product names, manufactured by US Union Carbide), Irgacure 261 (product name, Ciba Specialty Chemicals), SP-150, SP-151, SP-170, Optomer SP-171(all product names, manufactured by Adeka Corporation), CG-24-61 (product name, manufactured by Ciba Specialty Chemicals), Daicat II (product name, manufactured by Daicel Chemical Industries, Ltd.), UVAC 1591 (product name, manufactured by Daicel UCB Co., Ltd.), CI-2064, CI-2639, CI-2624, CI-2481, CI-2734, CI-2855, CI-2823, CI-2758 (product name, manufactured by Nippon Soda Co., Ltd.), PI-2074 (product name, manufactured by Rhone Poulenc, pentafluorophenyl borate tolyl cumyl iodonium), FFC509 (product name, manufactured by 3M Company), BBI-102, BBI-101, BBI-103, MPI-103, TPS-103, MDS-103, DTS-103, NAT-103, NDS-103 (product name, manufactured by Midori Kagaku Co., Ltd.), and CD-1012 (product name, manufactured by Sartomer Co., Inc.).

The viscosity (viscosity (kinetic viscosity) measured using an E-type viscometer) of the color filter ink at 25° C. is preferably 13 mPa·s or lower, more preferably 12 mPa·s or lower, and more preferably 5 to 11 mPa·s. When the viscosity (kinetic viscosity) of the color filter ink is thus adequately low, the production efficiency (efficiency of forming the colored portion) of the color filter can be made particularly excellent, for example, and unwanted fluctuation of the thickness and other characteristics of the colored portion can be effectively prevented. The viscosity (kinetic viscosity) of the color filter ink can be measured using an E-type viscometer (e.g., RE-01 manufactured by Toki Sangyo), for example, and can particularly be performed in accordance with JIS Z8809.

The amount of change in the viscosity at 25° C. of the color filter ink after the color filter ink is left for 12 days at 60° C. is preferably 0.5 mPa·s or less, more preferably 0.3 mPa·s or less, and more preferably 0.2 mPa·s or less. The color filter ink can thereby be provided with particularly excellent discharge stability, and the color filter ink can be suitably used for a longer period of time to manufacture a color filter in which the occurrence of uneven color, saturation, and the like is reliably prevented.

### Color Filter Ink Manufacturing Method

Preferred embodiments of the method for manufacturing a color filter ink such as described above will next be described.

The manufacturing method of the present embodiment has a preparatory dispersion step of obtaining a dispersing-agent-dispersed liquid in which a dispersing agent is dispersed in a dispersion medium, by stirring a mixture of a dispersing agent, a thermoplastic resin, and a dispersion medium; a fine dispersion step of adding a pigment to the dispersing-agent-dispersed liquid, adding inorganic beads in multi-stage fashion and performing a fine dispersion process, and obtaining a pigment dispersion; and a curable resin mixing step of mixing the pigment dispersion and the curable resin material.

### Preparatory Dispersion Step

In the preparatory dispersion step, a dispersing-agent-dispersed liquid in which a dispersing agent is dispersed in a dispersion medium is prepared by stirring a mixture that includes a dispersing agent, a thermoplastic resin, and a dispersion medium. The associated state of the dispersing agent can thereby be released (undone).

By thus pre-dispersing a mixture that does not include a pigment prior to the process described in detail hereinafter for fine dispersing the pigment in the present embodiment, a color filter ink can ultimately be obtained that has particularly excellent discharge stability, in which the pigment particles are uniformly and stably dispersed.

In this step, the thermoplastic resin, the dispersing agent, and the dispersion medium are mixed together in advance, whereby the dispersing agent and the thermoplastic resin are adhered to the surfaces of the pigment particles (pigment particles having a relatively large grain size that are not fine dispersed) added to the dispersing-agent-dispersed liquid in the fine dispersion step described hereinafter, and excellent dispersion properties of the pigment particles (pigment particles having a relatively large grain size that are not fine dispersed) in the dispersing-agent-dispersed liquid can be obtained. The fine dispersion process in the fine dispersion step can thereby be efficiently performed, the production properties of the color filter ink can be made particularly excellent, and particularly excellent long-term dispersion stability of the pigment particles (fine dispersed pigment fine-particles) and discharge stability of droplets can be obtained in the color filter ink ultimately obtained.

The content ratio (sum of the content ratios when a plurality of types of dispersing agents is used jointly) of the dispersing agent in the dispersing-agent-dispersed liquid prepared in the present step is not particularly limited, but is preferably 10 to 40 wt %, and more preferably 12 to 32 wt %. When the content ratio of the dispersing agent is within this range, such effects as previously described are demonstrated more significantly.

The content ratio of the thermoplastic resin in the dispersing-agent-dispersed liquid prepared in the present step is not particularly limited, but is preferably 6 to 30 wt %, and more preferably 8 to 26 wt %. When the content ratio of the thermoplastic resin is within this range, such effects as previously described are demonstrated more significantly.

The content ratio of the dispersion medium in the dispersing-agent-dispersed liquid prepared in the present step is not particularly limited, but is preferably 40 to 80 wt %, and more preferably 53 to 75 wt %. When the content ratio of the dispersion medium is within this range, such effects as previously described are demonstrated more significantly.

In the present step, a dispersing-agent-dispersed liquid is obtained by stirring a mixture of the abovementioned components using various types of agitators.

Examples of agitators that can be used in the present step include a Dispermill or other single-shaft or twin-shaft mixer or the like.

The stirring time for which the agitator is used is not particularly limited, but is preferably 1 to 30 minutes, and more preferably 3 to 20 minutes. The associated state of the dispersing agent can thereby be more effectively released while adequately excellent production properties of the color filter ink are obtained, and particularly excellent dispersion stability of pigment particles in the color filter ink ultimately obtained, particularly excellent discharge stability of the color filter ink can be obtained.

The speed of the stirring vanes of the agitator in the present step is not particularly limited, but is preferably 500 to 4000 rpm, and more preferably 800 to 3000 rpm. The associated state of the dispersing agent can thereby be more effectively released while adequately excellent production properties of the color filter ink are obtained, and it is possible to obtain particularly excellent dispersion stability of pigment particles in the color filter ink ultimately obtained. Degradation, denaturation, and the like of the thermoplastic resin and other components due to heat and the like can also be reliably prevented.

### Fine Dispersion Step

A pigment such as described above is then added to the dispersing-agent-dispersed liquid obtained in the step described above, inorganic beads are added in multiple stages, and a fine dispersion process is performed (fine dispersion step).

Prior to adding the pigment, a preparatory dispersion step such as the one described above is thus provided in the present embodiment, and inorganic beads are added in multiple stages in the step (fine dispersion step) of fine dispersing the pigment, In the fine dispersion step, adding the inorganic beads in multi-stage fashion makes it possible to form fine-particles of the pigment with superior efficiency, and to make the pigment particles adequately small in the color filter ink ultimately obtained. In particular, the effects of jointly using a halogenated phthalocyanine complex (main pigment) and a sulfonated pigment derivative (secondary pigment) such as described above, and the effects of using a method having a preparatory dispersion step and a multi-stage fine dispersion step act synergistically, the color filter ink ultimately obtained can be provided with extremely excellent dispersion stability of pigment and discharge stability of droplets, and the color filter ink can be used to manufacture a color filter having extremely excellent brightness and contrast.

It is sufficient for the present step to be performed by adding the inorganic beads in multiple stages, and the inorganic beads may be added in three or more stages, but the inorganic beads are preferably added in two stages. The production properties of the color filter ink can thereby be made particularly excellent while the color filter ink ultimately obtained is provided with adequately excellent long-term dispersion stability of the pigment particles.

A method for adding the inorganic beads in two stages will be described below. Specifically, a typical example of a method will be described for performing a first treatment using first organic beads, and a second treatment using second organic beads in the fine dispersion step.

The inorganic beads (first inorganic beads and second inorganic beads) used in the present step may be composed of any material insofar as the material is an inorganic material, but preferred examples of the inorganic beads include zirconia beads (e.g., Toray Ceram grinding balls (trade name); manufactured by Toray) and the like.

### First Treatment

In the present step, the pigments (main pigment and secondary pigment) are first added to the dispersing-agent-dispersed liquid prepared in the preparatory dispersion step described above, and a first treatment is performed for primary fine dispersion using first inorganic beads having a predetermined grain size.

The first inorganic beads used in the first treatment preferably have a larger grain size than the second inorganic beads used in the second treatment. The efficiency of fine-particle formation (fine dispersion) of the pigments in the overall fine dispersion step can thereby be made particularly excellent.

The average grain size of the first inorganic beads is not particularly limited, but is preferably 0.5 to 3.0 mm, more preferably 0.5 to 2.0 mm, and more preferably 0.5 to 1.2 mm. When the average grain size of the first inorganic beads is within the aforementioned range, the efficiency of fine-particle formation (fine dispersion) of the pigments in the overall fine dispersion step can be made particularly excellent. In contrast, when the average grain size of the first inorganic beads is less than the lower limit of the aforementioned range, severe reduction of the efficiency of fine-particle formation (grain size reduction) of the pigment particles by the first treatment tends to occur according to the type and other characteristics of the pigments. When the average grain size of the first inorganic beads exceeds the upper limit of the aforementioned range, although the efficiency of fine-particle formation (grain size reduction) of the pigment particles by the first treatment can be made relatively excellent, the efficiency of fine-particle formation (grain size reduction) of the pigment particles by the second treatment is reduced, and the efficiency of fine-particle formation (fine dispersion) of the pigments is reduced in the fine dispersion step as a whole.

The amount of the first inorganic beads used is not particularly limited, but is preferably 100 to 600 parts by weight, and more preferably 200 to 500 parts by weight with respect to 100 parts by weight of the dispersing-agent-dispersed liquid.

The amount of the pigments added to the dispersing-agent-dispersed liquid is not particularly limited, but is preferably 12 parts by weight or more, and more preferably 18 to 35 parts by weight with respect to 100 parts by weight of the dispersing-agent-dispersed liquid.

The first treatment may be performed by stirring using various types of agitators in a state in which the pigments and the first inorganic beads are added to the dispersing-agent-dispersed liquid.

Examples of agitators that can be used in the first treatment include a ball mill or other media-type dispersing device, a Dispermill or other single-shaft or twin-shaft mixer, or the like.

The stirring time (processing time of the first treatment) for which the agitator is used is not particularly limited, but is preferably 10 to 120 minutes, and more preferably 15 to 40 minutes. Fine-particle formation (fine dispersion) of the pigments can thereby be efficiently advanced without reducing the production properties of the color filter ink.

The speed of the stirring vanes of the agitator in the first treatment is not particularly limited, but is preferably 1000 to 5000 rpm, and more preferably 1200 to 3800 rpm. Fine-particle formation (fine dispersion) of the pigments can thereby be efficiently advanced without reducing the production properties of the color filter ink. Degradation, denaturation, and the like of the thermoplastic resin and other components due to heat and the like can also be reliably prevented.

### Second Treatment

A second treatment using second inorganic beads is performed after the first treatment. A pigment dispersion is thereby obtained in which the pigment particles are adequately fine dispersed.

The second treatment may be performed in a state in which the first inorganic beads are included, but the first inorganic beads are preferably removed prior to the second treatment. Fine-particle formation (fine dispersion) of the pigments in the second treatment can thereby be performed with particularly excellent efficiency. The first inorganic beads can be easily and reliably removed by filtration or the like, for example.

The second inorganic beads used in the second treatment preferably have a smaller grain size than the first inorganic beads used in the first treatment. The pigments can thereby be adequately formed into fine-particles (fine dispersed) in the color filter ink ultimately obtained, particularly excellent dispersion stability (long-term dispersion stability) of the pigment particles in the color filter ink over a long period of time can be obtained, and particularly excellent discharge stability of droplets can be obtained.

The average grain size of the second inorganic beads is not particularly limited, but is preferably 0.03 to 0.3 mm, and more preferably 0.05 to 0.2 mm. When the average grain size of the second inorganic beads is within the aforementioned range, the pigments can be formed into fine-particles (fine dispersed) with particularly excellent efficiency in the fine dispersion step as a whole. In contrast, when the average grain size of the second inorganic beads is less than the lower limit of the aforementioned range, severe reduction of the efficiency of fine-particle formation (grain size reduction) of the pigment particles by the second treatment tends to occur according to the type and other characteristics of the pigments. When the average grain size of the second inorganic beads exceeds the upper limit of the aforementioned range, fine-particle formation (fine dispersion) of the pigment particles can be difficult to adequately advance.

The amount of the second inorganic beads used is not particularly limited, but is preferably 100 to 600 parts by weight, and more preferably 200 to 500 parts by weight with respect to 100 parts by weight of the dispersing-agent-dispersed liquid.

The second treatment can be performed using various types of agitators.

Examples of agitators that can be used in the second treatment include a ball mill or other media-type dispersing device, a Dispermill or other single-shaft or twin-shaft mixer, or the like.

The stirring time (processing time of the second treatment) for which the agitator is used is not particularly limited, but is preferably 10 to 120 minutes, and more preferably 15 to 40 minutes. Fine-particle formation (fine dispersion) of the pigments can thereby be adequately advanced without reducing the production properties of the color filter ink.

The speed of the stirring vanes of the agitator in the second treatment is not particularly limited, but is preferably 1000 to 5000 rpm, and more preferably 1200 to 3800 rpm. Fine-particle formation (fine dispersion) of the pigments can thereby be efficiently advanced without reducing the production properties of the color filter ink. Degradation, denaturation, and the like of the thermoplastic resin and other components due to heat and the like can also be reliably prevented.

A case was described above in which the fine dispersion process was performed in two stages, but three or more stages of processing may also be performed. In such a case, the inorganic beads used in the later stages preferably have a smaller diameter than the inorganic beads used in the first stages. In other words, the average grain size of the inorganic beads (n^{th} inorganic beads) used in the n^{th} process is preferably smaller than the average grain size of the inorganic beads ((n−1)^{th} inorganic beads) used in the (n−1)^{th} process. By satisfying such a relationship, the pigment particles can be formed into fine-particles (fine dispersed) with particularly excellent efficiency, and the diameter of the pigment particles can be reduced in the color filter ink ultimately obtained.

In the fine dispersion step (e.g., the first treatment and the second treatment), the solvent may be used for dilution or the like, for example, as needed.

### Curable Resin Mixing Step

The pigment dispersion obtained in the fine dispersion step such as described above is mixed with the curable resin material (curable resin mixing step). The color filter ink is thereby obtained.

The present step is preferably performed in a state in which the second inorganic beads used in the second treatment have been removed. The second inorganic beads can be easily and reliably removed by filtration, for example.

The present step can be performed using various types of agitators.

Examples of agitators that can be used in the present step include a Dispermill or other single-shaft or twin-shaft mixer, or the like.

The stirring time (processing time of the present step) for which the agitator is used is not particularly limited, but is preferably 1 to 60 minutes, and more preferably 15 to 40 minutes.

The speed of the stirring vanes of the agitator in the present step is not particularly limited, but is preferably 1000 to 5000 rpm, and more preferably 1200 to 3800 rpm.

In the present step, a liquid having a different composition than the dispersion medium used in the aforementioned step may be added. A color filter ink having the desired characteristics can thereby be reliably obtained while dispersion of the dispersing agent in the aforementioned preparatory dispersion step, and fine dispersion of the pigment particles in the fine dispersion step are appropriately performed.

In the present step, at least a portion of the dispersion medium used in the aforementioned step may be removed prior to mixing of the pigment dispersion and the curable resin material, and after mixing of the pigment dispersion and the curable resin material. The composition of the dispersion medium in the preparatory dispersion step and the fine dispersion step, and the composition of the dispersion medium in the color filter ink ultimately obtained can thereby be made to differ from each other. As a result, a color filter ink having the desired characteristics can be reliably obtained while dispersion of the dispersing agent in the aforementioned preparatory dispersion step, and fine dispersion of the pigment particles in the fine dispersion step are appropriately performed. The dispersion medium can be removed by placing the liquid to be removed in a reduced-pressure atmosphere, heating, or another method, for example.

### Ink Set

The color filter ink such as that described above is used in the manufacture of a color filter using an inkjet method. A color filter ordinarily has colored portions having a plurality of colors (ordinarily, RGB corresponding to the three primary colors of light) in correlation with a full color display. A plurality of types of color filter ink that correspond to the plurality of colors of colored portions is used in the formation of the colored portions. In other words, an ink set provided with a plurality of colors of color filter ink is used in the manufacture of a color filter. In the present invention, the ink set is provided with the color filter ink of the present invention such as described above, and other colors of ink (color filter inks). The color filter ink of the present invention is usually used to form a green colored portion. Consequently, the ink set is provided with the color filter ink of the present invention, as well as an ink (color filter ink) used for form a red colored portion, and an ink (color filter ink) used to form a blue colored portion, for example. The other colors of ink (inks other than the color filter ink of the present invention) provided to the ink set may be manufactured by any method, but are preferably manufactured by the same method (the same method except that the types of pigment are changed) as the method for manufacturing a color filter ink set of the present invention such as described above. Fluctuation of the droplet discharge stability and the like between colors can thereby be suppressed at a higher level, and a more reliable color filter can be manufactured.

The other colors of ink (inks other than the color filter ink of the present invention) provided to the ink set are not particularly limited, but preferably include a dispersing agent and a liquid A and liquid B such as described above. The waste ink is thereby reliably prevented from solidifying and increasing in viscosity even when a plurality of types of ink is mixed in the waste ink. The waste ink is reliably prevented from solidifying and increasing in viscosity particularly by satisfying the solubility parameter relationship such as described above for the dispersing agent and the liquid B that are included in the color filter inks. As a result, fluctuation of the droplet discharge stability and other characteristics can be suppressed over long periods of time, and a more reliably color filter can be manufactured. Fluctuation of characteristics (e.g., light fastness, adhesion to the substrate, and other characteristics) between different colors of colored portions can also be suppressed, and the manufactured color filter can be provided with particularly high reliability, durability, and other characteristics.

The other colors of ink (inks other than then color filter ink of the present invention) provided to the ink set are not particularly limited, but preferably include a curable resin material such as described above. Fluctuation of the droplet discharge stability and other characteristics between colors can thereby be suppressed at a higher level, and a more reliable color filter can be manufactured. Fluctuation of characteristics (e.g., light fastness, adhesion to the substrate, and other characteristics) between different colors of colored portions can also be suppressed, and the manufactured color filter can be provided with particularly high reliability, durability, and other characteristics.

When the ink set is provided with a red color filter ink (R ink) besides the color filter ink (green color filter ink) of the present invention such as described above, the R ink preferably includes C. I. Pigment Red 254 and a sulfonated pigment derivative such as described above as pigments. The R ink can thereby be provided with particularly excellent coloration properties. It is also possible to obtain particularly excellent long-term dispersion stability of the pigment particles in the color filter ink, and particularly excellent discharge stability of the color filter ink. The red colored portion can also be provided with particularly high contrast, brightness, and color saturation. The color filter can also be provided with a particularly wide color reproduction range.

When the ink set is provided with a blue color filter ink (B ink) in addition to the color filter ink (red color filter ink) of the present invention such as described above, the B ink preferably includes C. I. Pigment Blue 15:6 as the pigment. Particularly excellent coloration properties of the B ink can thereby be obtained. It is also possible to obtain particularly excellent long-term dispersion stability of the pigment particles in the color filter ink, and particularly excellent discharge stability of the color filter ink. The blue colored portion can also be provided with particularly high contrast, brightness, and color saturation. The color filter can also be provided with a particularly wide color reproduction range.

### Color Filter

Following is a description of an example of a color filter manufactured using the color filter ink (ink set) described above.

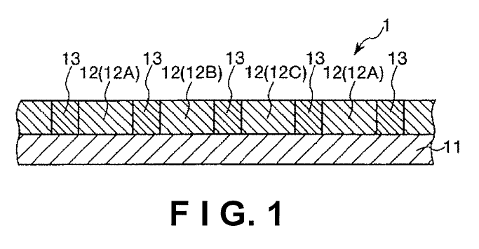

FIG. 1 is a sectional view showing a preferred embodiment of the color filter of the present invention.

A color filter 1 is provided with a substrate 11 and colored portions 12 formed using the color filter ink described above, as shown in FIG. 1. The colored portions 12 are provided with a first colored portion 12A, a second colored portion 12B, and a third colored portion 12C, having mutually different colors. A partition wall 13 is disposed between adjacent colored portions 12.

### Substrate

The substrate 11 is a plate-shaped member having optical transparency, and has a function for holding the colored portions 12 and the partition wall 13.

It is preferred that the substrate 11 be essentially composed of a transparent material. A clearer image can thereby be formed by light transmitted through the color filter 1.

The substrate 11 is preferably one having excellent heat resistance and mechanical strength. Deformations or the like caused by, e.g., heat applied during the manufacture of the color filter 1 can thereby be reliably prevented. Examples of a constituent material of the substrate 11 that satisfies such conditions include glass, silicon, polycarbonate, polyester, aromatic polyamide, polyamidoimide, polyimide, norbornene-based ring-opening polymers, and hydrogenated substances.

### Colored Portions

The colored portions 12 are formed using a color filter ink such as that described above.

The colored portions 12 are formed using a color filter ink such as that described above, and therefore have little variation in characteristics between pixels, and unintentional color mixing (mixing of a plurality of color filter inks) and the like is reliably prevented. For this reason, the color filter 1 is highly reliable in that the occurrence of unevenness of color and saturation, and the like is reduced. The color filter 1 also has excellent contrast and excellent coloration properties of the colored portions 12.

Each colored portion 12 is disposed inside a cell 14, which is an area enclosed by a later-described partition wall 13.

The first colored portion 12A, the second colored portion 12B, and the third colored portion 12C have mutually different colors. For example, the first colored portion 12A can be a red filter area (R), second colored portion 12B can be a green filter area (G), and the third colored portion 12C can be a blue filter area (B). The colored portions 12A, 12B, 12C as a single set of different colors constitute a single pixel. A prescribed number of the colored portions 12 are disposed in the lateral and longitudinal directions in the color filter 1. For example, when the color filter 1 is a color filter for high definition, 1366×768 pixels are disposed; when the color filter is a color filter for full high definition, 1920×1080 pixels are disposed; and when the color filter is a color filter for super high definition, 7680×4320 pixels are disposed. The color filter 1 may be provided with, e.g., spare pixels outside of the effective area.

### Partition Wall

A partition wall (bank) 13 is disposed between adjacent colored portions 12. Adjacent colored portions 12 can thereby be reliably prevented from color mixing, and as a result, a sharp image can be reliably displayed.

The partition wall 13 may be composed of a transparent material, but is preferably composed of material having light-blocking properties. An image with excellent contrast can thereby be displayed. The color of the partition wall (light-blocking portion) 13 is not particularly limited, but black is preferred. Accordingly, the contrast of a displayed image is particularly good.

The height of the partition wall 13 is not particularly limited, but is preferably greater than the thickness of the colored portions 12. Color mixing between adjacent colored portions 12 can thereby be reliably prevented. The specific thickness of the partition wall 13 is preferably 0.1 to 10 μm, and more preferably 0.5 to 3.5 μm. Color mixing between adjacent colored portions 12 can thereby be reliably prevented, and image display devices and electronic devices provided with the color filter 1 can be provided with excellent visual angle characteristics.

The partition wall 13 may be composed of any material, but is preferably composed principally of a curable resin material, for example. Accordingly, a partition wall 13 having a desired shape can be easily formed using a method described hereinafter. In the case that the partition wall 13 functions as a light-blocking portion, carbon black or another light-absorbing material may be included as a constituent element of the partition wall.

### Method for Manufacturing Color Filter

Next, an example of the method for manufacturing the color filter 1 will be described.

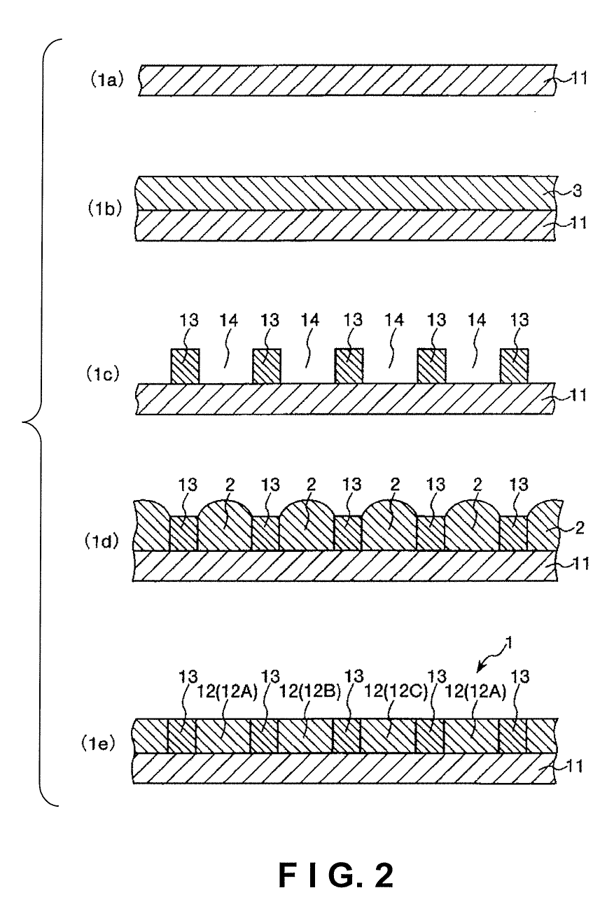

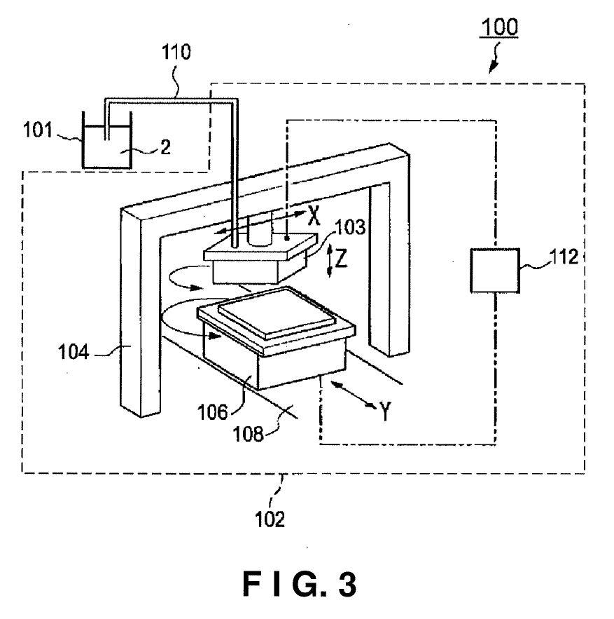

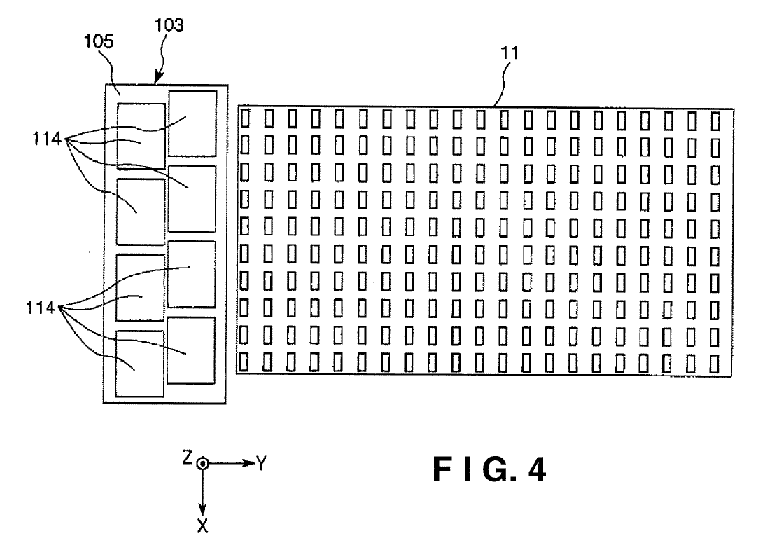

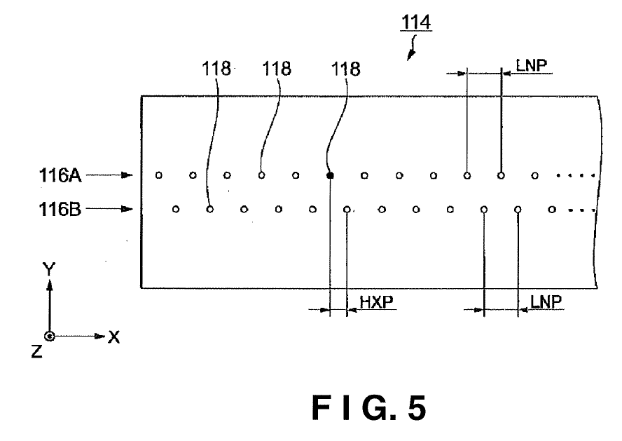

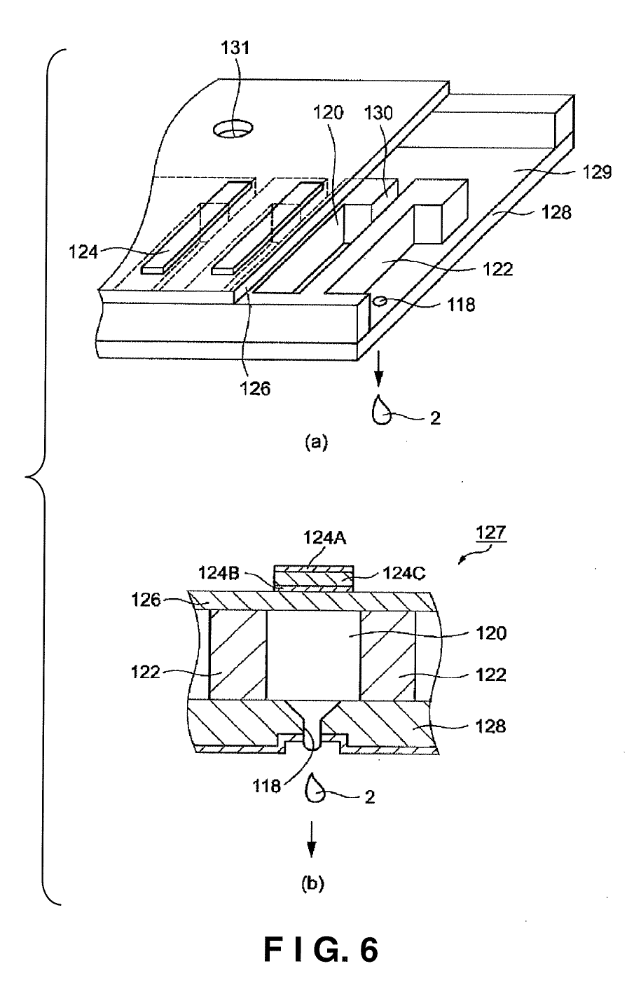

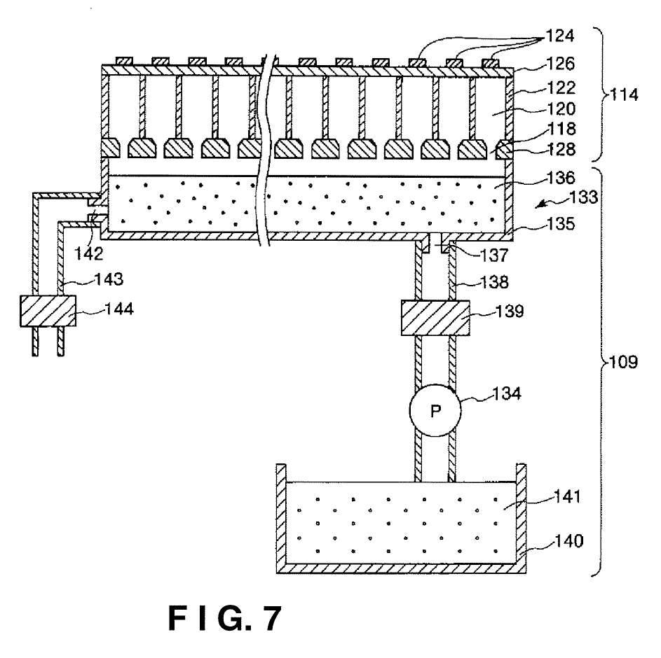

FIG. 2 is a cross-sectional view showing a method for manufacturing a color filter; FIG. 3 is a perspective view showing the droplet discharge device used in the manufacture of the color filter; FIG. 4 is a view of droplet discharge means in the droplet discharge device shown in FIG. 3, as seen from the stage side; FIG. 5 is a view showing the bottom surface of the droplet discharge head in the droplet discharge device shown in FIG. 3; FIG. 6 is a view showing the droplet discharge head in the droplet discharge device shown in FIG. 3, wherein FIG. 6(a) is a cross-sectional perspective view and FIG. 6(b) is a cross-sectional view; and FIG. 7 is a sectional view showing a portion of the cleaning mechanism in the droplet discharge device shown in FIG. 3.

The present embodiment has a substrate preparation step (1a) for preparing a substrate 11, a partition wall formation step (1b, 1c) for forming a partition wall 13 on the substrate 11, an ink application step (1d) for applying color filter ink 2 into an area surrounded by the partition wall 13 by using an inkjet method, and a colored portion formation step (1e) for forming solid colored portions 12 by removing liquid medium from the color filter ink 2 and curing the curable resin material, as shown in FIG. 2.

### Substrate Preparation Step

First, a substrate 11 is prepared (1a). It is preferred that the substrate 11 to be prepared in the present step undergo a washing treatment. The substrate 11 to be prepared in the present step may be washed by chemical treatment using a silane-coupling agent or the like, a plasma treatment, ion plating, sputtering, gas phase reaction, vacuum deposition, or another suitable washing treatment.

### Partition Wall Formation Step

Next, a radiation-sensitive composition is applied to substantially the entire surface of one of the surfaces of the substrate 11 to form (1b) a coated film 3. A prebaking treatment may be performed as required after the radiation-sensitive composition has been applied to the substrate 11. The prebaking treatment may be carried out under the conditions of, e.g., a heating temperature of 50 to 150° C. and a heating time of 30 to 600 seconds.

Next, a partition wall 13 is formed (1c) by irradiating the surface via a photomask, performing a post exposure bake (PEB), and carrying out a development treatment using an alkali development fluid. PEB can be carried out under the following example conditions: a heating temperature of 50 to 150° C., a heating time of 30 to 600 seconds, and a radiation intensity of 1 to 500 mJ/cm². The development treatment can be performed using, e.g., fluid overflow, dipping, vibration soaking, or another method, and the development treatment time can be set to 10 to 300 seconds, for example. After the development treatment, a post baking treatment may be performed as required. The post baking treatment can be carried out under the following example conditions: a heating temperature of 150 to 280° C. and a heating time of 3 to 120 minutes.

### Ink Application Step

Next, the color filter ink 2 is applied (1d) to the cells 14 surrounded by the partition wall 13 using the inkjet method.

The present step is carried out using a plurality of types of color filter inks 2 that correspond to the plurality of colors of the colored portions 12 to be formed. In this case, a partition wall 13 is provided, and mixing of two or more color filter inks 2 can therefore be reliably prevented.

The color filter ink 2 is discharged using a droplet discharge device such as that shown in FIGS. 3 to 7.

The droplet discharge device 100 used in the present step is provided with a tank 101 for holding the color filter ink 2, a tube 110, and a discharge scan unit 102 to which the color filter ink 2 is fed from the tank 101 via the tube 110, as shown in FIG. 3. The discharge scan unit 102 is provided with droplet discharge means 103 in which a plurality of droplet discharge heads (inkjet heads) 114 is mounted on a carriage 105, a first position controller 104 (movement means) for controlling the position of the droplet discharge means 103, a stage 106 for holding the substrate 11 (hereinafter simply referred to as “substrate 11”) on which the partition wall 13 is formed in an aforementioned step, a second position controller 108 (movement means) for controlling the position of the stage 106, a cleaning mechanism 109 for washing (cleaning) the droplet discharge head, and control means 1 12. The tank 101 and the plurality of droplet discharge heads 114 in the droplet discharge means 103 are connected by the tube 110, and the color filter ink 2 is fed by compressed air from the tank 101 to each of the plurality of droplet discharge heads 114.

The first position controller 104 moves the droplet discharge means 103 along the X-axis direction and Z-axis direction orthogonal to the X-axis direction, in accordance with a signal from the control means 112. The first position controller 104 also has a function for rotating the droplet discharge means 103 about the axis parallel to the Z-axis. In the present embodiment, the Z-axis direction is the direction parallel to the perpendicular direction (i.e., the direction of gravitational acceleration). The second position controller 108 moves the stage 106 along the Y-axis direction, which is orthogonal to both the X-axis direction and the Z-axis direction, in accordance with a signal from the control means 112. The second position controller 108 also has a function for rotating the stage 106 about the axis parallel to the Z-axis.

The stage 106 has a surface parallel to both the X-axis direction and the Y-axis direction. The stage 106 is configured so as to be capable of securing or holding the substrate 11 on the planar surface thereof, the substrate having the cells 14 in which the color filter ink 2 is to be applied.

As described above, the droplet discharge means 103 is moved in the X-axis direction by the first position controller 104. On the other hand, the stage 106 is moved in the Y-axis direction by the second position controller 108. In other words, the relative position of the droplet discharge heads 114 in relation to the stage 106 is changed by the first position controller 104 and the second position controller 108 (the substrate 11 held on the stage 106 and the droplet discharge means 103 move in a relative fashion).

The control means 112 is configured so as to receive from an external information processor discharge data that express the relative position in which the color filter ink 2 is to be discharged.

The droplet discharge means 103 has a plurality of droplet discharge heads 114, which have substantially the same structure as each other, and a carriage 105 for holding the droplet discharge heads 114, as shown in FIG. 4. In the present embodiment, the number of droplet discharge heads 114 held in the droplet discharge means 103 is eight. Each of the droplet discharge heads 114 has a bottom surface on which a plurality of later-described nozzles 118 is disposed. The shape of the bottom surface of each of the droplet discharge heads 114 is a polygon having two short sides and two long sides. The bottom surface of the droplet discharge heads 114 held in the droplet discharge means 103 faces the stage 106 side, and the long-side direction and the short-side direction of the droplet discharge heads 114 are parallel to the X-axis direction and the Y-axis direction, respectively.

The droplet discharge heads 114 have a plurality of nozzles 118 aligned in the X-axis direction, as shown in FIG. 5. The plurality of nozzles 118 is disposed so that a nozzle pitch HXP in the X-axis direction in the droplet discharge heads 114 has a prescribed value. The specific value of the nozzle pitch HXP is not particularly limited, but may be 50 to 90 μm, for example. In this case, “the nozzle pitch HXP in the X-axis direction in the droplet discharge heads 114” corresponds to the pitch between a plurality of nozzle images obtained by projecting all of the nozzles 118 in the droplet discharge heads 114 on the X axis along the Y-axis direction.

In the present embodiment, the plurality of nozzles 118 in the droplet discharge heads 114 forms a nozzle row 116A and a nozzle row 116B, both of which extend in the X-axis direction. The nozzle row 116A and the nozzle row 116B are disposed in parallel across an interval. In the present embodiment, 90 nozzles 118 are aligned in a row in the X-axis direction with a fixed interval LNP in each nozzle row 116A and nozzle row 116B. The specific value of LNP is not particularly limited, but may be 100 to 180 μm, for example.

The position of the nozzle row 116B is offset in the positive direction of the X-axis direction (the right-hand direction of FIG. 5) by half the length of the nozzle pitch LNP in relation to the position of the nozzle row 116A. For this reason, the nozzle pitch HXP in the X-axis direction of the droplet discharge heads 114 is half the length of the nozzle pitch LNP of the nozzle row 116A (or the nozzle row 116B).

Therefore, the nozzle line density in the X-axis direction of the droplet discharge heads 114 is twice the nozzle line density of the nozzle row 116A (or the nozzle row 116B). In the present specification, “the nozzle line density in the X-axis direction” corresponds to the number per unit length of the plurality of nozzle images obtained by projecting a plurality of nozzles on the X-axis along the Y-axis direction. Naturally, the number of nozzle rows included in the droplet discharge heads 114 is not limited to two rows. The droplet discharge heads 114 may include M number of nozzle rows. In this case, M is a natural number of 1 or higher. In this case, the plurality of nozzles 118 in each of the M number of nozzle rows is aligned at a pitch having a length that is M times that of the nozzle pitch HXP. In the case that M is a natural number of 2 or higher, another (M−1) number of nozzle rows are offset in the X-axis direction without overlapping, by a length i times that of the nozzle pitch HXP, in relation to a single nozzle row among the M number of nozzle rows. Here, i is a natural number from 1 to (M−1).

In the present embodiment, since the nozzle row 116A and the nozzle row 116B are each composed of 90 nozzles 118, a single droplet discharge head 114 has 180 nozzles 118. However, five nozzles at each end of the nozzle row 116A are set as “reserve nozzles.” Similarly, five nozzles at each end of the nozzle row 116B are set as “reserve nozzles.” The color filter ink 2 is not discharged from these 20 “reserve nozzles.” For this reason, 160 nozzles 118 among the 180 nozzles 118 in the droplet discharge heads 114 function as nozzles for discharging the color filter ink 2.

In the droplet discharge means 103, the plurality of droplet discharge heads 114 is disposed in two rows along the X-axis direction, as shown in FIG. 4. One of the rows of droplet discharge heads 114 and the other row of droplet discharge heads 114 are disposed so that a portion of the droplet discharge heads overlap as viewed from the Y-axis direction, with consideration given to the reserve nozzles. The nozzles 118 for discharging the color filter ink 2 are thereby configured so as to be continuous in the X-axis direction at the nozzle pitch HXP across the length of the dimension in the X-axis direction of the substrate 11 in the droplet discharge means 103.

In the droplet discharge means 103 of the present embodiment, the droplet discharge heads 114 are disposed so as to cover the entire length of the dimension in the X-axis direction of the substrate 11. However, the droplet discharge means in the present invention may cover a portion of the length of the dimension in the X-axis direction of the substrate 11.

As shown in FIGS. 6(a) and 6(b), each of the droplet discharge heads 114 is an inkjet head. More specifically, each of the droplet discharge heads 114 is provided with a vibration plate 126 and a nozzle plate 128. A fluid reservoir 129 in which the color filter ink 2 fed from the tank 101 via a hole 131 is constantly filled is positioned between the vibration plate 126 and the nozzle plate 128.

A plurality of partition walls 122 is disposed between the vibration plate 126 and the nozzle plate 128. The portions enclosed by the vibration plate 126, the nozzle plate 128, and a pair of partition walls 122 are cavities 120. Since the cavities 120 are disposed in correspondence with the nozzles 118, the number of cavities 120 and the number of nozzles 118 is the same. The color filter ink 2 is fed to the cavities 120 from the fluid reservoir 129 via supply ports 130 positioned between pairs of partition walls 122.

An oscillator 124 is positioned on the vibration plate 126 in correspondence with each of the cavities 120. The oscillator 124 includes a piezoelement 124C, and a pair of electrodes 124A, 124B that sandwich the piezoelement 124C. The color filter ink 2 is discharged from the corresponding nozzle 118 by applying a drive voltage between the pair of electrodes 124A, 124B. The shape of the nozzles 118 is adjusted so that the color filter ink 2 is discharged in the Z-axis direction from the nozzles 118.

The control means 112 (see FIG. 3) may be configured so as to independently apply signals to each of the plurality of oscillators 124. In other words, the volume of the color filter ink 2 discharged from the nozzles 118 can be controlled for each nozzle 118 in accordance with a signal from the control means 112. The control means 112 can also set the nozzles 118 that will perform a discharge operation during a coating scan, as well as the nozzles 118 that will not perform a discharge operation.

In the present specification, the portion that includes a single nozzle 118, a cavity 120 that corresponds to the nozzle 118, and the oscillator 124 that corresponds to the cavity 120 will be referred to as a “discharge portion 127”. In accordance with this is designation, a single droplet discharge head 114 has the same number of discharge portions 127 as the number of nozzles 118.

The droplet discharge device 100 is also provided with the cleaning mechanism 109.

The cleaning mechanism 109 is a mechanism for absorbing the color filter ink 2 remaining in the nozzles 118 and eliminating blockage of the nozzles. As shown in FIG. 7, the cleaning mechanism 109 is provided with a cap 133 for sealing the droplet discharge head 114, and a suction pump 134 for suctioning the color filter ink 2. The cleaning mechanism 109 is also provided with a number of caps 133 corresponding to the number of droplet discharge heads of the carriage 105.

The cap 133 is composed of a cap body 135 and an ink absorption body (liquid absorption body) 136 disposed inside the cap body 135. The cap body 135 is composed of silicone rubber or another elastic material, and is formed in a substantial box shape in which the upper side is open. The ink absorption body 136 is formed using a porous material and configured so as to absorb the color filter ink 2 discharged from the nozzles 118. Specifically, a polyethylene terephthalate nonwoven cloth having a color filter ink retention rate of 70 percent, for example, is used as the ink absorption body 136. The cap 133 can be moved vertically by a publicly known raising and lowering means not shown in the drawing, and when the cap 133 is raised, the cap 133 comes in contact with the droplet discharge head 114 and seals the nozzles 118 of the droplet discharge head 114.

A discharge hole 137 that passes through the suction pump 134 is formed so as to pass through the lower surface of the cap body 135. One end of a suction tube 138 is connected to the discharge hole 137. The suction tube 138 is a flow channel for suctioning the color filter ink 2 and the like, and the other end thereof extends into the waste fluid tank 140 via the suction pump 134. Furthermore, a suction valve 139 for opening and closing a communicated state with the suction pump 134 is provided to the suction tube 138. Consequently, when the suction pump 134 is operated in a state in which the suction valve 139 is open, a negative pressure occurs in the space formed by the droplet discharge head 114 and the cap body 135, and the thickened ink, the air bubbles, and the like inside the nozzles 118 are discharged into the cap body 135. The discharged color filter ink 2 is discharged to the waste fluid tank 140 via the ink absorption body 136 and the suction tube 138 by the suction pump 134, and absorbed into an absorption member 141.

An atmospheric opening hole 142 is also formed through a side surface of the cap body 135 in a position adequately distant from the discharge hole 137. One end of an opening tube 143 is connected to the atmospheric opening hole 142. The opening tube 143 is a flow channel for introducing air, and the other end thereof opens to the atmosphere. Furthermore, an opening valve 144 for opening the flow channel of the opening tube 143 is provided to the opening tube 143. Accordingly, when the opening valve 144 is opened, the inside of the cap 133 is communicated with the atmosphere, and the inside of the cap 133 is at atmospheric pressure. When the suction pump 134 is operated, the waste ink collects in the discharge hole 137 adequately distant from the atmospheric opening hole 142, and there is minimal waste ink around the atmospheric opening hole 142. The atmospheric opening hole 142 is provided to the side surface. Therefore, when the opening valve 144 is open, the air that flows into the cap body 135 flows primarily in the horizontal direction. Therefore, it is possible to reliably prevent the reduced-viscosity waste ink from being scattered by inflowing air and adhering to the droplet discharge head 114 when the flow channel of the opening tube 143 is opened after the suction pump is stopped. Since the atmospheric opening hole 142 is provided to the side surface of the cap body 135, the atmospheric opening hole 142 can be suitably prevented from being blocked by inflow of waste ink.

The cap 133 in the cleaning mechanism 132 functions as a lid for preventing drying of the nozzles 118, and when the droplet discharge device 100 is not being operated, the cap body 135 is maintained in a state of sealing the nozzles 118 of the droplet discharge head 114, as shown in FIG. 7. At this time, color filter ink 2 not discharged to the waste fluid tank 140 in the ink suctioned from the nozzles 118 is retained by the ink absorption body 136 after the cleaning operation. Drying of the nozzles 118 is prevented by the wet state maintained by the ink medium from the ink absorption body 135 in the space formed by the cap 133 and the droplet discharge head 114.

When conventional color filter ink is used, it is sometimes the case that the liquid medium evaporates from the color filter ink (waste ink) discharged to the ink absorption body during cleaning of the droplet discharge head using such a cleaning mechanism, the pigment aggregates and solidifies, and the viscosity increases. Mixing of different compositions of color filter ink causes the pigments and other components to aggregate and solidify particularly when cleaning is continued using a color filter ink of a different composition. Therefore, when the droplet discharge device is operated for a long time and cleaning is performed frequently, the color filter ink (waste ink) that has increased in viscosity and solidified is not removed by the suction, and the ink accumulates on the ink absorption body and forms a solid body (filter cake). Therefore, when this solid body is discharged on during cleaning, the discharged droplets impact the solid body and scatter, and the scattered droplets readily adhere in the vicinity of the nozzles of the droplet discharge head. The solid body and the droplet discharge head also sometimes come in contact with each other.

However, such problems can be prevented through the use of the color filter ink of the present invention. Specifically, even when the viscosity of the waste ink generated during cleaning has increased, the droplets discharged during the next cleaning can easily dissolve the dispersing agent in the waste ink. The dispersing agent dissolved in the liquid medium of the waste ink can therefore suitably re-disperse the aggregated pigment and other components. As a result, the waste ink can be prevented from increasing in viscosity and solidifying, and the waste ink can be suitably removed from the ink absorption body 136. By suitably removing the waste ink in this manner, solid bodies (filter cakes) can be prevented from forming, droplets that ricochet during cleaning can be prevented from adhering to the droplet discharge head 114, and contact between the droplet discharge head 114 and the solid body can be prevented. The droplet discharge device 100 can therefore operate stably for long periods of time, defects and unevenness of color and saturation between regions is suppressed in the manufactured color filter 1, and excellent uniformity of characteristics between units is obtained. Such effects as those described above are made more significant particularly by a configuration in which the color filter ink set such as described above is composed of the color filter ink of the present invention and a color filter ink that includes a liquid B and a dispersing agent that satisfy the solubility parameter relationship such as described above.

The color filter ink 2 corresponding to the plurality of colored portions 12 of the color filter 1 is applied to the cells 14 using such a droplet discharge device 100. The color filter ink 2 can be selectively applied with good efficiency in the cells 14 by using such a device. In the configuration of the diagrams, the droplet discharge device 100 has a tank 101 for holding the color filter ink 2, a tube 110, and other components for only one color, but these members may have a plurality of colors the correspond to the plurality of colored portions 12 of the color filter 1. Also, in the manufacture of the color filter 1, a plurality of droplet discharge devices 100 corresponding to a plurality of color filter inks 2 may be used.

In the present invention, the droplet discharge heads 114 may use an electrostatic actuator in place of the piezoelement as the drive element. The droplet discharge heads 114 may have a configuration in which an electrothermal converter is used and color filter ink is discharged using the thermal expansion of material produced by an electrothermal converter.

### Colored Portion Formation Step (Curing Step)

Next, the liquid medium is removed from the color filter ink 2 in the cells 14, and solid colored portions 12 are formed by curing the curable resin material (1e). The color filter 1 is obtained in this manner.

The present step, heating is ordinarily carried out, but in the present step, for example, treatments involving irradiation of active energy rays, treatments in which the substrate 11 to which the color filter ink 2 has been applied is placed under a reduced-pressure environment, and other treatments may also be performed. The curing reaction of the curable resin material can be made to proceed with good efficiency by irradiating active energy rays; the curing reaction of the curable resin material can be reliably promoted even when the heating temperature is relatively low; the occurrence of adverse effects on the substrate 11 and other components can reliably prevented; and other effects can be obtained. Examples of the active energy rays that may be used include light rays of various wavelengths, e.g., UV rays, X-rays, g-rays, i-rays, and excimer lasers. The substrate 11 on which the color filter ink 2 has been applied can be placed under a reduced-pressure environment, whereby the liquid medium can be removed with good efficiency, the shape of the colored portions in the pixels (cells) can be reliably made into good preferred shapes, the liquid medium can be reliably removed even when the heating temperature is relatively low, the occurrence of adverse effects on the substrate 11 and the like can be reliably prevented, and other effects can be obtained.

The heating temperature in the present step is not particularly limited, but 50 to 260° C. is preferred, and 80 to 240° C. is even more preferred.

### Image Display Device

Preferred embodiments of the liquid crystal display device, which is an image display device (electrooptic device) having the color filter 1, will next be described.

FIG. 7 is a cross-sectional view showing a preferred embodiment of the liquid crystal display device. As shown in the diagram, the liquid crystal display device 60 has a color filter 1, a substrate (opposing substrate) 66 arranged on the surface on which the colored portions 12 of the color filter 1 are disposed, a liquid crystal layer 62 composed of a liquid crystal sealed in the gaps between the color filter I and the substrate 66, a polarizing plate 67 disposed on the surface (lower side in FIG. 7) opposite from the surface that faces the liquid crystal layer 62 of the substrate 11 of the color filter 1, and a polarizing plate 68 disposed on the side (upper side in FIG. 7) opposite from the surface that faces liquid crystal layer 62 of the substrate 66. A shared electrode 61 is disposed on the surface (the surface opposite from the surface facing the substrate 11 of the colored portions 12 and the partition wall 13) on which the colored portions 12 and the partition wall 13 of the color filter 1 are disposed. Pixel electrodes 65 are disposed in the form of a matrix in positions that correspond to the colored portions 12 of the color filter 1 on the substrate (opposing substrate) 66, facing the liquid crystal layer 62 and color filter 1. An alignment film 64 is disposed between the shared electrode 61 and the liquid crystal layer 62, and an alignment film 63 is disposed between the substrate 66 (pixel electrodes 65) and the liquid crystal layer 62.

The substrate 66 is a substrate having optical transparency with respect to visible light, and is a glass substrate, for example.

The shared electrode 61 and the pixel electrodes 65 are composed of a material having optical transparency with respect to visible light, and are ITO or the like, for example.

Although not depicted in the diagram, a plurality of switching elements (e.g., TFT: thin film transistors) is disposed so as to correspond to the pixel electrodes 65. The pixel electrodes 65 corresponding to the colored portions 12 can be used to control the transmission properties of light in areas that correspond to the colored portions 12 (pixel electrodes 65) by controlling the state of the voltage applied between the shared electrode 61 and the pixel electrodes.

In the liquid crystal display device 60, light emitted from the backlight, which is not depicted, is incident from the polarizing plate 68 side (the upper side in FIG. 7). The light that passes through the liquid crystal layer 62 and enters the colored portions 12 (12A, 12B, 12C) of the color filter 1 is emitted from the polarizing plate 67 (lower side of FIG. 7) as light having a color that corresponds to the colored portions 12 (12A, 12B, 12C).

As described above, the colored portions 12 are formed using the color filter ink 2 (ink set) of the present invention and therefore have reduced variability in the characteristics between pixels. As a result, an image having reduced unevenness of color and saturation, and the like can be stably displayed in the liquid crystal display device 60. Since the colored portions 12 are formed using the color filter ink of the present invention, adequately high contrast and color saturation are also obtained.

### Electronic Device

A liquid crystal display device or another image display device (electrooptic device) 1000 having a color filter 1 such as that described above can be used in a display unit of a variety of electronic equipment.

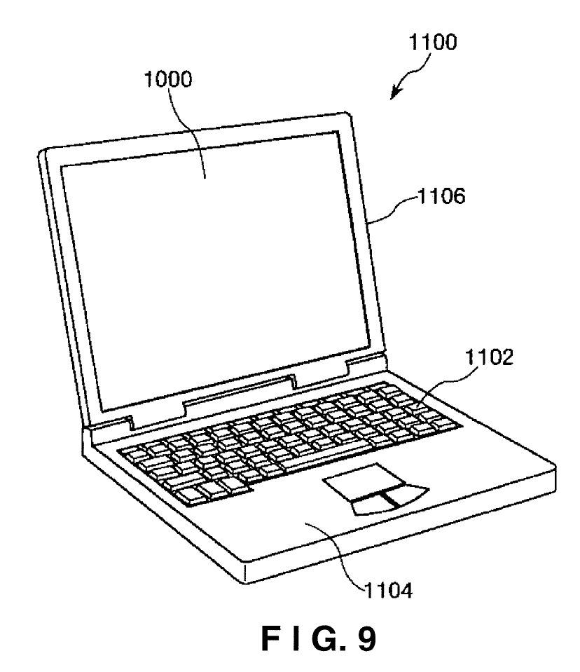

FIG. 9 is a perspective view showing the configuration of a mobile (or notebook) personal computer to which the electronic equipment of the present invention has been applied.

In the diagram, a personal computer 1100 is composed of a main unit 1104 provided with a keyboard 1102, and a display unit 1106. The display unit 1106 is rotatably supported by the main unit 1104 via a hinge structure.

In the personal computer 1100, the display unit 1106 is provided with an image display device 1000.

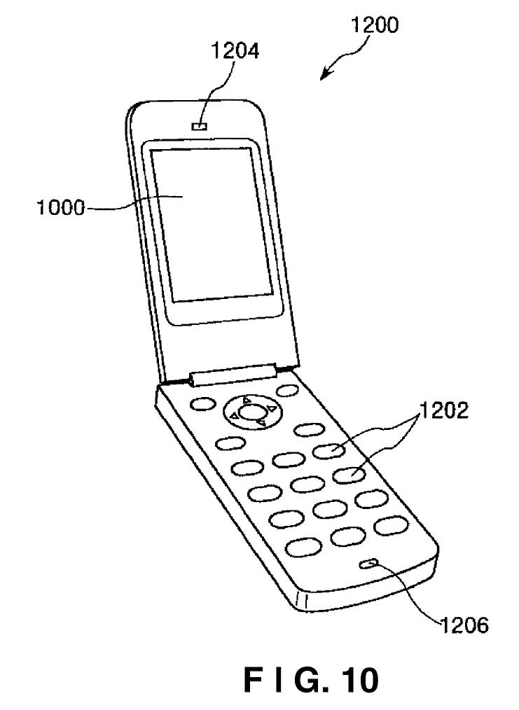

FIG. 10 is a perspective view showing the configuration of a portable telephone (including PHS) to which the electronic device of the present invention has been applied.

In the diagram, the portable telephone 1200 has a plurality of operating buttons 1202, an earpiece 1204, and a mouthpiece 1206, as well as an image display device 1000 provided to the display unit.

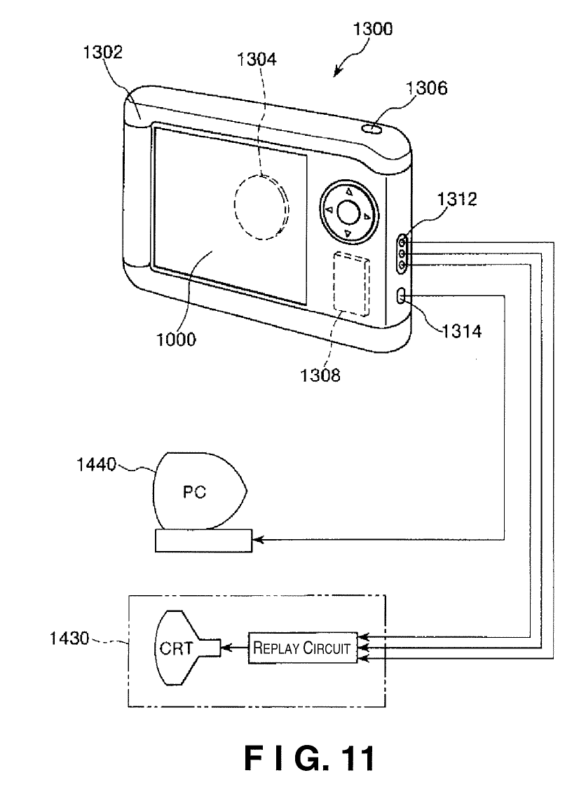

FIG. 11 is a perspective view showing the configuration of a digital still camera in which the electronic device of the present invention has been applied. In the diagram, connection to external apparatuses is displayed in a simplified manner.

In this case, an ordinary camera exposes a silver-salt photography film to the optical image of a photographed object, but in contrast, a digital still camera 1300 photoelectrically converts the optical image of a photographed image and generates an imaging signal (image signal) with the aid of a CCD (Charge Coupled Device) or another imaging element.

An image display device 1000 is disposed in the display portion on the back surface of a case (body) 1302 in the digital still camera 1300, is configured to perform display operation on the basis of a pickup signal from the CCD, and functions as a finder for displaying the photographed object as an electronic image.

A circuit board 1308 is disposed inside the case. The circuit board 1308 has a memory that can store (record) the imaging signal.

A photo-detection unit 1304 that includes an optical lens (imaging optical system), a CCD, and the like is disposed on the front surface side (back surface side in the configuration of the diagram) of the case 1302.

A photographer confirms the image of the object to be photographed displayed on the display unit, and the imaging signal of the CCD when a shutter button 1306 is pressed is transferred and stored in the memory of the circuit board 1308.

In the digital still camera 1300, a video signal output terminal 1312 and a data communication 1/O terminal 1314 are disposed on the side surface of the case 1302. A television monitor 1430 is connected to the video signal output terminal 1312 as required, and a personal computer 1440 is connected to the data communication I/O terminal 1314 as required, as shown in the diagram. An imaging signal stored in the memory of the circuit board 1308 is configured to be outputted by a prescribed operation to the television monitor 1430 and the personal computer 1440.

The electronic device of the present invention may be applied to the above-described personal computer (mobile personal computer), portable telephone, and digital still camera, and other examples include televisions (e.g., liquid crystal display devices), video cameras, view finder-type and direct-view monitor-type video tape recorders, laptop personal computers, car navigation devices, pagers, electronic assistants (including those with a communication function), electronic dictionaries, calculators, electronic game devices, word processors, work stations, videophones, security television monitors, electronic binoculars, POS terminals, apparatuses having a touch panel (e.g., cash dispensers for financial institutions, and automatic ticketing machines), medical equipment (e.g., electronic thermometers, sphygmomanometers, blood glucose sensors, electrocardiograph display devices, ultrasound diagnostic devices, and endoscopic display devices), fish finders, various measuring apparatuses, instruments (e.g., instruments in vehicles, aircraft, and ships), flight simulators, and various other monitors, and projectors, and other projection display devices. Among these, televisions have display units that are tending to become markedly larger in recent years, but in electronic devices having such a large display unit (e.g., a display unit having a diagonal length of 80 cm or more), unevenness of color and saturation, and other problems particularly readily occur when a color filter manufactured using a conventional color filter ink set is used. However, in accordance with the present invention, the occurrence of such problems can be reliably prevented. In other words, the effect of the present invention is more markedly demonstrated when application is made to an electronic device having a large display unit such as that described above.

The present invention above was described based on preferred embodiments, but the present invention is not limited to these embodiments.

For example, in the embodiments described above, color filter ink corresponding to the colored portions of various colors was applied inside the cells, the solvent (dispersion medium) was thereafter removed in a single process from the color filter ink of each color in the cells, and the resin material was cured. In other words, a process was described in which the colored portion formation step (curing step) was carried out a single time, but the ink application step and the colored portion formation step may be repeated for each color.

It is also possible to substitute or to add as another configuration the parts constituting a color filter, image display device, and electronic device with any part that demonstrates the same function. For example, in the color filter of the present invention, a protective film for covering the colored portions may be provided to the surface opposite from the surface facing the substrate of the colored portions. Damage, degradation, and the like of the colored portions can thereby be more effectively prevented.

The color filter ink of the present invention may be manufactured by any method, and is not limited to being manufacture using a method such as described above. For example, the manufacturing method was described in the embodiment as having a preparatory dispersion step and a multi-stage fine dispersion step, but the color filter ink of the present invention may be manufactured by a method that does not have a preparatory dispersion step, or a method that has a fine dispersion step that is not multi-stage. A thermoplastic resin was also described as being used in the preparatory dispersion step in the embodiment, but a curable resin material, e.g., the aforementioned polymer A and polymer B, may also be used in the preparatory dispersion step. More of the curable resin material can thereby be included in the color filter, and the color filter can be provided with particularly excellent durability.

In the embodiments described above, the case in which an ink set for a color filter is provided with three types (three colors) of color filter inks corresponding to the three primary colors of light was mainly described, but the number and type (color) of color filter inks constituting the ink set for a color filter is not limited to the arrangement described above. For example, in the present invention, the ink set for a color filter may be one provided with four or more types of color filter inks.

### EXAMPLES

Next, specific examples of the present invention will be described.

### 1. Synthesis of Polymer (Preparation of Polymer Solution )

### Synthesis Example 1

As the medium (solvent), 37.6 parts by weight of diethylene glycol butyl ether acetate was placed in a 1-L reaction container provided with an agitator, a reflux condenser, a dropping funnel, a nitrogen introduction tube, and a temperature gauge, and heated to 90° C. Next, 2 parts by weight of 2,2′-azobis(isobutyronitrile) (AIBN) and 3 parts by weight diethylene glycol butyl ether acetate (medium) were added, and a solution in which 27 parts by weight of (3,4-epoxy cyclohexyl) methyl methacrylate (product name: Cyclomer M100, manufactured by Daicel Chemical Industries), 1.5 parts by weight of 2-(0-[1′-methylpropylideneamino]carboxyamino)methacrylate (product name: MOI-BM, manufactured by Showa Denko), and 1.5 parts by weight of 2-hydroxyethyl methacrylate (HEMA) were admixed was dropped over about 4 hours using a dropping pump. Also, a solution (polymerization initiator solution) in which 5 parts by weight of dimethyl 2,2′-azobis(isobutyrate) (product name V-601, manufactured by Wako Pure Chemical Industries) as the polymerization initiator were dissolved in 20 parts by weight of diethylene glycol butyl ether acetate (medium) was dropped over about 4 hours using a separate dropping pump. After the dropping of the polymerization initiator solution was completed, 0.2 part by weight of AIBN and 1 part by weight of diethylene glycol butyl ether acetate (medium) was added and held for about 2 hours at about the same temperature, after which 0.2 part by weight of AIBN and 1 part by weight of diethylene glycol butyl ether acetate (medium) was added and held for about 2 hours at about the same temperature, and then cooled to room temperature to obtain a polymer solution Al containing a polymer A and having a solid content of 30 wt %.

### Synthesis Examples 2 to 12

The same operation as synthesis example 1 described above was carried out, except that the type of monomer components, usage amount, and type of medium (solvent) used in the synthesis of the polymer (preparation of the polymer solution) were varied in the manner shown in Table 1. As a result, eleven polymer solutions (polymer solutions A2 to A11) containing a polymer A and having a solid content of 30 wt % were obtained.

### Synthesis Example 13

The same operation as synthesis example 1 described above was carried out, except that 30 parts by weight of y-methacryloxypropyl trimethoxysilane (product name: SZ6030, manufactured by Dow Corning Toray) was used in place of (3,4-epoxy cyclohexyl) methyl methacrylate (product name: Cyclomer M100, manufactured by Daicel Chemical Industries), 2-(0-[1′-methylpropylideneamino]carboxyamino)methacrylate (product name: MOI-BM, manufactured by Showa Denko), and 2-hydroxyethyl methacrylate (HEMA). As a result, a polymer solution B 1 (homopolymer solution) containing a polymer B and having a solid content of 30 wt % was obtained.

### Synthesis Examples 14 to 19

The same operation as synthesis example 13 described above was carried out, except that the type of monomer components, usage amount, and type of medium (solvent) used in the synthesis of the polymer (preparation of the polymer solution) were varied in the manner shown in Table 2. As a result, six polymer solutions (polymer solutions B2 to B7) containing a polymer B and having a solid content of 30 wt % were obtained.

### Synthesis Example 20

The same operation as synthesis example 1 described above was carried out, except that 30 parts by weight of 1H,1H,5H-octafluoropentyl methacrylate (product name: Biscoat 8FM, manufactured by Osaka Organic Chemical Industry) was used in place of (3,4-epoxy cyclohexyl)methyl methacrylate (product name: Cyclomer M100, manufactured by Daicel Chemical Industries), 2-(0-[1′-methylpropylideneamino]carboxyamino)methacrylate (product name: MOI-BM, manufactured by Showa Denko), and 2-hydroxyethyl methacrylate (HEMA). As a result, a polymer solution Cl (homopolymer solution) containing a polymer C and having a solid content of 30 wt % was obtained.

### Synthesis Examples 21 and 22

The same operation as synthesis example 20 described above was carried out, except that the type of monomer components, usage amount, and type of medium (solvent) used in the synthesis of the polymer (preparation of the polymer solution) were varied in the manner shown in Table 2. As a result, two polymer solutions (polymer solutions C2 and C3) containing a polymer C and having a solid content of 30 wt % were obtained.

### Synthesis Example 23

The same operation as synthesis example 1 described above was carried out, except that 13.5 parts by weight of (3,4-epoxy cyclohexyl) methyl methacrylate (product name: Cyclomer M100, manufactured by Daicel Chemical Industries), 0.75 part by weight of 2-(0-[1′-methylpropylideneamino]carboxyamino)methacrylate (product name: MOI-BM, manufactured by Showa Denko), 0.75 part by weight of 2-hydroxyethyl methacrylate (HEMA), and 15 parts by weight of y-methacryloxypropyl trimethoxysilane (product name: SZ6030, manufactured by Dow Corning Toray) were used. As a result, a polymer solution X1 containing a polymer X and having a solid content of 30 wt % was obtained.

The type of material and usage amount (composition of the polymer synthesized in synthesis examples 1 to 23) used in the synthesis of the polymers (preparation of the polymer solutions) in the synthesis example 1 to 23 are summarized in Tables 1 and 2. In the tables, “S” refers to a medium (solvent), and more particularly “S1” refers to diethylene glycol butyl ether acetate, “S2” refers to 2-(2-methoxy-1-methylethoxy)-1-methyl ethyl acetate, “S3” refers to ethyl octanoate, “S4” refers to ethylene glycol butyl methyl ether, “S5” refers to ethylene glycol diacetate, “S6” refers to polyethylene glycol monomethyl ether, and “S7” refers to 3-methoxy butyl acetate. Also, “V-601” refers to dimethyl 2,2′-azobis(isobutyrate), “AIBN” refers to 2,2′-azobis(isobutyronitrile), “al-1” refers to (3,4-epoxy cyclohexyl) methyl methacrylate (Cyclomer M100), “a1-2” refers to (3,4-epoxycyclohexyl)methyl acrylate, “a2-1” refers to 2-(0-[1′-methylpropylideneamino]carboxyamino)ethyl methacrylate (MOI-BM), “a2-2” refers to 2-acryloyloxyethyl isocyanate (product name: “Karenz MOI”, manufactured by Showa Denko), “a3-1” refers to 2-hydroxyethyl methacrylate (HEMA), “a3-2” refers to 4-hydroxybutyl acrylate, “a4-1” refers to 1H,1H,5H-octafluoropentyl methacrylate (Biscoat 8FM), “a4-2” refers to 2-ethylhexyl methacrylate, “b1-1” refers to y-methacryloxypropyl trimethoxysilane (SZ6030), “b 1-2” refers to -methacryloxypropyl triethoxysilane, “b2-1” refers to ethyl methacrylate, “c1-1” refers to 1H,1H,5H-octafluoropentyl methacrylate (Biscoat 8FM), “c1-2” refers to 1,2,3,4,5-pentafluorostyrene, “c2-1” refers to 2,3-dihydroxybutyl methacrylate, and “c2-2” refers to cyclohexyl methacrylate. Also shown in the table are the weight-average molecular weights Mw of the polymers that constitute the polymer solutions.

TABLE 1

| | COMPONENTS (PARTS BY WEIGHT) | | | | | | | | | | | | | | | | | | | |
|---|---|---|---|---|---|---|---|---|---|---|---|---|---|---|---|---|---|---|---|---|
| | MONOMER COMPONENT | | | | | | | | | | | | | | | | | | | |
| | | | a2- | a2- | a3- | a3- | a4- | a4- | b1- | b1- | b2- | c1- | c1- | c2- | c2- | | | | MEDIUM (S) | POLYMER |
| | a1-1 | a1-2 | 1 | 2 | 1 | 2 | 1 | 2 | 1 | 2 | 1 | 1 | 2 | 1 | 2 | S | V-601 | AIBN | COMPOSITION | Mw |
| POLYMER | 27 | — | 1.5 | — | 1.5 | — | — | — | — | — | — | — | — | — | — | 62.6 | 5 | 2.4 | S1 | 2700 |
| SOLUTION | | | | | | | | | | | | | | | | | | | | |
| A1 | | | | | | | | | | | | | | | | | | | | |
| POLYMER | 27 | — | 1.5 | — | 1.5 | — | — | — | — | — | — | — | — | — | — | 62.6 | 5 | 2.4 | S2 | 2800 |
| SOLUTION | | | | | | | | | | | | | | | | | | | | |
| A2 | | | | | | | | | | | | | | | | | | | | |
| POLYMER | 26.5 | — | 2 | — | 1.5 | — | — | — | — | — | — | — | — | — | — | 62.6 | 5 | 2.4 | S3 | 2800 |
| SOLUTION | | | | | | | | | | | | | | | | | | | | |
| A3 | | | | | | | | | | | | | | | | | | | | |
| POLYMER | 26.5 | — | 2 | — | 1.5 | — | — | — | — | — | — | — | — | — | — | 62.6 | 5 | 2.4 | S4 | 2800 |
| SOLUTION | | | | | | | | | | | | | | | | | | | | |
| A4 | | | | | | | | | | | | | | | | | | | | |
| POLYMER | 19 | — | 5 | — | 4.5 | — | 1.5 | — | — | — | — | — | — | — | — | 62.6 | 5 | 2.4 | S5 | 2700 |
| SOLUTION | | | | | | | | | | | | | | | | | | | | |
| A5 | | | | | | | | | | | | | | | | | | | | |
| POLYMER | 27 | — | 1.5 | — | 1.5 | — | — | — | — | — | — | — | — | — | — | 62.6 | 5 | 2.4 | S6 | 2700 |
| SOLUTION | | | | | | | | | | | | | | | | | | | | |
| A6 | | | | | | | | | | | | | | | | | | | | |
| POLYMER | 27 | — | 1.5 | — | 1.5 | — | — | — | — | — | — | — | — | — | — | 62.6 | 5 | 2.4 | S7 | 2800 |
| SOLUTION | | | | | | | | | | | | | | | | | | | | |
| A7 | | | | | | | | | | | | | | | | | | | | |
| POLYMER | — | 27.5 | — | 1.5 | — | 1 | — | — | — | — | — | — | — | — | — | 62.6 | 5 | 2.4 | S1 | 2800 |
| SOLUTION | | | | | | | | | | | | | | | | | | | | |
| A8 | | | | | | | | | | | | | | | | | | | | |
| POLYMER | 26 | — | 1 | — | 3 | — | — | — | — | — | — | — | — | — | — | 62.6 | 5 | 2.4 | S1 | 2800 |
| SOLUTION | | | | | | | | | | | | | | | | | | | | |
| A9 | | | | | | | | | | | | | | | | | | | | |
| POLYMER | 27 | — | 3 | — | — | — | — | — | — | — | — | — | — | — | — | 62.6 | 5 | 2.4 | S1 | 2800 |
| SOLUTION | | | | | | | | | | | | | | | | | | | | |
| A10 | | | | | | | | | | | | | | | | | | | | |
| POLYMER | 24 | — | 3 | — | — | — | 3 | — | — | — | — | — | — | — | — | 62.6 | 5 | 2.4 | S2 | 2700 |
| SOLUTION | | | | | | | | | | | | | | | | | | | | |
| A11 | | | | | | | | | | | | | | | | | | | | |

TABLE 2

| | COMPONENTS (PARTS BY WEIGHT) | | | | | | | | | | | | | | | | | | | |
|---|---|---|---|---|---|---|---|---|---|---|---|---|---|---|---|---|---|---|---|---|
| | MONOMER COMPONENT | | | | | | | | | | | | | | | | | | | |
| | | a1- | | a2- | | a3- | a4- | a4- | b1- | b1- | b2- | c1- | c1- | c2- | c2- | | V- | | MEDIUM (S) | POLYMER |
| | a1-1 | 2 | a2-1 | 2 | a3-1 | 2 | 1 | 2 | 1 | 2 | 1 | 1 | 2 | 1 | 2 | S | 601 | AIBN | COMPOSITION | Mw |
| POLYMER | — | — | — | — | — | — | — | — | 30 | — | — | — | — | — | — | 62.6 | 5 | 2.4 | S1 | 2800 |
| SOLUTION | | | | | | | | | | | | | | | | | | | | |
| B1 | | | | | | | | | | | | | | | | | | | | |
| POLYMER | — | — | — | — | — | — | — | — | 26 | — | 4 | — | — | — | — | 62.6 | 5 | 2.4 | S2 | 2700 |
| SOLUTION | | | | | | | | | | | | | | | | | | | | |
| B2 | | | | | | | | | | | | | | | | | | | | |
| POLYMER | — | — | — | — | — | — | — | — | 23 | — | 7 | — | — | — | — | 62.6 | 5 | 2.4 | S3 | 2700 |
| SOLUTION | | | | | | | | | | | | | | | | | | | | |
| B3 | | | | | | | | | | | | | | | | | | | | |
| POLYMER | — | — | — | — | — | — | — | — | — | 30 | — | — | — | — | — | 62.6 | 5 | 2.4 | S4 | 2800 |
| SOLUTION | | | | | | | | | | | | | | | | | | | | |
| B4 | | | | | | | | | | | | | | | | | | | | |
| POLYMER | — | — | — | — | — | — | — | — | — | 28 | 2 | — | — | — | — | 62.6 | 5 | 2.4 | S5 | 2800 |
| SOLUTION | | | | | | | | | | | | | | | | | | | | |
| B5 | | | | | | | | | | | | | | | | | | | | |
| POLYMER | — | — | — | — | — | — | — | — | 30 | — | — | — | — | — | — | 62.6 | 5 | 2.4 | S6 | 2800 |
| SOLUTION | | | | | | | | | | | | | | | | | | | | |
| B6 | | | | | | | | | | | | | | | | | | | | |
| POLYMER | — | — | — | — | — | — | — | — | 30 | — | — | — | — | — | — | 62.6 | 5 | 2.4 | S7 | 2800 |
| SOLUTION | | | | | | | | | | | | | | | | | | | | |
| B7 | | | | | | | | | | | | | | | | | | | | |
| POLYMER | — | — | — | — | — | — | — | — | — | — | — | 30 | — | — | — | 62.6 | 5 | 2.4 | S1 | 2800 |
| SOLUTION | | | | | | | | | | | | | | | | | | | | |
| C1 | | | | | | | | | | | | | | | | | | | | |
| POLYMER | — | — | — | — | — | — | — | — | — | — | — | 4 | — | 26 | — | 62.6 | 5 | 2.4 | S2 | 2800 |
| SOLUTION | | | | | | | | | | | | | | | | | | | | |
| C2 | | | | | | | | | | | | | | | | | | | | |
| POLYMER | — | — | — | — | — | — | — | — | — | — | — | — | 28 | — | 2 | 62.6 | 5 | 2.4 | S3 | 2800 |
| SOLUTION | | | | | | | | | | | | | | | | | | | | |
| C3 | | | | | | | | | | | | | | | | | | | | |
| POLYMER | 13.5 | — | 0.75 | — | 0.75 | — | — | — | 15 | — | — | — | — | — | — | 62.6 | 5 | 2.4 | S1 | 2700 |
| SOLUTION | | | | | | | | | | | | | | | | | | | | |
| X1 | | | | | | | | | | | | | | | | | | | | |

### 2. Preparation of Color Filter Ink (Color Filter Ink Set)

### Example 1

Added to an agitator (single-shaft mixer) having a capacity of 400 cc were 18.60 g (52.0 parts by weight) of Disperbyk 161 as a dispersing agent, 25.91 g (72 parts by weight) of SPCN-17X (manufactured by Showa Highpolymer) as a thermoplastic resin, 61.90 g (172 parts by weight) of diethylene glycol butyl ether acetate (liquid A) as a liquid medium, and 10.90 g (30 parts by weight) of 1,3-butylene glycol diacetate (liquid B), and a dispersing-agent-dispersed liquid was obtained by stirring the mixture for 3 minutes in a Dispermill and performing preparatory dispersion (preparatory dispersion step). The speed of the stirring vanes of the agitator at this time was set to 2500 rpm.

Pigments were then added as described below to the dispersing-agent-dispersed liquid obtained by the preparatory dispersion step, inorganic beads were added in multiple stages, and the fine dispersion step of performing the fine dispersion process was performed.

First, 35.99 g (100 parts by weight) of pigments were added to the obtained dispersing-agent-dispersed liquid, and the mixture was stirred for 10 minutes. At this time, the speed of the stirring vanes of the agitator was set to 2000 rpm. The mixture used as the pigments included 32.39 g of a halogenated phthalocyanine zinc complex (main pigment) having the chemical structure (wherein two of the 16 X units in the molecule were hydrogen atoms, four were chlorine atoms, and ten were bromine atoms) indicated by Formula (3) below, and 3.60 g of powered sulfonated pigment derivative (secondary pigment) having the chemical structure indicated by Formula (5). At this time, the mixture of the pigments and the dispersing-agent-dispersed liquid was diluted by diethylene glycol butyl ether acetate (liquid A) and 1,3-butylene glycol diacetate (liquid B) as dispersion mediums to give a pigment content ratio of 17 wt %.

Formula (3)

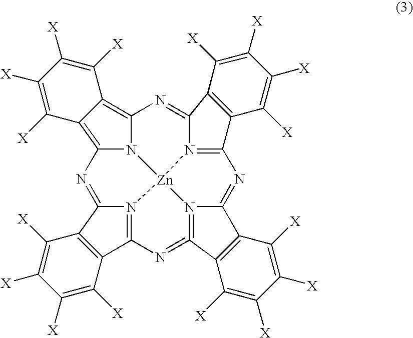

In Formula (3), X are each independently a hydrogen atom (H), a chlorine atom (Cl), or a bromine atom (Br), wherein the number of H atoms in each molecule is 0 to 4, the number of Cl atoms is 0 to 8, and the number of Br atoms is 4 to 16.

Formula (5)

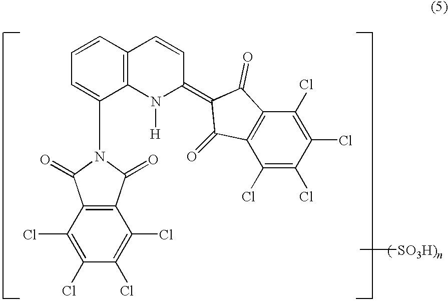

In Formula (5), n is an integer from 1 to 5.

Inorganic beads (first inorganic beads: zirconia beads; “Toray Ceram milling balls” (trade name); manufactured by Toray) having an average grain size of 0.8 mm were then added, the mixture was stirred for 35 minutes at room temperature, and the first stage of dispersion processing (first treatment) was performed. At this time, the speed of the stirring vanes of the agitator was set to 1700 rpm.

The inorganic beads (first inorganic beads) were then removed by filtration using a filter (“PALL HDCII Membrane Filter”; manufactured by PALL), after which inorganic beads (second inorganic beads: zirconia beads; “Toray Ceram grinding balls” (trade name); manufactured by Toray) having an average grain size of 0.1 mm were added, the mixture was further stirred for 20 minutes, and the second stage of dispersion processing (second treatment) was performed. At this time, the speed of the stirring vanes of the agitator was set to 2500 rpm. The mixture was also diluted at this time by diethylene glycol butyl ether acetate (liquid A) and 1,3-butylene glycol diacetate (liquid B) as dispersion mediums to give a pigment content ratio of 14 wt % in the obtained pigment dispersion.

The inorganic beads (second inorganic beads) were then removed by filtration using a filter (“PALL HDCII Membrane Filter”; manufactured by PALL), and a pigment dispersion was obtained.

The pigment dispersion obtained as described above, a polymer solution A1, and a polymer solution B 1 were then mixed. The present step was performed by placing the abovementioned pigment dispersion, polymer solution A1, polymer solution B1, diethylene glycol butyl ether acetate (liquid A), and 1,3-butylene glycol diacetate (liquid B) in a 400 cc agitator (single-shaft mixer) and stirring the mixture for 25 minutes in a Dispermill. At this time, the speed of the stirring vanes of the agitator was set to 2000 rpm. The desired green color filter ink (G ink) was thereby obtained. The pigment content ratio of the R ink at this time was 10.1 wt %.

A red color filter ink (R ink) and a blue color filter ink (B ink) were prepared in the same manner as the red color filter ink described above, except that the type of pigment and the usage amount of each component were varied. An ink set composed of the three colors R, G, B was thereby obtained. The average grain size of the pigment constituting the R ink, the average grain size of the pigment constituting the G ink, and the average grain size of the pigment constituting the B ink were 70 nm, 70 nm, and 70 nm, respectively. Also, C. I. Pigment Red 254 was used as the R ink pigment, and the content ratio of pigment in the final R ink was 7.3 wt %. Also, C. I. Pigment Blue 15:6 was used as the pigment of the B ink, and the content ratio of pigment in the final B ink was 4.9 wt %. The content ratio of the liquid B in the final B ink and R ink was adjusted to 7 to 15 wt %.

### Examples 2 Through 12

Color filter inks (ink set) were prepared in the same manner as Example 1, except that the composition of the color filter inks and the processing conditions of the fine dispersion step (first treatment, second treatment) and the curable resin mixing step were varied as shown in Tables 3, 4, and 5.

### Example 13

A color filter ink (ink set) was prepared in the same manner as Example 1, except that the composition of the color filter ink and the processing conditions of the fine dispersion step (first treatment, second treatment) and the curable resin mixing step were varied as shown in Tables 3, 4, and 5. However, the liquid B was not used in the R ink and B ink, and only the liquid A was used as a liquid medium.

### Comparative Examples 1 Through 9

Color filter inks (ink set) were prepared in the same manner as Example 1, except that the composition of the color filter inks and the processing conditions of the fine dispersion step (first treatment, second treatment) and the curable resin mixing step were varied as shown in Tables 3, 4, and 5.

Tables 3 and 4 show the composition of the green color filter ink obtained in the working examples and comparative examples. Table 4 also shows the viscosity of the obtained green color filter ink, and the stability evaluation of the color filter ink in section 3 described hereinafter. In the tables, the powder composed of the halogenated phthalocyanine zinc complex (wherein two of the 16 X units in the molecule are hydrogen atoms, four are chlorine atoms, and ten are bromine atoms) indicated by Formula (3) is referred to as “HPZC1,” the powder composed of the halogenated phthalocyanine zinc complex (wherein one of the 16 X units in the molecule is a hydrogen atom, three are chlorine atoms, and twelve are bromine atoms) indicated by Formula (3) is referred to as “HPZC2,” the powder composed of the pigment derivative indicated by Formula (5) is referred to as “SPD I,” the powder composed of the pigment derivative indicated by Formula (10) is referred to as “SPD2,” and C. I. Pigment Green 36 is referred to as “PG36.” In the curable resin material column in Tables 3 and 4, the polymer included in the polymer solution A1 is indicated as A1. In the same manner, the polymers included in the polymer solutions A2 to A13, B1 to B9, C1 to C3, and X are referred to as A2 to A13, B1 to B9, C1 to C3, and X1, respectively. In the tables, Disperbyk 161 is referred to as “BYK,” and SPCN-17X is referred to as “DR1.”

In Tables 3 and 4, the various types of solvents (dispersion mediums) are referred to in the same manner as in Tables 1 and 2, and “S8” refers to diethyl glutarate, “S9” refers to butyl cellosolve, “S10” refers to propylene glycol diacetate, “S11” refers to 1,3-butylene glycol diacetate, and “S12” refers to diethylene glycol ethyl ether acetate. Also, “X_{PG}” refers to the content ratio of the halogenated phthalocyanine complex in the color filter ink, “X_{PD}” refers to the content ratio of the sulfonated pigment derivative in the color filter ink, “X_{D}” refers to the content ratio of the dispersing agent in the color filter ink, “X_{LA}” refers to the content ratio of the liquid A in the color filter ink, and “X_{LB}” refers to the content ratio of the liquid B in the color filter ink. The viscosity was measured in a 25° C. environment using an E-type viscometer (RE-01, manufactured by Toki Sangyo) in accordance with JIS Z8809. The “boiling point” in the tables is the boiling point at normal pressure (1 atmosphere) of the liquid medium. The solubility parameters of the dispersing agents were measured and the values thereof were calculated in accordance with the “solubility test” (“Solvent Pocket Handbook,” p. 22, Society of Synthetic Organic Chemistry). The solubility parameter of the liquid B was calculated by the method of Hildebrand.

Table 5 shows the manufacturing conditions of the color filter inks of the examples and comparative examples. Table 5 also shows the pigment content ratio at the end of the first treatment and at the end of the second treatment.

Formula (10)

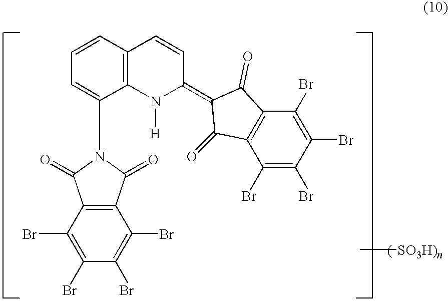

In Formula (10), n is an integer from 1 to 5.

TABLE 3

| | COMPOSITION | | | | | | | |
|---|---|---|---|---|---|---|---|---|
| | | | RESIN MATERIAL | | | | | |
| | | | CURABLE RESIN | | THERMOPLASTIC | | DISPERSING | |
| | PIGMENT | | MATERIAL | | RESIN | | AGENT | |
| | | CONTENT | | CONTENT | | CONTENT | | CONTENT |
| | | RATIO | | RATIO | | RATIO | | RATIO XD |
| | TYPE | (wt %) | TYPE | (wt %) | TYPE | (wt %) | TYPE | (wt %) |
| EXAMPLE 1 | HPZC1/SPD1 | 9.1/1.0 | A1/B1/C1 | | DR1 | 7.3 | BYK | 4.2 |
| EXAMPLE 2 | HPZC1/SPD1 | 9.1/1.0 | A2/B2/C2 | 1.2/1.1/0.7 | DR1 | 7.3 | BYK | 4.2 |
| EXAMPLE 3 | HPZC1/SPD1 | 9.1/1.0 | A3/B3/C3 | 1.5/1.2/0.3 | DR1 | 7.3 | BYK | 4.2 |
| EXAMPLE 4 | HPZC1/SPD1 | 8.0/2.1 | A4/B4 | 1.6/1.4 | DR1 | 7.3 | BYK | 4.2 |
| EXAMPLE 5 | HPZC1/SPD1 | 9.3/0.8 | A5/B5 | 1.6/1.4 | DR1 | 7.3 | BYK | 4.2 |
| EXAMPLE 6 | HPZC1/SPD1 | 9.1/1.0 | A10/B1/C1 | 1.3/1.1/0.6 | DR1 | 7.3 | BYK | 0.9 |
| EXAMPLE 7 | HPZC1/SPD1 | 7.0/0.8 | A9/B1 | 0.6/2.4 | DR1 | 7.3 | BYK | 6.8 |
| EXAMPLE 8 | HPZC1/SPD1 | 6.8/0.9 | A1 | 3 | DR1 | 7.3 | BYK | 7.2 |
| EXAMPLE 9 | HPZC1/SPD1 | 9.8/0.3 | B1 | 3 | DR1 | 7.3 | BYK | 4.2 |
| EXAMPLE 10 | HPZC1/SPD1 | 7.8/2.3 | A8/B1 | 1.5/1.5 | DR1 | 7.3 | BYK | 4.2 |
| EXAMPLE 11 | HPZC2/SPD1 | 9.1/1.0 | X1 | 3 | DR1 | 7.3 | BYK | 4.2 |
| EXAMPLE 12 | HPZC1/SPD2 | 9.1/1.0 | A1/B1 | 1.5/1.5 | DR1 | 7.3 | BYK | 4.2 |
| EXAMPLE 13 | HPZC1/SPD1 | 9.1/1.0 | A11/B2/C2 | 1.2/1.2/0.6 | DR1 | 7.3 | BYK | 1.6 |
| COMPARATIVE | HPZC1/SPD1 | 9.1/1.0 | A10/B1 | 1.5/1.5 | DR1 | 7.3 | BYK | 4.2 |
| EXAMPLE 1 | | | | | | | | |
| COMPARATIVE | HPZC1/SPD1 | 9.1/1.0 | A10/B1 | 1.5/1.5 | DR1 | 7.3 | BYK | 4.2 |
| EXAMPLE 2 | | | | | | | | |
| COMPARATIVE | HPZC1/SPD1 | 9.1/1.0 | A6/B6 | 1.5/1.5 | DR1 | 7.3 | BYK | 4.2 |
| EXAMPLE 3 | | | | | | | | |
| COMPARATIVE | HPZC1/SPD1 | 9.1/1.0 | A7/B7 | 1.5/1.5 | DR1 | 7.3 | BYK | 4.2 |
| EXAMPLE 4 | | | | | | | | |
| COMPARATIVE | HPZC1/SPD1 | 9.1/1.0 | A10/B1 | 1.5/1.5 | DR1 | 7.3 | BYK | 4.2 |
| EXAMPLE 5 | | | | | | | | |
| COMPARATIVE | HPZC1/SPD1 | 9.1/1.0 | A3/B3 | 1.5/1.5 | DR1 | 7.3 | BYK | 4.2 |
| EXAMPLE 6 | | | | | | | | |
| COMPARATIVE | PG36 | 10.1 | A9/B1/C1 | 1.3/1.1/0.6 | DR1 | 7.3 | BYK | 4.2 |
| EXAMPLE 7 | | | | | | | | |
| COMPARATIVE | HPZC1 | 10.1 | A1/B1/C1 | 1.3/1.1/0.6 | DR1 | 7.3 | BYK | 4.2 |
| EXAMPLE 8 | | | | | | | | |
| COMPARATIVE | PG36/SPD1 | 9.1/1.0 | A1/B1/C1 | 1.3/1.1/0.6 | DR1 | 7.3 | BYK | 4.2 |
| EXAMPLE 9 | | | | | | | | |

| | COMPOSITION | | | | | | |
|---|---|---|---|---|---|---|---|
| | | LIQUID MEDIUM | | | | | |
| | DISPERSING AGENT | LIQUID A | | | LIQUID B | | |
| | SP VALUE | | CONTENT | | | CONTENT | |
| | SP(X) | | RATIO | BOILING | | RATIO | SP VALUE |
| | ((cal/ml)1/2) | TYPE | XLA (wt %) | POINT (° C.) | TYPE | XLB (wt %) | SP (Y) |
| EXAMPLE 1 | 9.8 | S1 | 64.1 | 246 | S11 | 11.3 | 9.5 |
| EXAMPLE 2 | 9.8 | S2 | 64.1 | 213 | S8 | 11.3 | 9.9 |
| EXAMPLE 3 | 9.8 | S3 | 64.1 | 208 | S8 | 11.3 | 9.9 |
| EXAMPLE 4 | 9.8 | S4 | 64.1 | 192 | S9 | 11.3 | 9.8 |
| EXAMPLE 5 | 9.8 | S5 | 64.1 | 187 | S9 | 11.3 | 9.8 |
| EXAMPLE 6 | 9.8 | S1 | 66.9 | 246 | S10 | 11.8 | 9.6 |
| EXAMPLE 7 | 9.8 | S1 | 63.9 | 246 | S11 | 11.2 | 9.5 |
| EXAMPLE 8 | 9.8 | S1 | 63.6 | 246 | S11 | 11.2 | 9.5 |
| EXAMPLE 9 | 9.8 | S1 | 67.8 | 246 | S11 | 11.2 | 9.5 |
| EXAMPLE 10 | 9.8 | S1 | 64.1 | 217 | S12 | 11.2 | 9.0 |
| EXAMPLE 11 | 9.8 | S1 | 56.6 | 246 | S11 | 18.8 | 9.5 |
| EXAMPLE 12 | 9.8 | S1 | 70.1 | 246 | S8 | 5.3 | 9.9 |
| EXAMPLE 13 | 9.8 | S2 | 66.3 | 216 | S10 | 11.7 | 9.6 |
| COMPARATIVE | 9.8 | S1 | 70.9 | 246 | S11 | 4.5 | 9.5 |
| EXAMPLE 1 | | | | | | | |
| COMPARATIVE | 9.8 | S1 | 50.6 | 246 | S11 | 24.8 | 9.5 |
| EXAMPLE 2 | | | | | | | |
| COMPARATIVE | 9.8 | S6 | 64.1 | 295 | S11 | 11.3 | 9.5 |
| EXAMPLE 3 | | | | | | | |
| COMPARATIVE | 9.8 | S7 | 64.1 | 171 | S11 | 11.3 | 9.5 |
| EXAMPLE 4 | | | | | | | |
| COMPARATIVE | 9.8 | S1 | 64.1 | 246 | S3 | 11 | 8.3 |
| EXAMPLE 5 | | | | | | | |
| COMPARATIVE | 9.8 | S3 | 75.4 | 208 | — | — | — |
| EXAMPLE 6 | | | | | | | |
| COMPARATIVE | 9.8 | S1 | 64.1 | 246 | S11 | 11.3 | 9.5 |
| EXAMPLE 7 | | | | | | | |
| COMPARATIVE | 9.8 | S1 | 64.1 | 246 | S11 | 11.3 | 9.5 |
| EXAMPLE 8 | | | | | | | |
| COMPARATIVE | 9.8 | S1 | 64.1 | 246 | S11 | 11.3 | 9.5 |
| EXAMPLE 9 | | | | | | | |

TABLE 4

| | | | | | | | CHANGE IN | |
|---|---|---|---|---|---|---|---|---|
| | | | | | \|SP (X) − | | APPEARANCE | AMOUNT OF |
| | | | | | SP (Y)\| | VISCOSITY | AFTER HEAT | VISCOSITY |
| | X_{PD}/X_{PG} | X_{D}/X_{PG} | X_{LA}/X_{LB} | X_{D}/X_{LB} | ((cal/cm3)1/2) | (mPa · s) | TREATMENT | CHANGE |
| EXAMPLE 1 | 0.11 | 0.46 | 5.7 | 0.37 | 0.3 | 8.3 | A | A |
| EXAMPLE 2 | 0.11 | 0.46 | 5.7 | 0.37 | 0.1 | 8.0 | A | A |
| EXAMPLE 3 | 0.11 | 0.46 | 5.7 | 0.37 | 0.1 | 7.2 | A | A |
| EXAMPLE 4 | 0.26 | 0.53 | 5.7 | 0.37 | 0.0 | 8.3 | A | A |
| EXAMPLE 5 | 0.09 | 0.45 | 5.7 | 0.37 | 0.0 | 9.0 | A | A |
| EXAMPLE 6 | 0.11 | 0.10 | 5.7 | 0.08 | 0.2 | 8.3 | A | B |
| EXAMPLE 7 | 0.11 | 0.97 | 5.7 | 0.60 | 0.3 | 8.2 | A | A |
| EXAMPLE 8 | 0.13 | 1.06 | 5.7 | 0.64 | 0.3 | 9.3 | A | A |
| EXAMPLE 9 | 0.03 | 0.43 | 6.1 | 0.38 | 0.3 | 9.4 | A | B |
| EXAMPLE 10 | 0.29 | 0.54 | 5.7 | 0.38 | 0.8 | 9.2 | A | A |
| EXAMPLE 11 | 0.11 | 0.46 | 3.0 | 0.22 | 0.3 | 8.7 | B | B |
| EXAMPLE 12 | 0.11 | 0.46 | 13.2 | 0.80 | 0.1 | 8.8 | B | B |
| EXAMPLE 13 | 0.11 | 0.18 | 5.7 | 0.14 | 0.2 | 8.6 | A | A |
| COMPARATIVE EXAMPLE 1 | 0.11 | 0.46 | 15.7 | 0.93 | 0.3 | 9.3 | B | C |
| COMPARATIVE EXAMPLE 2 | 0.11 | 0.46 | 2.0 | 0.17 | 0.3 | 9.2 | C | D |
| COMPARATIVE EXAMPLE 3 | 0.11 | 0.46 | 5.7 | 0.37 | 0.3 | 16.2 | C | C |
| COMPARATIVE EXAMPLE 4 | 0.11 | 0.46 | 5.7 | 0.37 | 0.3 | 8.2 | A | A |
| COMPARATIVE EXAMPLE 5 | 0.11 | 0.46 | 5.8 | 0.38 | 1.5 | 9.1 | C | D |
| COMPARATIVE EXAMPLE 6 | 0.11 | 0.46 | — | — | — | 8.1 | C | E |
| COMPARATIVE EXAMPLE 7 | — | — | 5.7 | 0.37 | 0.3 | 11.3 | A | A |
| COMPARATIVE EXAMPLE 8 | — | 0.42 | 5.7 | 0.37 | 0.3 | 10.1 | D | E |
| COMPARATIVE EXAMPLE 9 | — | — | 5.7 | 0.37 | 0.3 | 12.0 | A | A |

TABLE 5

| | | | FINE DISPERSION STEP | | | | |
|---|---|---|---|---|---|---|---|
| | | | FIRST TREATMENT | | | | |
| | | | FIRST INORGANIC BEADS | | | | |
| | | | | AMOUNT | | | |
| | | | | (PARTS BY wt.) | | | |
| | | | | PER 100 PARTS | | | |
| | PREPARATORY | | | BY WEIGHT OF | | | |
| | DISPERSION STEP | | AVERAGE | DISPERSING- | | | |
| | TREATMENT | | PARTICLE | AGENT- | | | PIGMENT |
| | TIME | ROTATIONAL | DIAMETER | DISPERSED | TREATMENT | ROTATIONAL | CONTENT |
| | (min.) | SPEED (rpm) | (mm) | LIQUID | TIME (min) | SPEED (rpm) | (wt %) |
| EXAMPLE 1 | 3 | 2500 | 1 | 350 | 35 | 1700 | 17 |
| EXAMPLE 2 | 5 | 2000 | 0.7 | 450 | 25 | 1900 | 17 |
| EXAMPLE 3 | 3 | 2500 | 1 | 350 | 35 | 1700 | 17 |
| EXAMPLE 4 | 3 | 2500 | 1 | 350 | 35 | 1700 | 17 |
| EXAMPLE 5 | 3 | 2500 | 1 | 350 | 35 | 1700 | 17 |
| EXAMPLE 6 | 3 | 2500 | 1 | 350 | 35 | 1700 | 17 |
| EXAMPLE 7 | 5 | 2000 | 0.7 | 450 | 25 | 1900 | 17 |
| EXAMPLE 8 | 3 | 2500 | 1 | 350 | 35 | 1700 | 17 |
| EXAMPLE 9 | 10 | 2500 | 0.4 | 350 | 40 | 1700 | 15 |
| EXAMPLE 10 | 30 | 2400 | 1.1 | 350 | 12 | 1700 | 13 |
| EXAMPLE 11 | 20 | 1200 | 0.4 | 250 | 70 | 1100 | 15 |
| EXAMPLE 12 | 2 | 4100 | 1.4 | 500 | 70 | 4200 | 15 |
| EXAMPLE 13 | 5 | 2000 | 0.7 | 450 | 25 | 1900 | 17 |
| COMPARATIVE | 5 | 2000 | 0.7 | 450 | 25 | 1900 | 17 |
| EXAMPLE 1 | | | | | | | |
| COMPARATIVE | 3 | 2500 | 1 | 350 | 35 | 1700 | 17 |
| EXAMPLE 2 | | | | | | | |
| COMPARATIVE | 3 | 2500 | 1 | 350 | 35 | 1700 | 17 |
| EXAMPLE 3 | | | | | | | |
| COMPARATIVE | 3 | 2500 | 1 | 350 | 35 | 1700 | 17 |
| EXAMPLE 4 | | | | | | | |
| COMPARATIVE | 3 | 2500 | 1 | 350 | 35 | 1700 | 17 |
| EXAMPLE 5 | | | | | | | |
| COMPARATIVE | 3 | 2500 | 1 | 350 | 35 | 1700 | 17 |
| EXAMPLE 6 | | | | | | | |
| COMPARATIVE | 3 | 2500 | 1 | 350 | 35 | 1700 | 17 |
| EXAMPLE 7 | | | | | | | |
| COMPARATIVE | 3 | 2500 | 1 | 350 | 35 | 1700 | 17 |
| EXAMPLE 8 | | | | | | | |
| COMPARATIVE | 3 | 2500 | 1 | 350 | 35 | 1700 | 17 |
| EXAMPLE 9 | | | | | | | |

| | FINE DISPERSION STEP | | | | | | |
|---|---|---|---|---|---|---|---|
| | SECOND TREATMENT | | | | | | |
| | SECOND INORGANIC | | | | | | |
| | BEADS | | | | | | |
| | | AMOUNT | | | | | |
| | | (PARTS BY wt.) | | | | | |
| | | PER 100 PARTS | | | | | |
| | | BY WEIGHT OF | | | | | |
| | AVERAGE | DISPERSING- | | | | CURABLE RESIN MIXING | |
| | PARTICLE | AGENT- | | | PIGMENT | STEP | |
| | DIAMETER | DISPERSED | TREATMENT | ROTATIONAL | CONTENT | TREATMENT | ROTATIONAL |
| | (mm) | LIQUID | TIME (min) | SPEED (rpm) | (wt %) | TIME (min) | SPEED (rpm) |
| EXAMPLE 1 | 0.1 | 450 | 20 | 2500 | 14 | 25 | 2000 |
| EXAMPLE 2 | 0.2 | 500 | 25 | 2200 | 13 | 45 | 3500 |
| EXAMPLE 3 | 0.1 | 450 | 20 | 2500 | 14 | 25 | 2000 |
| EXAMPLE 4 | 0.1 | 450 | 20 | 2500 | 14 | 25 | 2000 |
| EXAMPLE 5 | 0.1 | 450 | 20 | 2500 | 14 | 25 | 2000 |
| EXAMPLE 6 | 0.1 | 450 | 20 | 2500 | 14 | 25 | 2000 |
| EXAMPLE 7 | 0.2 | 500 | 25 | 2200 | 13 | 45 | 3500 |
| EXAMPLE 8 | 0.1 | 450 | 20 | 2500 | 14 | 25 | 2000 |
| EXAMPLE 9 | 0.05 | 450 | 30 | 2500 | 14 | 25 | 3000 |
| EXAMPLE 10 | 0.1 | 450 | 40 | 2700 | 12 | 25 | 1800 |
| EXAMPLE 11 | 0.1 | 600 | 45 | 2500 | 13 | 20 | 2300 |
| EXAMPLE 12 | 0.1 | 170 | 45 | 4000 | 13 | 20 | 2100 |
| EXAMPLE 13 | 0.2 | 500 | 25 | 2200 | 13 | 45 | 3500 |
| COMPARATIVE | 0.2 | 500 | 25 | 2200 | 13 | 45 | 3500 |
| EXAMPLE 1 | | | | | | | |
| COMPARATIVE | 0.1 | 450 | 20 | 2500 | 14 | 25 | 2000 |
| EXAMPLE 2 | | | | | | | |
| COMPARATIVE | 0.1 | 450 | 20 | 2500 | 14 | 25 | 2000 |
| EXAMPLE 3 | | | | | | | |
| COMPARATIVE | 0.1 | 450 | 20 | 2500 | 14 | 25 | 2000 |
| EXAMPLE 4 | | | | | | | |
| COMPARATIVE | 0.1 | 450 | 20 | 2500 | 14 | 25 | 2000 |
| EXAMPLE 5 | | | | | | | |
| COMPARATIVE | 0.1 | 450 | 20 | 2500 | 14 | 25 | 2000 |
| EXAMPLE 6 | | | | | | | |
| COMPARATIVE | 0.1 | 450 | 20 | 2500 | 14 | 25 | 2000 |
| EXAMPLE 7 | | | | | | | |
| COMPARATIVE | 0.1 | 450 | 20 | 2500 | 14 | 25 | 2000 |
| EXAMPLE 8 | | | | | | | |
| COMPARATIVE | 0.1 | 450 | 20 | 2500 | 14 | 25 | 2000 |
| EXAMPLE 9 | | | | | | | |

### 3. Evaluation of Stability of Color Filter Ink (Durability Evaluation

### 3-1. Change in Appearance After Heating

The green color filter ink (G ink) of the examples and comparative examples was left for 12 days in a 60° C. environment, after which the ink was visually observed and evaluated according to the four criteria shown below.

A: No change from the state prior to heating was observed.

B: Slight aggregation/precipitation of pigment particles was observed.

C.: Aggregation/precipitation of pigment particles was plainly observed.

D: Severe aggregation/precipitation of pigment particles was observed.

### 3-2. Change in Viscosity

The viscosity (kinetic viscosity) of the green color filter ink (G ink) of the examples and comparative examples was measured after the ink was left for 12 days in a 60° C. environment, and the difference in viscosity was calculated with respect to the viscosity immediately after manufacture. Specifically, the difference indicated by v₁−v₀ was calculated, wherein v₀ (mPa·s) is the viscosity immediately after manufacturing, and v₁ (mPa·s) is the viscosity after the ink was left for 12 days in a 60° C. environment. The values calculated in this manner were evaluated according to the five criteria shown below.

A: The value of v₁−v₀ is less than 0.4 mPa·s.

B: The value of v₁−v₀ is 0.4 mPa·s or higher and less than 0.6 mPa·s.

C: The value of v₁−v₀ is 0.6 mPa·s or higher and less than 0.8 mPa·s.

D: The value of v₁−v₀ is 0.8 mPa·s or higher and less than 1.0 mPa·s.

E: The value of v₁−v₀ is 1.0 mPa·s or higher.

### 4. Evaluation of Stability of Droplet Discharge

### Evaluation of Stable Discharge Properties

Evaluation by testing as described below was performed using the green color filter ink obtained in the examples and comparative examples.

### 4-1. Evaluation of Landing Position Accuracy

A droplet discharge device such as that shown in FIGS. 3 to 6 disposed in a chamber (thermal chamber) and the G inks of the examples and comparative examples were prepared, and 100,000 droplets (100,000 drops) of the inks were continuously discharged from the nozzles of a droplet discharge head in an environment of 25° C. and 55% RH in a state in which the drive waveform of the piezoelement had been optimized. The average value of the offset distance d from the center aim position of the center position of the landed droplets was calculated for the 100,000 droplets discharged from specified nozzles in the vicinity of the center of the droplet discharge head, and an evaluation was made based on the four ranges described below.

A: The average value of the offset distance d is less than 0.08 μm

B: The average value of the offset distance d is 0.08 μm or more and less than 0.12 μm

C.: The average value of the offset distance d is 0.12 μm or more and less than 0.20 μm

D: The average value of the offset distance d is 0.20 or more

### 4-2. Evaluation of Stability of Droplet Discharge Quantity

A droplet discharge device such as that shown in FIGS. 3 to 6 disposed in a chamber (thermal chamber), and the G inks of the examples and comparative examples were prepared, and 100,000 droplets (100,000 drops) of the inks were continuously discharged from the nozzles of a droplet discharge head in an environment of 28° C. and 50% RH in a state in which the drive waveform of the piezoelement had been optimized. The total weight of the discharged droplets was calculated for two specific nozzles at the left and right ends of the droplet discharge head, and the absolute value ΔW (ng) of the difference between the average discharge quantities of the droplets discharged from the two nozzles was calculated. The ratio (ΔW/W_{T}) of the ΔW in relation to the target discharge quantity W_{T} (ng) of the droplets was calculated, and an evaluation was made based on the four ranges described below. It is apparent that the smaller the value of ΔW/W_{T} is, the greater the stability of the droplet discharge quantity.

A: The value of ΔW/W_{T} is less than 0.050

B: The value of ΔW/W_{T} is 0.050 or higher and less than 0.700

C: The value of ΔW/W_{T} is 0.7030 or higher and less than 0.900

D: The value of ΔW/W_{T} is 0.900 or higher

### 4-3. Evaluation of Intermittent Printing Performance

A droplet discharge device such as that shown in FIGS. 3 to 6 disposed in a chamber (thermal chamber), and the G inks of the examples and comparative examples were prepared, and 10000 droplets (10000 drops) of the inks were continuously discharged from the nozzles of a droplet discharge head in an environment of 28° C. and 50% RH in a state in which the drive waveform of the piezoelement had been optimized, after which droplet discharge was stopped for 30 seconds (first sequence). Thereafter, droplets were continuously discharged in the same manner and the operation of stopping the discharge of droplets was repeated. The average weight W₁ (ng) of the droplets discharged in the first sequence and the average weight W₂₀ (ng) of the droplets discharged in the 20^{th} sequence were calculated for the specified nozzles in the vicinity of the center of the droplet discharge head. The ratio (|W₁−W₂₀|/W_{T}) of the absolute value of the difference between W₁ and W₂₀ in relation to the target discharge quantity W_{T} (ng) of the droplets was calculated, and an evaluation was made based on the three ranges described below. It is apparent that the smaller the value of |W₁−W₂₀|/W_{T} is, the greater the intermittent printing performance (stability of the droplet discharge quantity).

A: The value of |W₁−W₂₀|/W_{T} is less than 0.150

B: The value of |W₁−W₂₀|/W_{T} is 0.150 or higher and less than 0.900

C: The value of |W₁−W₂₀|/W_{T} is 0.900 or higher

### 4-4. Continuous Discharge Test

The inks were discharged by continuously operating the droplet discharge device for 128 hours in an environment of 28° C. and 50% RH using a droplet discharge device such as that shown in FIGS. 3 to 6 disposed in a chamber (thermal chamber) and the R inks of the examples and comparative examples.

The rate ([(number of clogged nozzles)/(total number of nozzles)]×100) at which clogging of the nozzles constituting the droplet discharge head occurs after continuous operation was calculated, and it was investigated whether clogging can be eliminated using a cleaning member composed of a plastic material. The results were evaluated based on the four ranges described below.

A: Nozzle clogging does not occur.

B: The occurrence rate of nozzle clogging is less than 0.5% (not including 0), and clogging can be eliminated by cleaning.

C: The occurrence rate of nozzle clogging is 0.5% or higher and less than 1.0%, and clogging can be eliminated by cleaning.

D: The occurrence rate of nozzle clogging is 1.0% or higher, and clogging cannot be eliminated by cleaning.

The evaluation described above was carried out in the same conditions for the examples and the comparative examples.

### 4-5. Accumulation of Solids in a Cap Part and Blockage of Cap Part

A droplet discharge device such as the one shown in FIGS. 3 through 7, and the color filter ink sets of the examples and working examples were prepared, and the inks constituting the color filter ink set were discharged by continuously operating the droplet discharge device for 24 hours in an environment of 28° C. and 50% RH. Discharge was performed while periodically performing cleaning using the cap part during operation. Problems with the cap part during continuous operation of the droplet discharge device were evaluated according to the three levels described below. The same continuous operation was performed for the green ink, and problems with the cap part during continuous operation of the droplet discharge device were evaluated in the same manner.

A: Accumulation of solids in the cap part and blockage of the ink absorption body and discharge hole of the cap part were not observed.

B: Accumulation of solids in the cap part and blockage of the ink absorption body and discharge hole of the cap part were observed, but were not problematic.

C: Accumulation of solids in the cap part and blockage of the ink absorption body and discharge hole of the cap part were observed, and operation had to be stopped to eliminate the accumulation and blockage.

### 4-6. Evaluation of Re-Dispersion Properties

### (Re-Dissolving Properties) of Ink Solids

For the color filter inks prepared in the examples and comparative examples, 1 mL of each of the three colors of ink was measured out and mixed in a 10 mL petri dish. The mixed ink was then dried for 8 hours at 40° C. and further dried for 96 hours at 20° C. to form a solid body of ink. One drop of each color of ink was then dropped in mutually different locations on the obtained solid body, and the re-dispersion (re-dissolving) of the solid body was observed and evaluated according to the three levels described below. For the G ink, 3 mL was placed in a 10 mL petri dish and dried under the same conditions, and the same evaluation was performed by dropping one drop of the green ink. In general, when the ink has excellent re-dispersion properties (re-dissolving properties) of the solid body, there is minimal blockage of the nozzles, and even when the nozzles do become blocked, the blockage can be eliminated by cleaning. Flight deflection during droplet discharge is also minimal.

A: The solid body was rapidly dispersed (dissolved).

B: The solid body was slow to disperse (dissolve).

C: The solid body was not dispersed (dissolved).

### 5. Manufacture of Color Filters

A color filter was manufactured in the following manner using the color filter ink set obtained in the examples and comparative examples.

First, a substrate (G5 size: 1100×1300 mm) composed of soda glass on which a silica (SiO₂) film for preventing elution of the sodium ions was formed on the two sides was prepared and washed.

Next, a radiation-sensitive composition for forming a partition wall containing carbon black was applied to the entire surface of one of the surfaces of the washed substrate to form a coated film.

Next, a prebaking treatment was performed at a heating temperature of 110° C. and a heating time of 120 seconds.

The substrate was thereafter irradiated via a photomask, subjected to post exposure baking (PEB), subsequently developed using an alkali development fluid, and then subjected to a post baking treatment to thereby form a partition wall. PEB was carried out at a heating temperature of 110° C., a heating time of 120 seconds, and an irradiation intensity of 150 mJ/cm². The development treatment time was set to 60 seconds. The post baking treatment was carried out at a heating temperature of 150° C. for a heating time of 5 minutes. The thickness of the partition wall thus formed was 2.1 μm.

Next, the color filter ink was discharged into the cells as areas surrounded by the partition wall by using a droplet discharge device such as that shown in FIGS. 3 to 7. In this case, three color filter inks were used, and care was taken that the color filter ink of each color was not mixed. A droplet discharge head was used in which the nozzle plate had been joined using an epoxy adhesive (AE-40, manufactured by Ajinomoto Fine-Techno).

Thereafter, heat treatment is carried out for 10 minutes at 100° C. on a hot plate, and heat treatment was then carried out for one hour in an oven at 200° C., whereby three colored portions were formed. A color filter such as that shown in FIG. 1 was thereby obtained.

The color filter inks (ink sets) of the examples and the comparative examples were used to manufacture 8000 color filters of each ink set using the method described above.

### 6. Evaluation of Color Filters

The color filters obtained in the manner described above were evaluated in the manner described below

### 6-1. Uneveness of Color and Saturation

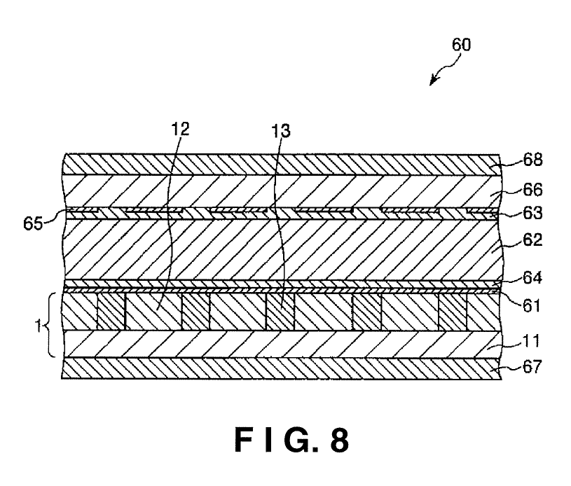

Among the color filters manufactured using the color filter inks (ink sets) of the examples and the comparative examples, a liquid crystal display device such as that shown in FIG. 8 was manufactured under the same conditions using the 8000^{th} color filter manufactured of each example and the comparative example.

Red monochromatic display and white monochromatic display were visually observed in a dark room using these liquid crystal display devices, and the occurrence of uneven color and uneven saturation between different regions was evaluated based on the five levels described below.

A: Uneven color and uneven saturation were not observed.

B: Uneven color and uneven saturation were substantially not observed.

C: Some uneven color and uneven saturation was observed.

D: Uneven color and uneven saturation were plainly observed.

E: Uneven color and uneven saturation were markedly observed.

### 6-2. Difference in Charateristics Between Units

Of the color filters manufactured using the color filter ink sets of the examples and the comparative examples, the first to the 10^{th} and the 4990^{th} to the 4999^{th} color filters manufactured of each example and the comparative example were prepared, and 100 pixels were extracted at random from each color filter. Red monochromatic display, green monochromatic display, blue monochromatic display, and white monochromatic display were carried out in a dark room for the extracted 100 pixels, and the colors were measured using a spectrophotometer (MCPD 3000, manufactured by Otsuka Electronics). The average value of the hue calculated for the abovementioned 100 pixels was used as the color filter hue for each color filter. The maximum color differences (color difference ΔE in the Lab display system) in the first to the 10^{th} and the 4990^{th} to the 4999^{th} color filters manufactured for each of the examples and comparative examples were calculated from the results and evaluated based on the five ranges described below.

A: Color difference (ΔE) is less than 0.5.

B: Color difference (ΔE) is 0.5 or more and less than 1.0.

C: Color difference (ΔE) is 1.0 or more and less than 1.5.

D: Color difference (ΔE) is 1.5 or more and less than 2.0.

E: Color difference (ΔE) is 2.0 or more.

### 6-3. Durability

Among the color filters manufactured using the color filter inks (ink sets) of the examples and the comparative examples, a liquid crystal display device such as that shown in FIG. 7 was manufactured under the same conditions using the 1991^{st} to 2000^{th} color filters manufactured of each example and the comparative example. Green monochromatic display and white monochromatic display were visually observed in a dark room using these liquid crystal display devices, and the occurrence of light leakage (white spots, luminescent spots) was checked.

Next, the color filters were removed from the liquid crystal display devices.

The color filters thus removed were left sitting for 1.5 hours at 25° C., then 2 hours at 50° C., subsequently 1.5 hours at 25° C., and then 3 hours at −20° C. Thereafter, the environment temperature was again restored to 25° C. to complete a single cycle (8 hours), and this cycle was repeated for a total of 30 times (total of 240 hours).

Thereafter, liquid crystal display devices such as the one shown in FIG. 8 were again assembled using these color filters.

Red monochromatic display and white monochromatic display were visually observed in a dark room using these liquid crystal display devices, and the occurrence of light leakage (white spots, luminescent spots) was evaluated based on the following five levels.

A: There was no color filter in which light leakage (white spots, luminescent spots) occurred.

B: Light leakage (white spots, luminescent spots) was observed in 1 to 2 color filters.

C: Light leakage (white spots, luminescent spots) was observed in 3 to 5 color filters.

D: Light leakage (white spots, luminescent spots) was observed in 6 to 9 color filters.

E: Light leakage (white spots, luminescent spots) was observed in 10 color filters.

### 7. Evaluation of Contrast

Evaluation by testing as described below was performed using the green color filter ink obtained in the examples and comparative examples.

Green colored films were each formed by an inkjet method on a different glass plate (diameter: 10 cm) using the G inks constituting the ink sets of the examples and comparative examples.

The colored films were formed by discharging droplets onto the glass plates, and thereafter carrying out a heat treatment for 10 minutes at 120° C. on a hot plate, and then carrying out a heat treatment for 0.5 hour in an oven at 260° C. The discharge quantity of the color filter ink was adjusted so that the thickness of the formed colored film was 1.5 μm.

The contrast (CR) was obtained for the glass substrates on which a colored film was formed in this manner using a contrast tester (CT-1, manufactured by Tsubosaka Electric), and evaluated based on the five ranges described below.

A: CR was 10000 or higher.

B: CR was 8500 or higher and less than 10000.

C.: CR was 7000 or higher and less than 8500.

D: CR was 5000 or higher and less than 7000.

E: CR was less than 5000.

### 8. Evaluation of Brightness

Tristimulus values according to the xyY color system were calculated using a calorimeter (CM-3700d, manufactured by Minolta) for the glass substrates on which the green color films were formed that were used in the evaluation of contrast, and evaluation was performed according to the five ranges described below.

A: The brightness Y was 62.0 or higher.

B: The brightness Y was 60.0 or higher and less than 62.0.

C: The brightness Y was 58.0 or higher and less than 60.0.

D: The brightness Y was 55.5 or higher and less than 58.0.

E: The brightness Y was less than 55.5.

In the evaluations described above, the color filters and glass substrates were observed and measured under the same conditions.

These results are shown in Table 6.

TABLE 6

| | DROPLET DISCHARGE STABILITY | | | | | | | |
|---|---|---|---|---|---|---|---|---|
| | | STABILITY | | | | | | |
| | | OF | | | | | INK SOLID RE- | |
| | LANDING | DROPLET | INTERMITTENT | CONTINUOUS | BLOCKAGE OF CAP | | DISPERSION | |
| | POSITION | DISCHARGE | PRINTING | DISCHARGE | PART | | PROPERTIES | |
| | ACCURACY | QUANTITY | PERFORMANCE | TEST | GREEN | 3 COLORS | GREEN | 3 COLORS |
| EXAMPLE 1 | A | A | A | A | A | A | A | A |
| EXAMPLE 2 | A | A | A | A | A | A | A | A |
| EXAMPLE 3 | A | A | B | A | A | A | A | A |
| EXAMPLE 4 | A | A | B | A | A | A | A | A |
| EXAMPLE 5 | A | A | B | B | A | A | A | A |
| EXAMPLE 6 | A | A | B | B | A | A | A | A |
| EXAMPLE 7 | A | A | A | A | A | A | A | A |
| EXAMPLE 8 | A | B | A | A | A | A | A | B |
| EXAMPLE 9 | A | B | A | B | A | A | A | B |
| EXAMPLE 10 | A | A | A | B | B | B | B | B |
| EXAMPLE 11 | B | B | B | B | A | A | A | B |
| EXAMPLE 12 | A | B | A | B | A | B | A | B |
| EXAMPLE 13 | A | A | B | A | A | B | A | B |
| COMPARATIVE | B | B | C | C | B | C | B | B |
| EXAMPLE 1 | | | | | | | | |
| COMPARATIVE | B | C | B | B | B | C | B | C |
| EXAMPLE 2 | | | | | | | | |
| COMPARATIVE | D | D | C | C | C | B | A | A |
| EXAMPLE 3 | | | | | | | | |
| COMPARATIVE | C | C | C | C | B | C | C | C |
| EXAMPLE 4 | | | | | | | | |
| COMPARATIVE | C | B | C | B | B | C | B | C |
| EXAMPLE 5 | | | | | | | | |
| COMPARATIVE | C | C | B | D | C | C | C | C |
| EXAMPLE 6 | | | | | | | | |
| COMPARATIVE | A | A | A | A | A | B | A | B |
| EXAMPLE 7 | | | | | | | | |
| COMPARATIVE | C | D | C | D | C | C | C | C |
| EXAMPLE 8 | | | | | | | | |
| COMPARATIVE | A | A | A | A | A | B | A | A |
| EXAMPLE 9 | | | | | | | | |

| | COLOR FILTER | | | | |
|---|---|---|---|---|---|
| | UNEVEN COLOR, | DIFFERENCE IN | | | |
| | UNEVEN | CHARACTERISTICS | | | |
| | SATURATION | BETWEEN UNITS | CONTRAST | BRIGHTNESS | DURABILITY |
| EXAMPLE 1 | A | A | A | A | A |
| EXAMPLE 2 | A | A | A | A | A |
| EXAMPLE 3 | A | A | A | A | A |
| EXAMPLE 4 | A | B | A | A | B |
| EXAMPLE 5 | B | A | A | A | B |
| EXAMPLE 6 | A | B | A | A | B |
| EXAMPLE 7 | A | B | A | A | A |
| EXAMPLE 8 | B | B | A | A | A |
| EXAMPLE 9 | A | B | B | B | A |
| EXAMPLE 10 | A | B | A | B | A |
| EXAMPLE 11 | B | C | B | B | C |
| EXAMPLE 12 | B | C | A | A | A |
| EXAMPLE 13 | A | B | A | A | A |
| COMPARATIVE | B | C | B | B | C |
| EXAMPLE 1 | | | | | |
| COMPARATIVE | C | B | C | B | B |
| EXAMPLE 2 | | | | | |
| COMPARATIVE | E | E | B | B | B |
| EXAMPLE 3 | | | | | |
| COMPARATIVE | D | E | D | D | D |
| EXAMPLE 4 | | | | | |
| COMPARATIVE | D | D | D | D | B |
| EXAMPLE 5 | | | | | |
| COMPARATIVE | E | E | E | E | E |
| EXAMPLE 6 | | | | | |
| COMPARATIVE | B | B | E | E | C |
| EXAMPLE 7 | | | | | |
| COMPARATIVE | E | E | E | C | E |
| EXAMPLE 8 | | | | | |
| COMPARATIVE | B | B | E | E | C |
| EXAMPLE 9 | | | | | |

As is clear from Table 6, the stability of droplet discharge was excellent in the present invention, the occurrence of color mixing, uneven color, uneven saturation, and light leakage was suppressed in the manufactured color filters, and there was minimal variation of characteristics between units. The ink of the present invention also had excellent re-dispersing properties (re-dissolving properties) of solidified ink, nozzle blockage in the droplet discharge device and droplet flight deflection were minimal during droplet discharge, and there were almost no problems in the cap part. The color filter also had excellent durability in the present invention. Contrast and brightness were also excellent in the present invention. In the present invention, the color filter ink had excellent stability over time. In contrast, satisfactory results were not obtained in the comparative examples.

The similar results as described above were also obtained when a commercially available liquid crystal television was disassembled, the liquid crystal display device unit was replaced by a unit manufactured as described above, and the same evaluations (the evaluation 6.) as described above were performed.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have-been chosen to illustrate the present invention, it will be apparent to those skilled in the alt from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A color filter ink adapted to be used to manufacture a color filter by an inkjet method, the color filter ink comprising:
a pigment including a halogenated phthalocyanine zinc complex and a pigment derivative represented by a chemical formula (1) below, 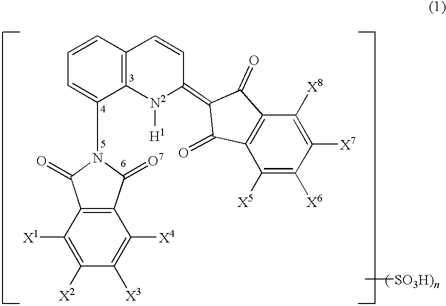
wherein, in the chemical formula (1), a value n is an integer from 1 to 5, and X¹ through X⁸ represent each independently a hydrogen atom or a halogen atom;
a dispersing agent that disperses the pigment; and
a liquid medium in which the pigment is dispersed, the liquid medium including at least a first liquid and a second liquid different than the first liquid, with a boiling point at atmospheric pressure of the first liquid being 180 to 290° C., a content ratio of the second liquid in the color filter ink being 5 to 20 wt %, and a relationship |SP (X)−SP (Y)|≦0.8 being satisfied, wherein a value SP (X) ((cal/cm³)^{1/2}) indicates a solubility parameter for the dispersing agent, and a value SP (Y) ((cal/cm³)1/2) indicates a solubility parameter for the second liquid.

2. The color filter ink according to claim 1, wherein a relationship 0.01≦X_{PD}/X_{PG}≦0.30 is satisfied, wherein a value X_{PD} (wt %) indicates a content ratio of the pigment derivative in the color filter ink, and a value X_{PG} (wt %) indicates a content ratio of the halogenated phthalocyanine zinc complex.

3. The color filter ink according to claim 1, wherein
a relationship 0.05≦X_{D}/X_{PG}≦1.50 is satisfied, wherein a value X_{D} (wt %) indicates a content ratio of the dispersing agent in the color filter ink, and a value X_{PG} (wt %) indicates a content ratio of the halogenated phthalocyanine zinc complex.

4. The color filter ink according to claim 1, wherein
a relationship 3.0≦X_{LA}/X_{LB}≦13.0 is satisfied, wherein a value X_{LA} (wt %) indicates a content of the first liquid, and a value X_{LB} (wt %) indicates a content ratio of the second liquid in the color filter ink.

5. The color filter ink according to claim 1, wherein
a relationship 0.32≦X_{D}/X_{LB}≦3.0 is satisfied, wherein a value X_{D} (wt %) indicates a content ratio of the dispersing agent in the color filter ink, and a value X_{LB} (wt %) indicates a content ratio of the second liquid.

6. The color filter ink according to claim 1, further comprising
a resin material including a first polymer containing at least a first epoxy-containing vinyl monomer as a monomer component.

7. The color filter ink according to claim 6, wherein
the first polymer is a copolymer having the first epoxy-containing vinyl monomer and a second vinyl monomer as monomer components, the second vinyl monomer having an isocyanate group or a block isocyanate group in which an isocyanate group is protected by a protective group.

8. The color filter ink according to claim 6, wherein
the first polymer is a copolymer having the first epoxy-containing vinyl monomer and a third vinyl monomer as monomer components, the third vinyl monomer having a hydroxyl group.

9. The color filter ink according to claim 1, further comprising
a resin material including a second polymer containing at least an alkoxysilyl-containing vinyl monomer indicated by a chemical formula (2) below as a monomer component, 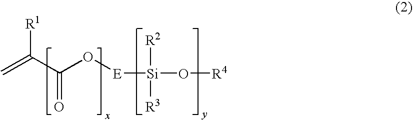
wherein, in the chemical formula (2), R¹ represents a hydrogen atom or a C₁₋₇ alkyl group, E represents a single bond hydrocarbon group or a bivalent hydrocarbon group, R2 represents a C₁₋₆ alkyl group or a C₁₋₆ alkoxyl group, R³ represents a C₁₋₆ alkyl group or a C₁₋₆ alkoxyl group, R⁴ represents a C₁₋₆ alkyl group, a value x is 0 or 1, and a value y is an integer from 1 to 10.

10. A color filter ink set including a plurality of different colors of color filter ink with a green ink being the color filter ink according to claim 1.

11. A color filter manufactured using the color filter ink according to claim 1.

12. A color filter manufactured using the color filter ink set according to claim 10.

13. An image display device having the color filter according to claim 11.

14. The image display device according to claim 13, wherein
the image display device is a liquid crystal panel.

15. An electronic device having the image display device according to claim 13.
